(19) United States
(12) Patent Application Publication
(10) Pub. No.: US 2014/0229274 A1
(43) Pub. Date: Aug. 14, 2014

(54) PROPERTY BILLBOARDING AND FINANCIAL REVENUE DISTRIBUTION TO PROPERTY OWNER IN A GEO-SPATIAL ENVIRONMENT

(71) Applicant: Raj Abhyanker, Cupertino, CA (US)

(72) Inventor: Raj Abhyanker, Cupertino, CA (US)

(21) Appl. No.: 14/257,021

(22) Filed: Apr. 21, 2014

Related U.S. Application Data
(63) Continuation-in-part of application No. 14/151,844, filed on Jan. 10, 2014, now Pat. No. 8,732,091.
Application No. 14/151,844 is a continuation-in-part of application No. 14/144,612, filed on Dec. 31, 2013, now Pat. No. 8,738,545.
Application No. 14/144,612 is a continuation-in-part of application No. 11/805,329, filed on May 22, 2007, now abandoned.
Application No. 11/805,329 is a continuation-in-part of application No. 11/653,194, filed on Jan. 12, 2007.
Application No. 11/653,194 is a continuation-in-part of application No. 11/603,442, filed on Nov. 22, 2006, now abandoned.

(51) Int. Cl. G06Q 30/02

(52) U.S. Cl. CPC G06Q 30/0261; G06Q 30/0247; G06Q 30/0269
USPC 705/14.46; 705/14.58

(57) ABSTRACT

A method, apparatus and system of property billboarding and financial revenue distribution to property owner in a geo-spatial environment are disclosed. In one embodiment, a method includes generating a community network of user profiles, each user profile of the user profiles associated with a specific geographic location, determining a first user profile of the user profiles, generating advertisements, determining a first advertisement of the advertisements, generating a first display view to include a map view embodied by the community network, the first user profile of the user profiles represented at a location in the map view corresponding with the associated specific geographic location, and the first advertisement of the advertisements displayed in conjunction with the first user profile of the user profiles, and generating a commerce transaction associated with the first user profile of the user profiles.

### CLAIMS OF PRIORITY

This patent application is a continuation in part, claims priority from, and hereby incorporates by reference:
(1) U.S. Utility patent application Ser. No. 14/151,844 titled ‘SECURITY IN A GEO-SPATIAL ENVIRONMENT’, filed on Jan. 10, 2014, and now Patented as U.S. Pat. No. ______.
(2) U.S. Utility patent application number Ser. No. 14/144,612 titled ‘MAP BASED NEIGHBORHOOD SEARCH AND COMMUNITY CONTRIBUTION’ filed on Dec. 31, 2013, and now Patented as U.S. Pat. No. ______.
(3) U.S. Utility patent application Ser. No. 11/805,329 titled ‘PROPERTY BILLBOARDING AND FINANCIAL REVENUE DISTRIBUTION TO PROPERTY OWNER IN A GEO-SPATIAL ENVIRONMENT’, filed on May 22, 2007.
(4) U.S. Utility patent application Ser. No. 11/653,194 titled ‘LODGING AND REAL PROPERTY IN A GEO-SPATIAL MAPPING ENVIRONMENT’ filed on Jan. 12, 2007, which further claims priority to:
(5) U.S. Utility patent application Ser. No. 11/603,442 titled ‘MAP BASED NEIGHBORHOOD SEARCH AND COMMUNITY CONTRIBUTION’ filed on Nov. 22, 2006, and
   a. U.S. Provisional patent application No. 60/783,226, titled ‘TRADE IDENTITY LICENSING IN A PROFESSIONAL SERVICES ENVIRONMENT WITH CONFLICT’ filed on Mar. 17, 2006.
   b. U.S. Provisional patent application No. 60/817,470 titled ‘SEGMENTED SERVICES HAVING A GLOBAL STRUCTURE OF NETWORKED INDEPENDENT ENTITIES’, filed Jun. 28, 2006.
   c. U.S. Provisional patent application No. 60/853,499, titled ‘METHOD AND APPARATUS OF NEIGHBORHOOD EXPRESSION AND USER CONTRIBUTION SYSTEM’ filed on Oct. 19, 2006.
   d. U.S. Provisional patent application No. 60/854,230 titled ‘METHOD AND APPARATUS OF NEIGHBORHOOD EXPRESSION AND USER CONTRIBUTION SYSTEM’ filed on Oct. 25, 2006.

### FIELD OF TECHNOLOGY

This disclosure relates generally to the technical field of communications, and in one embodiment, to a method, system and apparatus of property billboarding and financial revenue distribution to property owner in a geo-spatial environment.

### BACKGROUND

Billboarding may be used to promote products and/or services. Advertisements are sometimes displayed on buildings and/or other structures. For example, advertisers may pay building owners to display the advertisements on faces of city buildings, barns, etc. The advertisements may provide a promotional profile sought by the advertisers and may generate revenue sought by the building owners. Sometimes, however, local ordinances may prohibit advertising in the form of billboarding.

Billboarding may also be found in a geo-spatial environment. For example, sponsors of geo-spatial environments may display the advertisements on representations of real life buildings and/or structures. The advertisers may pay the sponsors of the geospatial environments for the billboarding services. Owners of the buildings and/or structures represented in the geo-spatial environment, however, may not receive any compensation for the advertisements displayed in conjunction with the representations.

### SUMMARY OF THE DISCLOSURE

A method, apparatus and system of property billboarding and financial revenue distribution to property owner in a geo-spatial environment are disclosed. In one aspect, a method includes generating a community network of user profiles, each user profile associated with a specific geographic location, determining a first user profile, generating advertisements, determining a first advertisement, generating a first display view to include a map view embodied by the community network, the first user profile represented at a location in the map view corresponding with the associated specific geographic location, and the first advertisement displayed in conjunction with the first user profile, and generating a commerce transaction associated with the first user profile.

The first advertisement may also be displayed in conjunction with a property representation selected from a group including a representation of an outside surface of a structure associated with the first user profile, a representation of an inside area of a structure associated with the first user profile, a representation of an outside property area associated with the first user profile, a editable portion associated with the first user profile, and content associated with the editable portion.

The method may further include generating a revenue transaction associated with the first user profile. The method may also include generating an online payment transaction associated with the first user profile. The method may include generating a link between the first advertisement and a website, tabulating clicks of the link, determining revenue based on the tabulation of the clicks, and generating the online payment transaction associated with the first user profile based on the revenue.

In addition, the method may include apportioning a first portion of the revenue and a second portion of the revenue associated with the online payment transaction, associating the first portion of the revenue with a claimant of the first user profile, and associating the second portion of the revenue with a sponsor of the community network.

The method may include providing at least a portion of the advertisements available for placement in conjunction with a particular user profile. The method may further include providing at least a portion of the user profiles available to accept an advertisement. In addition, the method may include selecting a geographic region, and selecting a particular user profile of the portion of the user profiles available to accept an advertisement having a specific geographic location associated with the geographic region.

The method may also include receiving a preference (e.g., may include an advertiser, a product, and/or a service) associated with a second user profile of the portion of the user profiles available to accept an advertisement, determining a second advertisement that matches the preference, and generating a second display view to include a map view embodied by the community network, the second user profile represented at a location in the map view corresponding with the associated specific geographic location, and the second advertisement displayed in conjunction with the second user profile.

The method may further include providing search categories associated with the advertisements, selecting at least one search category, determining a third advertisement associated with the search category, determining a third user profile associated with the third advertisement, and generating a third display view to include a three-dimensional map view embodied by the community network, the third user profile represented at a location in the map view corresponding with the associated specific geographic location, and the third advertisement displayed in conjunction with the third user profile.

The search categories may include a preference, a location of a user profile, and/or a type of advertisement (e.g., may be associated with a product, a service, an event, a celebrity, and/or content such as music clips, movie trailers, audiovisual clips and/or podcasts, etc.). In addition, the method may include generating a link between the third advertisement and a website, selecting the link, and generating an online transaction associated with the third advertisement. The online transaction may further include generating an online purchase transaction associated with the product and/or the service. The online transaction may also include generating an online order of music associated with the music clip.

Moreover, the online transaction may include generating an online order of a movie associated with the movie trailer. The online transaction may also include generating an online reservation associated with the event, and generating an online payment transaction associated with the online reservation. Furthermore, the online transaction may include generating a link associated with the celebrity.

It may be verified that each user of the community network lives at a residence associated with a claimable residential address of the community network formed through a social community module of a privacy server using a processor and a memory. Member data associated with each user may be obtained from each user of the community network, using the processor of a computing device. The member data may include an address. The address may be associated with a profile of each user. A location of each user may be determined based on the member data. The member data may be stored in a database. A personal address privacy preference may be obtained from each user, the personal address privacy preference specifying if the address should be displayed to other users.

A threshold radial distance may be optionally extended to an adjacent boundary of an adjacent neighborhood based a request of the particular user. A separate login may be generated to the online community designed to be usable by at least one of a police department, a municipal agency, a neighborhood association, and a neighborhood leader associated with the particular neighborhood. The police department, the municipal agency, the neighborhood association, and/or the neighborhood leader may be permitted to invite residents of the particular neighborhood themselves using the privacy server using a self-authenticating access code that permits new users that enter the self-authenticating access code in the online community to automatically join the particular neighborhood as verified users, generate a virtual neighborhood watch group and/or an emergency preparedness group restricted to users verified in the particular neighborhood using the privacy server, conduct high value crime and safety related discussions from local police and fire officials that is restricted to users verified in the particular neighborhood using the privacy server, broadcast information across the particular neighborhood, and/or receive and/or track neighborhood level membership and/or activity to identify leaders from the restricted group of users verified in the particular neighborhood using the privacy server.

In another aspect, a system includes a geo-spatial environment, a community network module of the geo-spatial environment to include user profiles, each user profile to include a specific geographic location, an advertisement algorithm of the geo-spatial environment to generate advertisements, a map algorithm of the geo-spatial environment to include map data which serves as a basis to render a map view in the geo-spatial environment which identifies at least one of residences, businesses, and civic structures having specific geographic locations, a display algorithm of the geo-spatial environment to generate a first display view of the map view embodied by the community network, a first user profile represented at a location in the three-dimensional map view corresponding to the specific geographic location associated with the first user profile, and an advertisement displayed in conjunction with the first user profile, and a commerce transaction algorithm of the geo-spatial environment to generate a commerce transaction associated with the first user profile.

The system may further include a revenue module of the geo-spatial environment to generate revenue associated with the commerce transaction. The system may also include an online payment transaction module of the geo-spatial environment to generate an online payment transaction associated with the revenue (e.g., a first portion of the revenue may be associated with a claimant of the first user profile and a second portion of the revenue may be associated with a sponsor of the community network).

The system may also include a tabulate module of the geo-spatial environment to generate a link associated with the first advertisement, to tabulate clicks of the link, and to associate the tabulated links with the commerce transaction. The system may yet include an availability module of the geo-spatial environment to provide a portion of the user profiles available to accept advertisements and to enable selection of a particular user profile of the portion of user profiles with which a particular advertisement is associated.

Moreover, the system may include a preference module of the geo-spatial environment to determine a second profile available to accept an advertisement, to receive a preference (e.g., may include an advertiser, a product, and/or a service) associated with the second user profile available to accept an advertisement, and to determine a particular advertisement that matches the preference. The system may also include a search module of the geo-spatial environment to provide search categories (e.g., may include preferences, locations of user profiles, and/or types of advertisements), to enable selection of at least one search category, to determine at least one advertisement associated with a selected search category, and to identify at least one user profile associated with the advertisement.

The system may further include a claimable profile module of the geo-spatial environment to generate a claimable profile associated with at least one representation of a user profile. The system may also include an append module of the geo-spatial environment to generate, with the claimable profile, content associated with the claimable profile.

A privacy server may be configured to verify that each user of the community network lives at a residence associated with a claimable residential address of the community network formed through a social community module of a privacy server using a processor and a memory, to obtain from each user of the community network, using the processor of a computing device, member data associated with each user, the member data including an address, to associate the address with a profile of each user, to determine a location of each user based on the member data, to store the member data in a database, and/or to obtain a personal address privacy preference from each user, the personal address privacy preference specifying if the address should be displayed to other users.

The privacy server may be configured to optionally extend a threshold radial distance to an adjacent boundary of an adjacent neighborhood based a request of the particular user, to generate a separate login to the online community designed to be usable by a police department, a municipal agency, a neighborhood association, and/or a neighborhood leader associated with the particular neighborhood, to permit at least one of the police department, the municipal agency, the neighborhood association, and the neighborhood leader to invite residents of the particular neighborhood themselves using the privacy server using a self-authenticating access code that permits new users that enter the self-authenticating access code in the online community to automatically join the particular neighborhood as verified users, to generate a virtual neighborhood watch group and/or an emergency preparedness group restricted to users verified in the particular neighborhood using the privacy server, to conduct high value crime and/or safety related discussions from local police and/or fire officials that is restricted to users verified in the particular neighborhood using the privacy server, to broadcast information across the particular neighborhood, and/or to receive and track neighborhood level membership and activity to identify leaders from the restricted group of users verified in the particular neighborhood using the privacy server.

In yet another aspect, a geo-spatial environment includes a first instruction set to enable a community network to include a map database associated with map data, a user database associated with user profiles, each user profile associated with a specific geographic location identifiable in the map data, and an advertisement database associated with advertisements, each advertisement associated with a user profile. The system also includes a second instruction set integrated with the first instruction set to display a map view embodied by the community network, a user profile represented at a location in the map view corresponding to the associated specific geographic location and an advertisement associated with the user profile. The system further includes a third instruction set to generate a commerce transaction associated with the user profile.

The geo-spatial environment may include a fourth instruction set to generate an online payment transaction associated with the user profile. The geo-spatial environment may also include a fifth instruction set to provide at least a portion of the user profiles available to accept an advertisement, and a sixth instruction set to provide search categories, to enable selection of at least one search category, to determine at least one advertisement associated with a selected search category, and to identify at least one user profile associated with the advertisement.

A seventh instruction set may verify that each user of the community network lives at a residence associated with a claimable residential address of the community network formed through a social community module of a privacy server using a processor and a memory, to obtain from each user of the community network, using the processor of a computing device, member data associated with each user, the member data including an address, to associate the address with a profile of each user, to determine a location of each user based on the member data, to store the member data in a database, and to obtain a personal address privacy preference from each user, the personal address privacy preference specifying if the address should be displayed to other users.

An eighth instruction set may optionally extend a threshold radial distance to an adjacent boundary of an adjacent neighborhood based a request of the particular user, to generate a separate login to the online community designed to be usable by at least one of a police department, a municipal agency, a neighborhood association, and a neighborhood leader associated with the particular neighborhood, to permit at least one of the police department, the municipal agency, the neighborhood association, and the neighborhood leader to at least one of invite residents of the particular neighborhood themselves using the privacy server using a self-authenticating access code that permits new users that enter the self-authenticating access code in the online community to automatically join the particular neighborhood as verified users, to generate at least one of a virtual neighborhood watch group and an emergency preparedness group restricted to users verified in the particular neighborhood using the privacy server, to conduct high value crime and safety related discussions from local police and fire officials that is restricted to users verified in the particular neighborhood using the privacy server, to broadcast information across the particular neighborhood, and to receive and track neighborhood level membership and activity to identify leaders from the restricted group of users verified in the particular neighborhood using the privacy server.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a geo-spatial environment communicating with users through a network, according to one embodiment.

FIG. 2 is an exploded view of the community network algorithm of FIG. 1, according to one embodiment.

FIG. 3 is an exploded view of the additional algorithms of FIG. 1, according to one embodiment.

FIG. 4 is a block diagram illustrating generation of a display view associated with the advertisements, according to one embodiment.

FIG. 5 is a block diagram representation of search categories, according to one embodiment.

FIG. 6 is a user interface view displaying profile details of a user associated with the community network, according to one embodiment.

FIG. 7 is a user interface view of property billboarding associated with a specific geographic location, according to one embodiment.

FIG. 8 is a user interface view of listing property of the user as available to accept an advertisement, according to one embodiment.

FIG. 9 is a user interface view of the property billboarding preview, according to one embodiment.

FIG. 10 is a user interface view of listing an advertisement for placement in the geo-spatial environment, according to one embodiment.

FIG. 11 is a user interface view of a search menu associated with the property billboarding, according to one embodiment.

FIG. 12 is a user interface view displaying search results associated with the property billboarding, according to one embodiment.

FIG. 13 is a representation of the displayed advertisements, according to one embodiment.

FIG. 14 is a table view displaying advertisement and commerce transaction information, according to one embodiment.

FIG. 15 is a diagrammatic system view of a data processing system in which any of the embodiments disclosed herein may be performed, according to one embodiment.

FIG. 16A is a process flow of generating a commerce transaction associated with a user profile in the geo-spatial environment, according to one embodiment.

FIG. 16B is a continuation of the process flow of FIG. 16A, showing additional processes, according to one embodiment.

FIG. 16C is a continuation of the process flow of FIG. 16B, showing additional processes, according to one embodiment.

FIG. 16D is a continuation of the process flow of FIG. 16C, showing additional processes, according to one embodiment.

FIG. 16E is a continuation of the process flow of FIG. 16D, showing additional processes, according to one embodiment.

FIG. 17 is a systematic view of communication of claimable data, according to one embodiment.

FIG. 18 is a systematic view of a network view, according to one embodiment.

FIG. 19 is a block diagram of a database, according to one embodiment.

FIG. 20 is an exemplary graphical user interface view for data collection, according to one embodiment.

FIG. 21 is an exemplary graphical user interface view of image collection, according to one embodiment.

FIG. 22 is an exemplary graphical user interface view of an invitation, according to one embodiment.

FIG. 23 is a flowchart of inviting the invitee(s) by the registered user, notifying the registered user upon the acceptance of the invitation by the invitee(s) and, processing and storing the input data associated with the user in the database, according to one embodiment.

FIG. 24 is a flowchart of adding the neighbor to the queue, according to one embodiment.

FIG. 25 is a flowchart of communicating brief profiles of the registered users, processing a hyperlink selection from the verified registered user and calculating and ensuring the Nmax degree of separation of the registered users away from verified registered users, according to one embodiment.

FIG. 26 is an N degree separation view, according to one embodiment.

FIG. 27 is a user interface view showing a map, according to one embodiment.

FIG. 28A is a process flow chart of searching a map based community and neighborhood contribution, according to one embodiment.

FIG. 28B is a continuation of process flow of FIG. 28A showing additional processes, according to one embodiment.

FIG. 28C is a continuation of process flow of FIG. 28B showing additional processes, according to one embodiment.

FIG. 28D is a continuation of process flow of FIG. 28C showing additional processes, according to one embodiment.

FIG. 28E is a continuation of process flow of FIG. 28D showing additional processes, according to one embodiment.

FIG. 29 is a system view of a global neighborhood environment 1800 communicating with the neighborhood(s) through a network, an advertiser(s), a global map data and an occupant data according to one embodiment.

FIG. 30 is an exploded view of a social community module of FIG. 29, according to one embodiment.

FIG. 31 is an exploded view of a search module of FIG. 29, according to one embodiment.

FIG. 32 is an exploded view of a claimable module of FIG. 29, according to one embodiment.

FIG. 33 is an exploded view of a commerce module of FIG. 29, according to one embodiment.

FIG. 34 is an exploded view of a map algorithm of FIG. 29, according to one embodiment.

FIG. 35 is a table view of user address details, according to one embodiment.

FIG. 36 is a social community view of a social community module, according to one embodiment.

FIG. 37 is a profile view of a profile module, according to one embodiment.

FIG. 38 is a contribute view of a neighborhood network module, according to one embodiment.

FIG. 39 is a diagrammatic system view of a data processing system in which any of the embodiments disclosed herein may be performed, according to one embodiment.

FIG. 40A is a user interface view of mapping user profile of the geographical location, according to one embodiment.

FIG. 40B is a user interface view of mapping of the claimable profile, according to one embodiment.

FIG. 41A is a user interface view of mapping of a claimable profile of the commercial user, according to one embodiment.

FIG. 41B is a user interface view of mapping of customizable business profile of the commercial user, according to one embodiment.

FIG. 42 is a user interface view of a group view associated with particular geographical location, according to one embodiment.

FIG. 43 is a user interface view of claim view, according to one embodiment.

FIG. 44 is a user interface view of a building builder, according to one embodiment.

Other features of the present embodiments will be apparent from the accompanying drawings and from the detailed description that follows.

### DETAILED DESCRIPTION

A method, system and apparatus of property billboarding and financial revenue distribution to property owner in a geo-spatial environment are disclosed. In the following description, for the purposes of explanation, numerous specific details are set forth in order to provide a thorough understanding of the various embodiments. It will be evident, however, to one skilled in the art that the various embodiments may be practiced without these specific details.

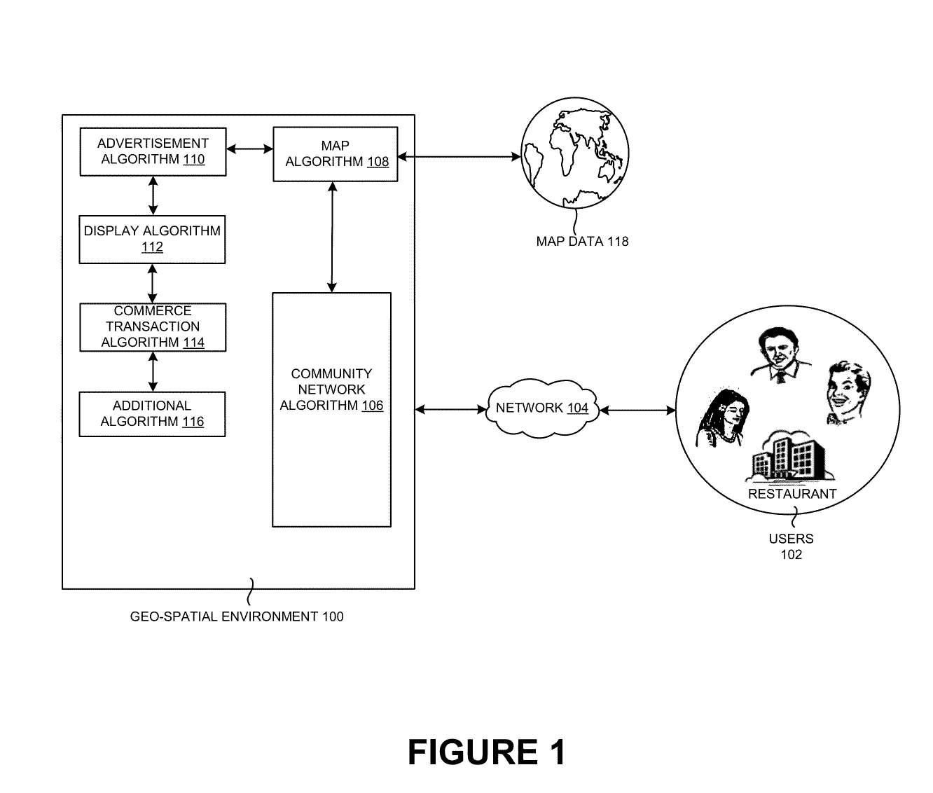

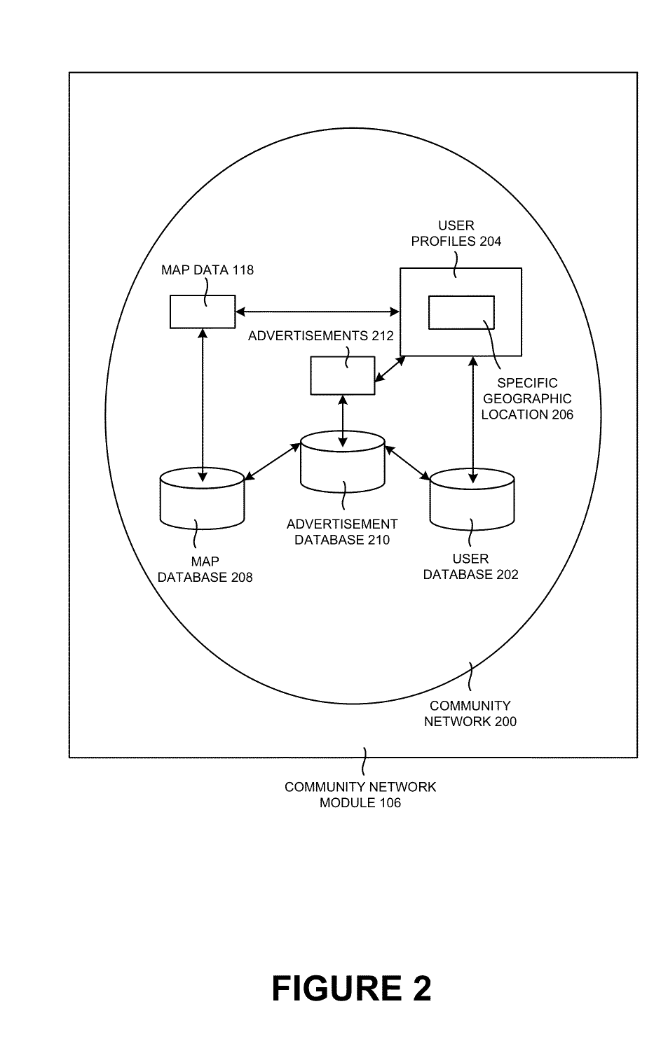

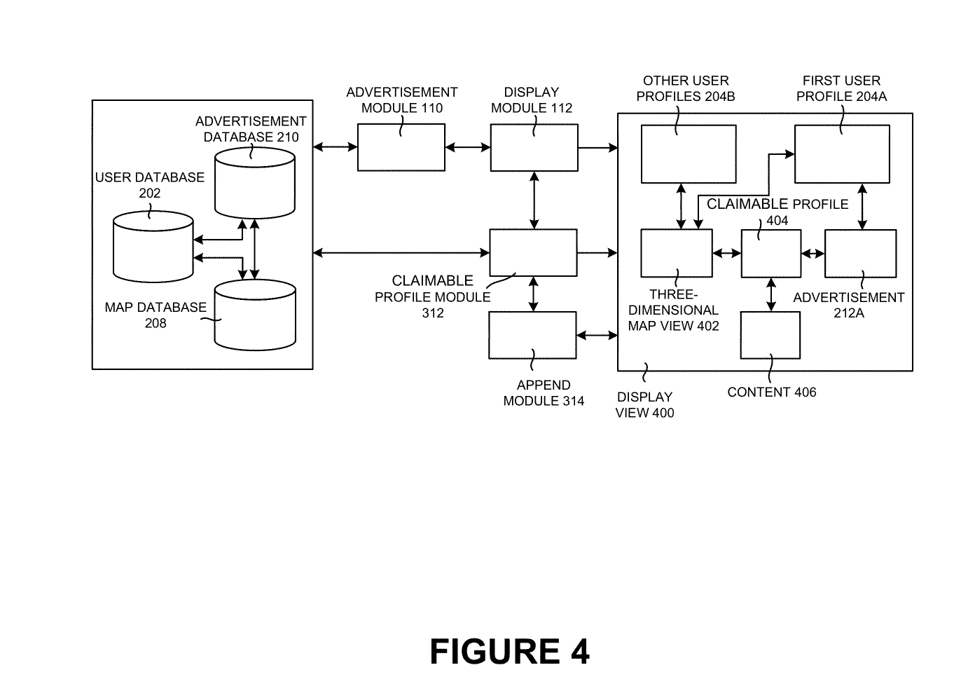

In one embodiment, a method includes generating a community network (e.g., the community network 200 of FIG. 2) of user profiles (e.g., the user profiles 204 of FIG. 2), each user profile associated with a specific geographic location (e.g., the specific geographic location 206 of FIG. 2), determining a first user profile (e.g., the first user profile 204A of FIG. 4), generating advertisements (e.g., the advertisements 212 of FIG. 2), determining a first advertisement (e.g., the advertisement 212A of FIG. 4), generating a first display view (e.g., the display view 400 of FIG. 4) to include a map view (e.g., the map view 402 of FIG. 4) embodied by the community network 200, the first user profile 204A represented at a location in the map view 402 corresponding with the associated specific geographic location 206, and the first advertisement displayed (e.g., using the display algorithm 112 of FIG. 1) in conjunction with the first user profile 204A, and generating a commerce transaction (e.g., through the commerce transaction algorithm 114 of FIG. 1) associated with the first user profile 204A.

In another embodiment, a system includes a geo-spatial environment (e.g., the geo-spatial environment 100 of FIG. 1), a community network algorithm (e.g., the community network algorithm 106 of FIG. 1) of the geo-spatial environment 100, to include user profiles (e.g., the user profiles 204 of FIG. 2), each user profile to include a specific geographic location (e.g., the specific geographic location 206 of FIG. 2), and an advertisement algorithm (e.g., the advertisement algorithm 110 of FIG. 1) of the geo-spatial environment 100 to generate advertisements 212. The system also includes a map algorithm (e.g., the map algorithm 108 of FIG. 1) of the geo-spatial environment 100 to include map data (e.g., the map data 118 of FIG. 1) which serve as a basis to render a map view (e.g., the map view 402 of FIG. 4) in the geo-spatial environment 100 which identifies residences, businesses, and/or civic structures having specific geographic locations a display algorithm (e.g., the display algorithm 112 of FIG. 1) of the geo-spatial environment 100 to generate a first display view (e.g., the display view 400 of FIG. 4) of the map view 402 embodied by a community network (e.g., the community network 200 of FIG. 2), a first user profile (e.g., the first user profile 204A of FIG. 4) represented at a location in the map view 402 corresponding to the specific geographic location 206 associated with the first user profile 204A, and an advertisement displayed in conjunction with the first user profile 204A, and a commerce transaction algorithm (e.g., the commerce transaction module 114 of FIG. 1) of the geo-spatial environment 100 to generate a commerce transaction associated with the first user profile 204A.

In yet another embodiment, a geo-spatial environment (e.g., the geo-spatial environment 100 of FIG. 1) includes a first instruction set to enable a community network (e-g., the community network 200 of FIG. 2), to include a map database (e.g., the map database 208 of FIG. 2) associated with map data (e.g., the map data 118 of FIG. 1), a user database (e.g., the user database 202 of FIG. 2) associated with user profiles (e.g., the user profiles 204 of FIG. 2), each user profile 204 associated with a specific geographic location (e.g., the specific geographic location 206 of FIG. 2) identifiable in the map data 118, and an advertisement database (e.g., the advertisement database 210 of FIG. 2) associated with advertisements 212, each advertisement 212 associated with a user profile 204, a second instruction set integrated with the first instruction set to display a map view (e-g., the three-dimensional map view 402 of FIG. 4) embodied by the community network 200, a user profile 204 represented at a location in the map view 402 corresponding to the associated specific geographic location 206, and an advertisement 212 associated with the user profile 204, and a third instruction set to generate a commerce transaction associated with the first user profile 204A.

FIG. 1 is a system view of a geo-spatial environment 100 communicating with users 102 through a network 104, according to one embodiment. Particularly, FIG. 1 illustrates the geo-spatial environment 100, the users 102, the network 104, a community network module 106, a map algorithm 108, an advertisement algorithm 110, a display algorithm 112, a commerce transaction algorithm 114, additional algorithms 116 and map data 118, according to one embodiment.

The geo-spatial environment 100 may consist of advertisements (e.g., the advertisements 212 of FIG. 2) displayed in conjunction with representation of buildings and/or structures associated with user profiles (e.g., the user profiles 204 of FIG. 2). The users 102 may be entities (e.g., individuals, commercial structures, etc.) having user profiles 204 associated with a specific geographic location (e.g., the specific geographic location 206 of FIG. 2) in the geo-spatial environment 100. The network 104 may enable property billboarding and financial revenue distribution between the users 102 in the geo-spatial environment 100.

The community network algorithm 106 may generate a community network (e.g., the community network 200 of FIG. 2) with the user profiles 204 associated with the specific geographic location 206. The map algorithm 108 may generate a three-dimensional map view (e.g., the map view 402 of FIG. 4) which includes residences, businesses and/or civic structures having specific geographic locations 206. The advertisement algorithm 110 may generate the advertisements 212 that are displayed along with the user profiles 204 in the geo-spatial environment 100. The display algorithm 112 may display the advertisements 212 along with the user profiles 204 in the map view 402.

The commerce transaction algorithm 114 may generate a commerce transaction associated with the property billboarding in the geo-spatial environment 100. The additional algorithms 116 may generate additional processes associated with the property billboarding in the geo-spatial environment 100. The map data 118 may be address data and/or location data associated with the user profiles 204, that serve as a basis to render the map view 402.

In the example embodiment illustrated in FIG. 1, the geo-spatial environment 100 communicates with the users 102 through the network 104. The geo-spatial environment 100 consists of the community network algorithm 106, the map algorithm 108, the advertisement algorithm 110, the display algorithm 112, the commerce transaction algorithm 114, and the additional algorithms 116, that communicate with each other. The map module 108 also processes (e.g., generates, tracks, captures, stores and/or analyzes, etc.) the map data 118.

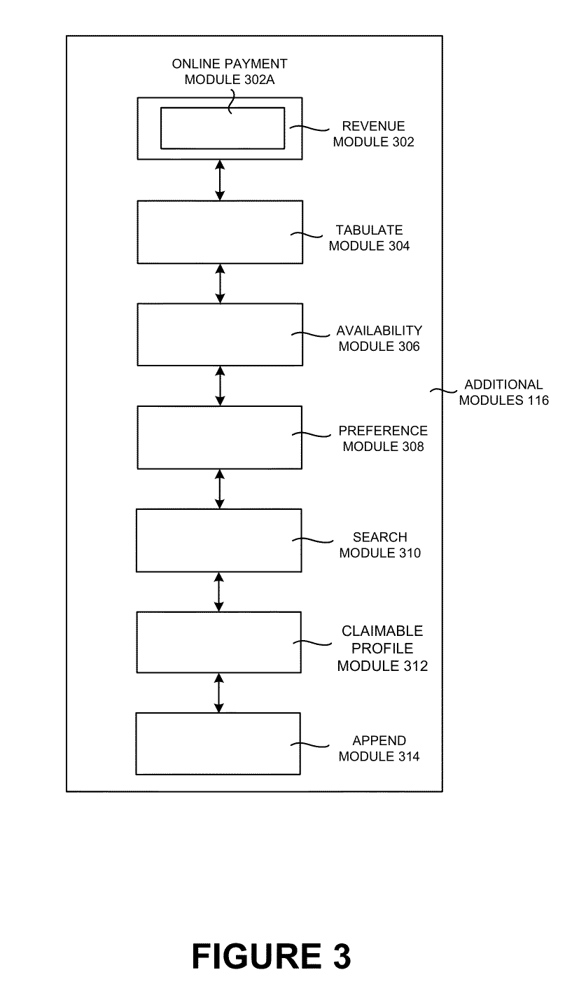

A portion of the advertisements 212 available for placement in conjunction with a particular user profile 204 and a portion of the user profiles 204 available to accept an advertisement 212 may be provided (e.g., using the advertisement algorithm 110 of FIG. 1 and/or the availability module 306 of the FIG. 3). A geographic region may be selected, and/or a particular user profile 204 (e.g., of the portion of the user profiles 204 available to accept an advertisement 212) having a specific geographic location (e.g., the specific geographic location 206 of FIG. 2) associated with the geographic region may be selected.

The geo-spatial environment 100 may include the community network algorithm 106, to include user profiles 204, each user profile 204 to include the specific geographic location 206. The advertisement algorithm 110 of the geo-spatial environment 100 may process (e.g., generate) the advertisements 212. The map algorithm 108 of the geo-spatial environment 100 may include the map data 118 which serves as a basis to render the map view 402 in the geo-spatial environment 100 which identifies the residences, the businesses, and/or the civic structures having the specific geographic locations 206.

The display algorithm 112 of the geo-spatial environment 100 may generate a first display view (e.g., the display view 400 of FIG. 4) of the map view 402 embodied by the community network 200, a first user profile (e.g., the first user profile 204A of FIG. 4) represented at a location in the map view 402 corresponding to the specific geographic location 206 associated with the first user profile 204A, and an advertisement 212 displayed in conjunction with the first user profile 204A.

The commerce transaction algorithm 114 of the geo-spatial environment 100 may generate a commerce transaction associated with the first user profile 204A (e.g., an online purchase). The geo-spatial environment 100 may include a third instruction set to generate the commerce transaction associated with the user profiles 204. The geo-spatial environment 100 may include a fifth instruction set to provide the portion of the user profiles 204 available to accept an advertisement 212.

FIG. 2 is an exploded view of the community network algorithm 106 of FIG. 1, according to one embodiment. Particularly, FIG. 2 illustrates the map data 118, a community network 200, a user database 202, user profiles 204, a specific geographic location 206, a map database 208, an advertisement database 210, and advertisements 212, according to one embodiment.

The community network 200 may enable association of the advertisements 212 with the user profiles 204 in the geo-spatial environment 100. The user database 202 may generate the user profiles 204 in the geo-spatial environment 100. The specific geographic location 206 may be a geographic region associated with the user profiles 204 and/or the advertisements 212 (e.g., in the geospatial environment 100). The map database 208 may generate the map data 118 which serves as the basis to render the map view 402 in the geo-spatial environment 100.

The advertisement database 210 may generate the advertisements 212 that are displayed along with the user profiles 204 in the geo-spatial environment 100. The advertisements 212 may be associated with products and/or services used for publicity, sales promotion, and/or product placement through different media.

In the example embodiment as illustrated in FIG. 2, the community network module 106 consists of the community network 200 that includes the user database 202, the map database 208, and the advertisement database 210, from which the user profiles 204, the map data 118, and the advertisements 212 associated with the specific geographic location 206 are generated.

The community network 200 of the user profiles 204 may be generated (e.g., by the community network algorithm 106 of FIG. 1) Each user profile 204 may be associated with a specific geographic location 206, and/or the first user profile 204A may be determined. The advertisements 212 may be generated and/or a first advertisement (e.g., the first advertisement 212A of FIG. 4) of the advertisements 212 may be determined (e.g., using the advertisement algorithm 110 of FIG. 1). The geo-spatial environment 100 may include a first instruction set to enable the community network 200 to include the map database 208 associated with the map data 118, the user database 202 associated with user profiles 204, each user profile 204 associated with a specific geographic location 206 identifiable in the map data 118, and the advertisement database 210 associated with the advertisements 212, each advertisement 212 associated with a user profile 204.

FIG. 3 is an exploded view of the additional algorithms 116 of FIG. 1, according to one embodiment. Particularly, FIG. 3 illustrates a revenue module 302, an online payment module 302A, a tabulate module 304, an availability module 306, a preference module 308, a search module 310, a claimable profile module 312, and an append module 314, according to one embodiment.

The revenue module 302 may process (e.g., generate, capture, track, store and/or synchronize) revenue based on transactions involved in the property billboarding in the geo-spatial environment 100. The online payment module 302A may process monetary transactions associated with the property billboarding. The tabulate module 304 may generate a link associated with an advertisement 212 and may also tabulate (e.g., record, track and/or analyze, etc.) clicks of the link based on which the commerce transaction is performed. The availability module 306 may provide user profiles 204 ready to accept the advertisements 212 in the geo-spatial environment 100.

The preference module 308 may associate a particular advertisement 212 with a user profile 204 based on a preference of the user profile 204. The search module 310 may provide search categories (e.g., the search categories 502 of FIG. 3) to enable selection of desired advertisements 212 to place them along with the user profiles 204 in the geo-spatial environment 100. The claimable profile module 312 may generate claimable profiles (e.g., the claimable profiles 404 illustrated in FIG. 4) associated with the user profiles 204 in the geo-spatial environment 100. The append module 314 may generate content (e.g., comments, feedback, ratings, flags, etc.) added to the claimable profiles 404 by the users 102 of the geo-spatial environment 100.

In the example embodiment illustrated in FIG. 3, the additional algorithms 116 include the revenue module 302, the online payment module 302A, the tabulate module 304, the availability module 306, the preference module 308, the search module 310, the claimable profile module 312, and the append module 314, communicating with each other.

A revenue transaction associated with a first user profile 204A may be generated (e.g., based on a property billboarding activity of a user 102 in the geo-spatial environment 100) through the revenue module 302, based on which an online payment transaction associated with the first user profile 204A may be generated (e.g., by the online payment module 302A). A preference (e.g., may include an advertiser, a product, and/or a service) associated with a second user profile 204 available to accept an advertisement 212 may be received from a user 102, and/or a second advertisement 212 that matches the preference may be determined. A second display view may be generated to include a map view (e.g., the map view 402 of FIG. 4) embodied by the community network 200, the second user profile 204 represented at a location in the map view 402 corresponding with the associated specific geographic location 206, and the second advertisement 212 displayed in conjunction with the second user profile 204.

The revenue module 302 of the geo-spatial environment 100 may generate the revenue (e.g., a first portion of the revenue may be associated with a claimant of the first user profile 204A and a second portion of the revenue may be associated with a sponsor of the community network 200) associated with the commerce transaction. The online payment module 302A of the geo-spatial environment 100 may generate an online payment transaction associated with the revenue. The tabulate module 304 of the geo-spatial environment 100 may generate the link associated with the advertisement 212, to tabulate clicks of the link, and to associate the tabulated links with the commerce transaction.

The availability module 306 of the geo-spatial environment 100 may process (e.g., determine) a portion of the user profiles 204 available to accept the advertisements 212, and/or may enable selection of a particular user profile 204 with which a particular advertisement 212 is associated. The preference module 308 of the geo-spatial environment 100 may determine the second user profile 204 available to accept an advertisement, 212 to receive the preference (e.g., may include advertiser, product, and/or service) associated with the second user profile 204 available to accept an advertisement 212, and to determine a particular advertisement 212 that matches the preference.

The search module 310 of the geo-spatial environment 100 may provide the search categories 502 (e.g., may include preference, location of a user profile, and/or type of advertisement) to enable selection of a search category (e.g., the search categories 502 illustrated in FIG. 3), to determine an advertisement 212 associated with a selected search category 502, and to identify a user profile 204 associated with the advertisement 212. The claimable profile module 312 of the geo-spatial environment 100 may generate a claimable profile (e.g., the claimable profile 404 of FIG. 4) associated with a representation of a user profile 204. The append module 314 of the geo-spatial environment 100 may generate, with the claimable profile 404, content associated with the claimable profile 404 (e.g., the content 406 of FIG. 4). The geo-spatial environment 100 may include a fourth instruction set to generate an online payment transaction associated with the user profile 204 (e.g., using the online payment module 302A of FIG. 3).

FIG. 4 is a block diagram illustrating generation of a display view 400 associated with the advertisements 212, according to one embodiment. Particularly, FIG. 4 illustrates the advertisement algorithm 110, the display algorithm 112, the user database 202, a first user profile 204A, other user profiles 204B, the map database 208, the advertisement database 210, an advertisement 212A, the claimable profile module 312, the append module 314, the display view 400, a map view 402, a claimable profile 404, and a content 406, according to one embodiment.

The display view 400 may display the advertisements 212 in conjunction with the user profiles 204 in the map view 402. The three-dimensional map view 402 may enable the users 102 of the geo-spatial environment 100 to visualize the advertisements 212 in their neighborhood. The claimable profile 404 may be a profile associated with a user 102 (e.g., the user profiles 204 of FIG. 2) that is represented in the map view 402. The content 406 may be comments that are added to the claimable profile 404 by the users 102 of the geo-spatial environment 100.

In the example embodiment as illustrated in FIG. 4, the display view 400 includes the map view 402 and the advertisement 212A associated with the first user profile 204A. The advertisements 212 generated from the advertisement database 210 may be displayed in conjunction with the user profiles 204 in the display view 400. The claimable profile 404 and the other user profiles 204B (e.g., generated from the user database 202) are also displayed in the display view 400 along with the advertisements 212.

The first display view may be generated to include the three-dimensional map view 402 embodied by the community network 200, the first user profile 204A represented at a location in the map view 402 corresponding with the associated specific geographic location 206, and the first advertisement 212 displayed in conjunction with the first user profile 204A. The commerce transaction associated with the first user profile 204A may be generated (e.g., through the commerce transaction module 114 of FIG. 1).

A link between the first advertisement 212A and a website may be generated, and/or clicks of the link may be tabulated (e.g., using the tabulate module 304 of FIG. 3). A revenue factor (e.g., amount, distribution, etc.) may be determined based on the tabulation of the clicks (e.g., on a cost-per-click (CPC) basis), using the revenue module 302 of FIG. 3). The online payment transaction associated with the first user profile 204A may be generated based on the revenue factor (e.g., by the online payment module 302A of the revenue module 302 of FIG. 3). The first portion of the revenue and the second portion of the revenue associated with the online payment transaction may be apportioned, and/or the first portion of the revenue may be associated with the claimant of the first user profile 204A.

The second portion of the revenue may be associated with the sponsor of the community network 200. The geo-spatial environment 100 may include a second instruction set integrated with the first instruction set to display the three-dimensional map view 402 embodied by the community network 200, a user profile 204 represented at a location in the map view 402 corresponding to the associated specific geographic location 206, and an advertisement 212 associated with the user profile 204.

FIG. 3 is a block diagram representation of the search categories 502, according to one embodiment. Particularly, FIG. 3 illustrates a block 504, a type of advertisement 504A, a block 506, a property representation 508, and a block 510, according to one embodiment.

The block 504 may display various search categories 502 based on which the advertisements 212 are selected by the users 102 to be displayed along with the user profiles 204 in the geo-spatial environment 100. The type of advertisement 504A may be a search category 502 from which the users 102 of the geo-spatial environment 100 select desired advertisements 212 to display in conjunction with the user profiles 204. The block 506 may display various types of advertisements 212 that are available for the users 102 to select in order to associate them with the user profiles 204 in the geo-spatial environment 100 (e.g., using the availability module 306 of FIG. 3).

The property representation 508 may indicate a portion of a property where the desired advertisements 212 are displayed in the geo-spatial environment 100. The block 510 may display a list of the portion of the property available to place the advertisements 212 in the geo-spatial environment 100.

In the example embodiment illustrated in FIG. 3, the users 102 of the geospatial environment 100 may search for the desired advertisements 212 to be displayed along with the user profiles 204 based on the search categories 502. The search categories 502 include preference, location of a user profile and type of advertisement (e.g., displayed in the block 504). The type of advertisement 504A includes options for product, service, music clip, event, audiovisual clip, podcast, celebrity, etc. as displayed in the block 506.

The property representation 508 includes a representation of an outside surface of a structure (e.g., a building, in the geo-spatial environment 100) associated with the first user profile 204A, a representation of an inside area of a structure (e.g., an interior space) associated with the first user profile 204A, a representation of an outside property area associated with the first user profile 204A, a editable portion associated with the first user profile 204A, and content associated with the editable portion as shown in the block 510.

The search categories 502 associated with the advertisements 212 may be provided (e.g., using the search module 310 of FIG. 3) and/or a search category 502 may be selected (e.g., by a user 102). A third advertisement 212 associated with the search category 502 may be determined, and/or a third user profile 204 associated with the third advertisement 212 may be determined (e.g., using the advertisement algorithm 110 and/or the additional algorithms 116 of FIG. 1). A third display view may be generated to include a map view (e.g., the map view 402 of FIG. 4) embodied by the community network 200, the third user profile 204 represented at a location in the map view 402 corresponding with the associated specific geographic location 206, and the third advertisement 212 displayed in conjunction with the third user profile 204. The search categories 502 may include preference, location of a user profile, and/or type of advertisement (e.g., may be associated with a product, service, music clip, movie trailer, event, audiovisual clip, podcast, and/or celebrity). A link between the third advertisement 212 and a website may be generated, the link may be selected (e.g., by a user 102) and an online transaction associated with the third advertisement 212 may be processed. The online transaction may include generating an online purchase transaction associated with the product and/or the service in the geo-spatial environment 100. For example, the online transaction may include generating an online order of music associated with a music clip, generating an online order of a movie associated with a movie trailer, generating an online reservation associated with an event, and/or generating an online payment transaction associated with an online reservation. The online transaction may also include generating a link associated with a celebrity.

The geo-spatial environment 100 may include a sixth instruction set to provide the search categories 502, to enable selection of a search category 502, to determine an advertisement 212 associated with a selected search category 502, and/or to identify a user profile 204 associated with the advertisement 212.

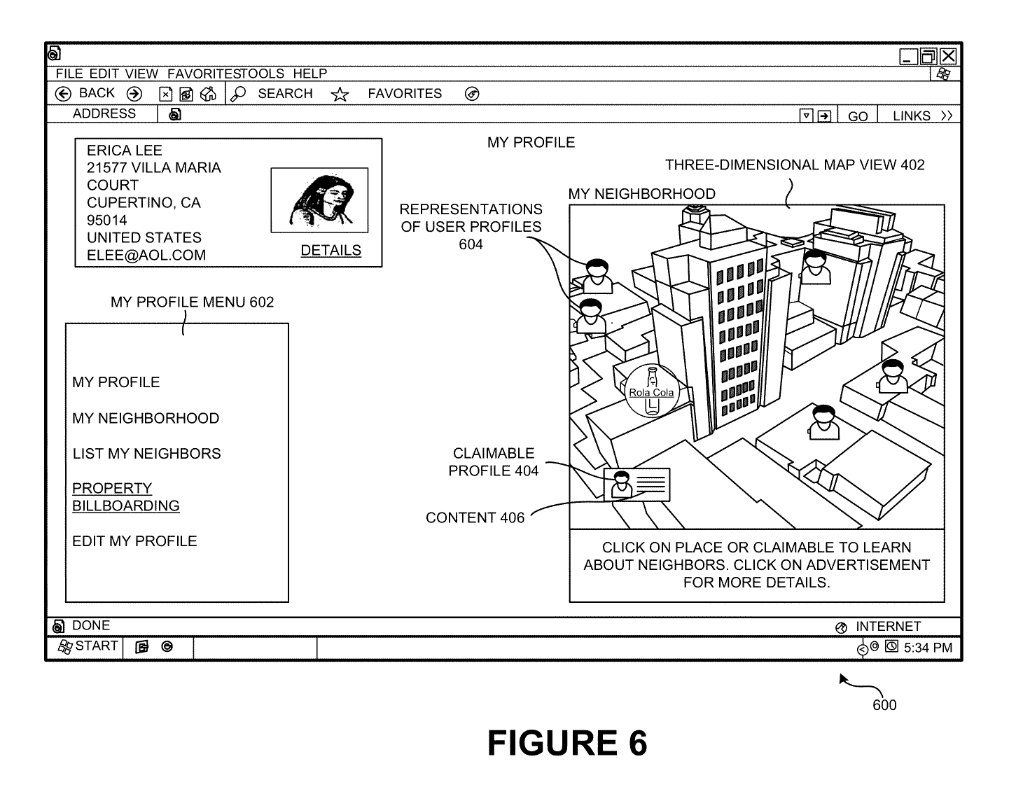

FIG. 6 is a user interface view 600 displaying profile details of a user 102 associated with the community network 200, according to one embodiment. Particularly, FIG. 6 illustrates the map view 402, the claimable profile 404, the content 406, my profile menu 602, and representations of user profiles 604, according to one embodiment.

The my profile menu 602 may display profile information associated with the user 102 in the geo-spatial environment 100 (e.g., biographical information, interests, preferences, group affiliations, hobbies, background, etc.). The representations of user profiles 604 may be the user profiles 204 and claimable profiles 404 (e.g., publicly editable profiles) that are displayed in the map view 402.

In the example embodiment illustrated in FIG. 6, the user interface view 600 displays profile information of the user (e.g., Erica Lee) in the my profile menu 602. The my profile menu 602 displays details of the neighborhood, property billboarding, etc. in the geo-spatial environment 100. The map view 402 displays the neighborhood of the user (e.g., Erica Lee) where the advertisements 212 are displayed.

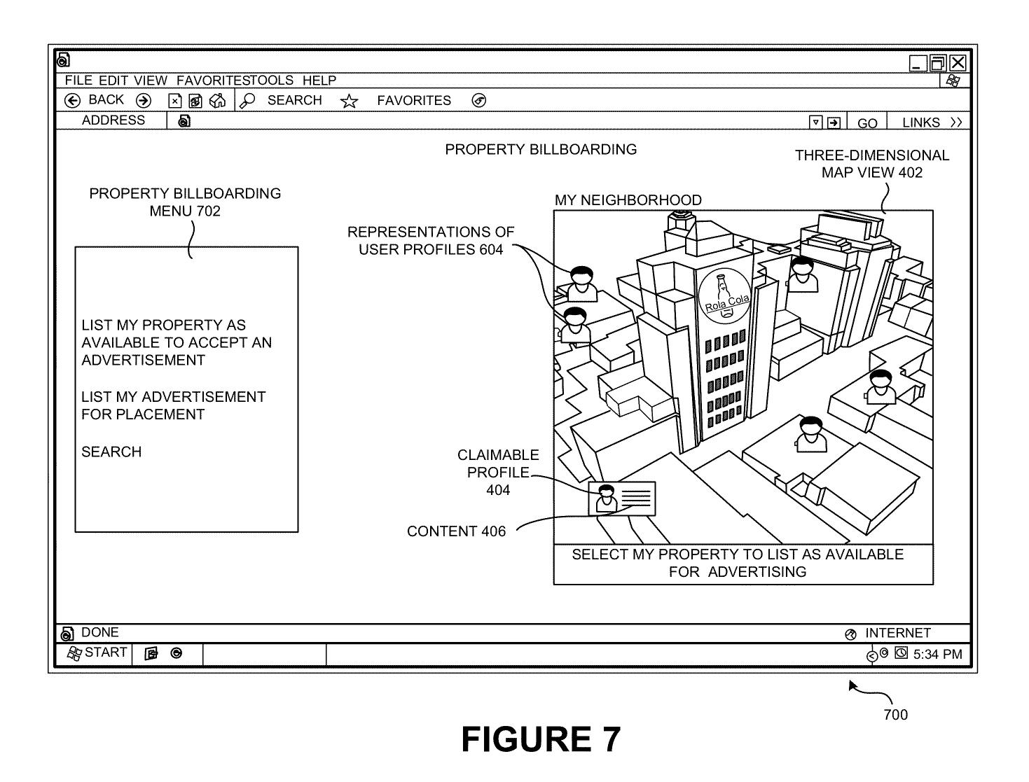

FIG. 7 is a user interface view 700 of property billboarding associated with a specific geographic location (e.g., the specific geographic location 206 illustrated in FIG. 2), according to one embodiment. Particularly, FIG. 7 illustrates the map view 402, the claimable profile 404, the content 406, the representations of user profile 604, and a property billboarding menu 702, according to one embodiment.

The property billboarding menu 702 may display options associated with placing of the advertisements 212 along with the user profiles 204 in the geo-spatial environment 100.

In the example embodiment illustrated in FIG. 7, the property billboarding menu 702 displays the options “list my property as available to accept an advertisement”, “list my advertisement for placement” and a search option. The user (e.g., Erica Lee) may offer her property (e.g., in the geo-spatial environment 100) for placement of the advertisements 212 (e.g., may offer property billboarding for the advertisements 212) and may also display any desired advertisements 212 in the geo-spatial environment 100. An example advertisement (e.g., Rola Cola) displayed along with the user profiles 204 and the claimable profile 404 is illustrated in the map view 402.

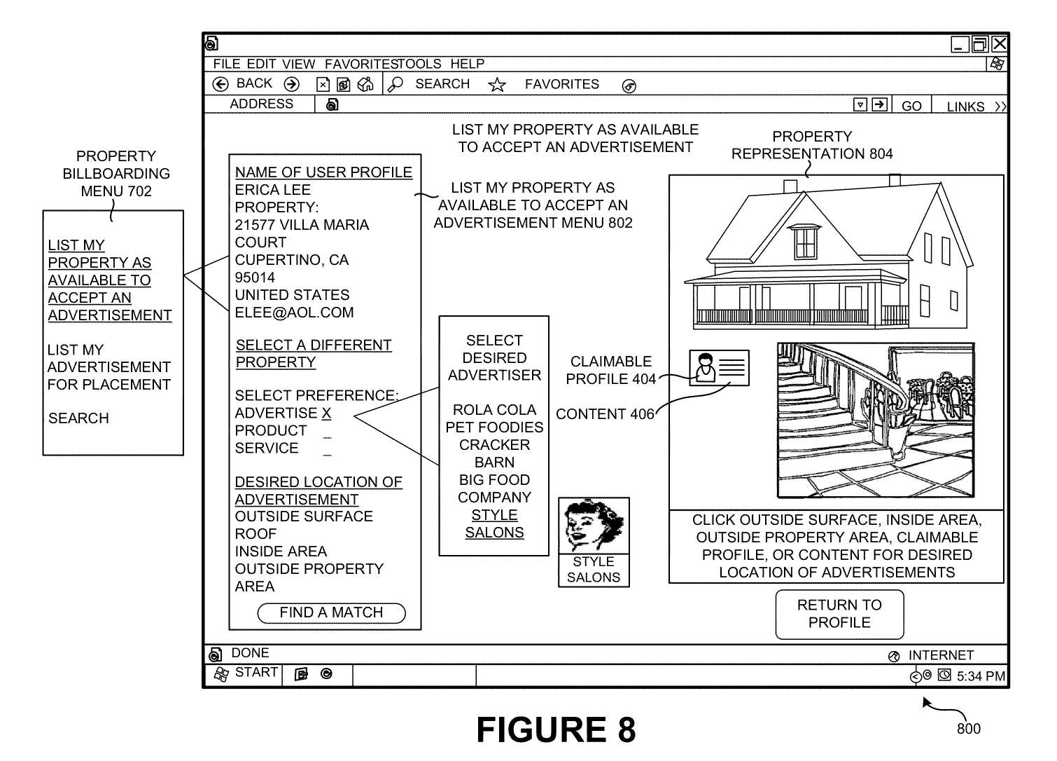

FIG. 8 is a user interface view 800 of listing property of the user 102 as available to accept an advertisement 212, according to one embodiment. Particularly, FIG. 8 illustrates claimable profile 404, the content 406, the property billboarding menu 702, a list my property as available to accept an advertisement menu 802, and a property representation 804, according to one embodiment.

The list my property as available to accept an advertisement menu 802 may display options that enable the user 102 to list hislher property (e.g., in the geo-spatial environment 100) as available to accept the advertisements 212 that are displayed along with the user profiles 204 in the geo-spatial environment 100. The property representation 804 may be representations of physical buildings and/or structures in the geo-spatial environment 100 where the advertisements 212 are displayed.

In the example embodiment illustrated in FIG. 8, the user interface view 800 displays location details of the user 102 (e.g., Erica Lee) in the list my property as available to accept an advertisement menu 802. The user 102 may select an advertisement (e.g., Style Salons) matching her preference (e.g., for advertiser, product and/or service). The user 102 may offer outside surface, inside area, and/or outside property area views associated with a property representation for displaying a matched advertisement 212 in the geo-spatial environment 100. The advertisements 212 may also be displayed along with the claimable profile 404 and the content 406 associated with the user 102.

The first advertisement 212 may be displayed in conjunction with the property representation, selected from a group (e.g., including a representation of an outside surface of a structure, a representation of an inside area of a structure, a representation of an outside property area, a editable portion and/or content associated with the editable portion) associated with the first user profile 204A.

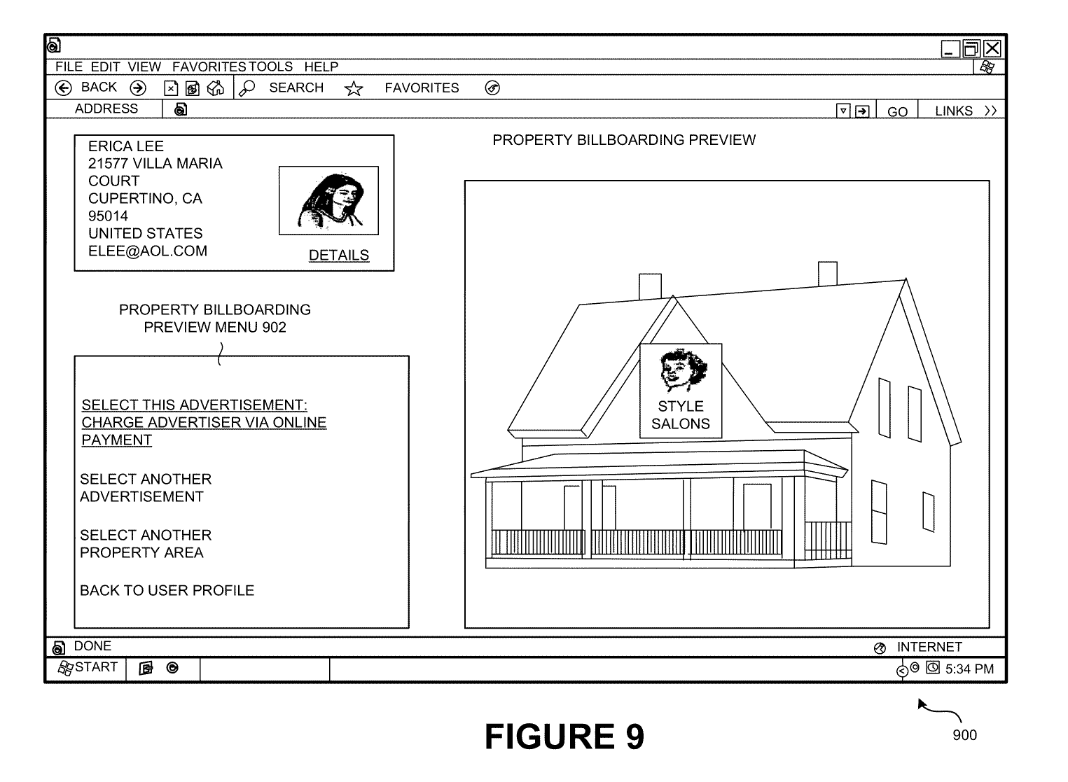

FIG. 9 is a user interface view 900 of the property billboarding preview, according to one embodiment. Particularly, FIG. 9 illustrates a property billboarding preview menu 902, according to one embodiment.

The property billboarding preview menu 902 may display options to confirm the placement of the desired advertisements 212 on a property area associated with the users 102 in the geo-spatial environment 100.

In the example embodiment illustrated in FIG. 9, the user interface view 900 displays the advertisement 212 (e.g., Style Salons) on outside surface of the property representation associated with the user 102 (e.g., Erica Lee) in the geo-spatial environment 100. The users 102 of the geo-spatial environment 100 may select another advertisement 212 and/or another property area based on their preferences (e.g., for advertisers, products and/or services). Online payments may also be performed during the property billboarding in the geo-spatial environment 100 (e.g., using the revenue module 302 of FIG. 3).

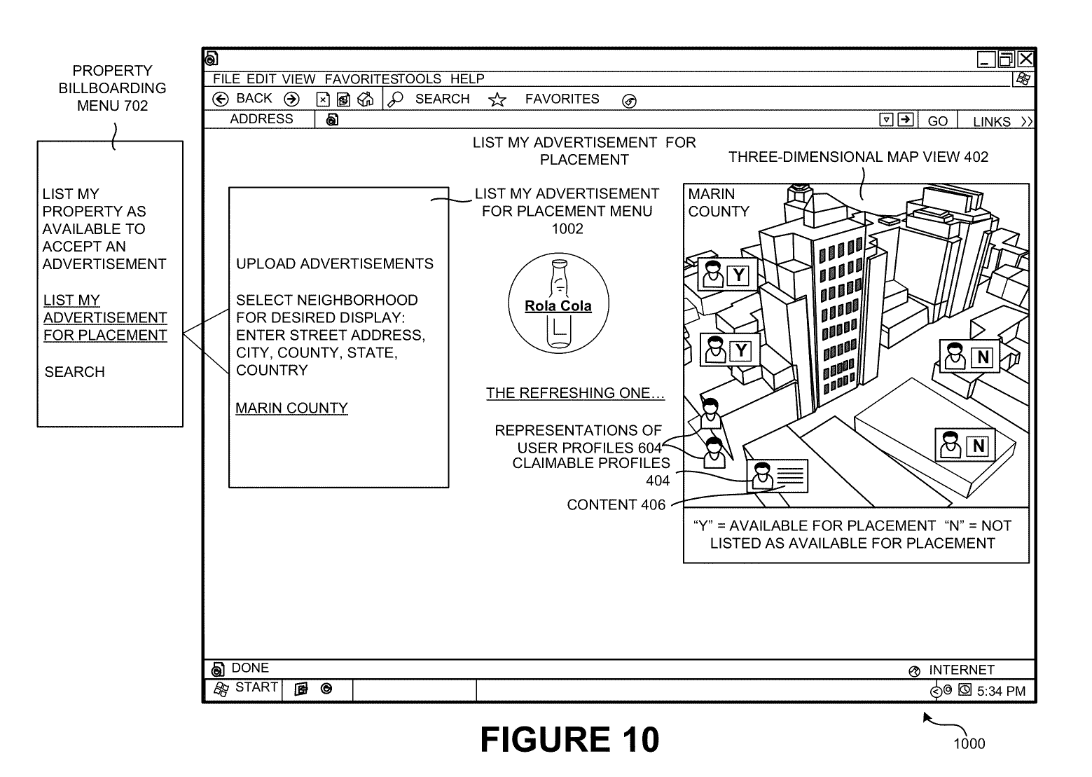

FIG. 10 is a user interface view 1000 of listing an advertisement 212 for placement in the geo-spatial environment 100, according to one embodiment. Particularly, FIG. 10 illustrates the map view 402, the claimable profile 404, the content 406, the representations of user profiles 604, the property billboarding menu 702, a list my advertisement for placement menu 1002, according to one embodiment.

The list my advertisement for placement menu 1002 may display options that enable an advertiser (e.g., may be a user 102) to display the advertisements 212 in the geo-spatial environment 100.

In the example embodiment illustrated in FIG. 10, the list my advertisement for placement menu 1002 displays various options including “upload advertisement” and “select neighborhood for desired display”. The advertiser may upload the advertisements 212 on desired property representations in the geo-spatial environment 100. The map view 402 displays a specific geographic location (e.g., Marin County) where the advertisement 212 (e.g., Rola Cola) is listed to be placed.

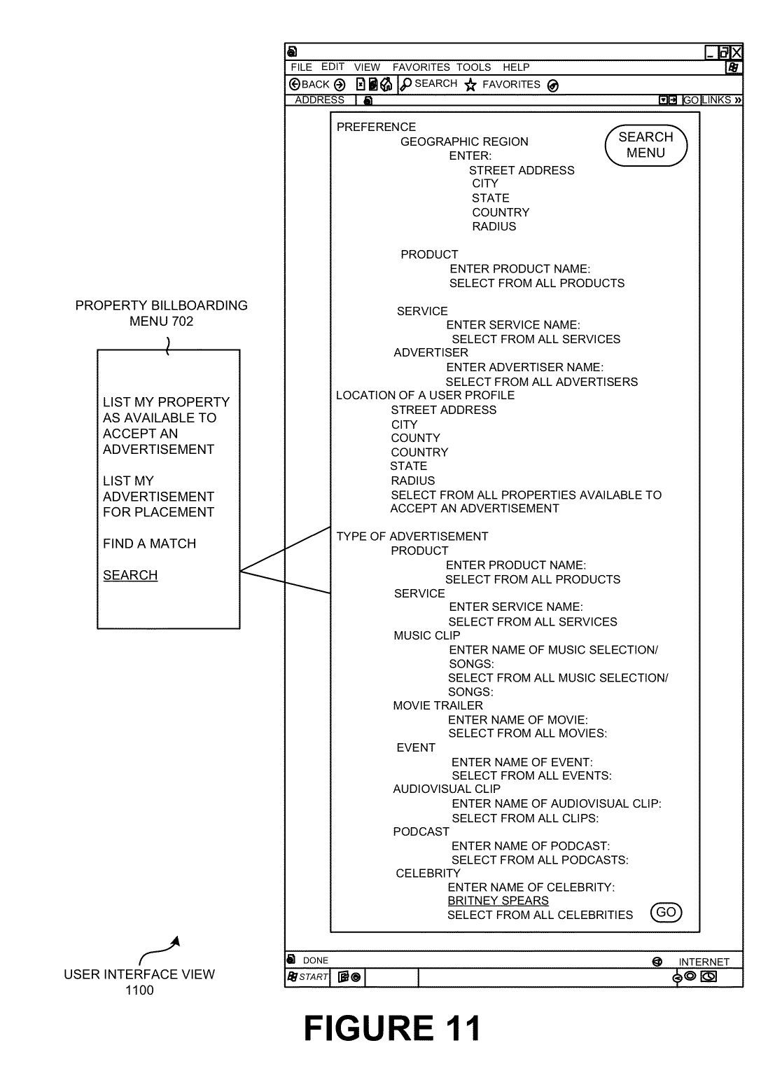

FIG. 11 is a user interface view 1100 of a search menu associated with the property billboarding (e.g., displaying an advertisement 212 in a specific geographic location 206 associated with a user profile 204 of the geospatial environment 100 based on a preference of a user 102 associated with the user profile 204), according to one embodiment. Particularly, FIG. 11 illustrates the property billboarding menu 702, according to one embodiment.

In the example embodiment illustrated in FIG. 11, the search menu displays the search categories 502 (e.g., the preference, the location of a user profile, type of advertisement, etc.) based on which the users 102 search for the desired advertisements 212 that are placed along with the user profiles 204 in the geo-spatial environment 100. The search category preference includes options such as geographic region, product, service and advertiser. The search category location of a user profile 204 includes street address, city, county, state, country, and radius (e.g., from a geospatial location associated with the user profile 204). The type of advertisement 212 includes options such as product, service, music clip, event, audiovisual clip, podcast, and celebrity. The users 102 may enter their preferences (e.g., Britney Spears in a celebrity link in the type of advertisement search category) to obtain the desired advertisements 212 in the geo-spatial environment 100.

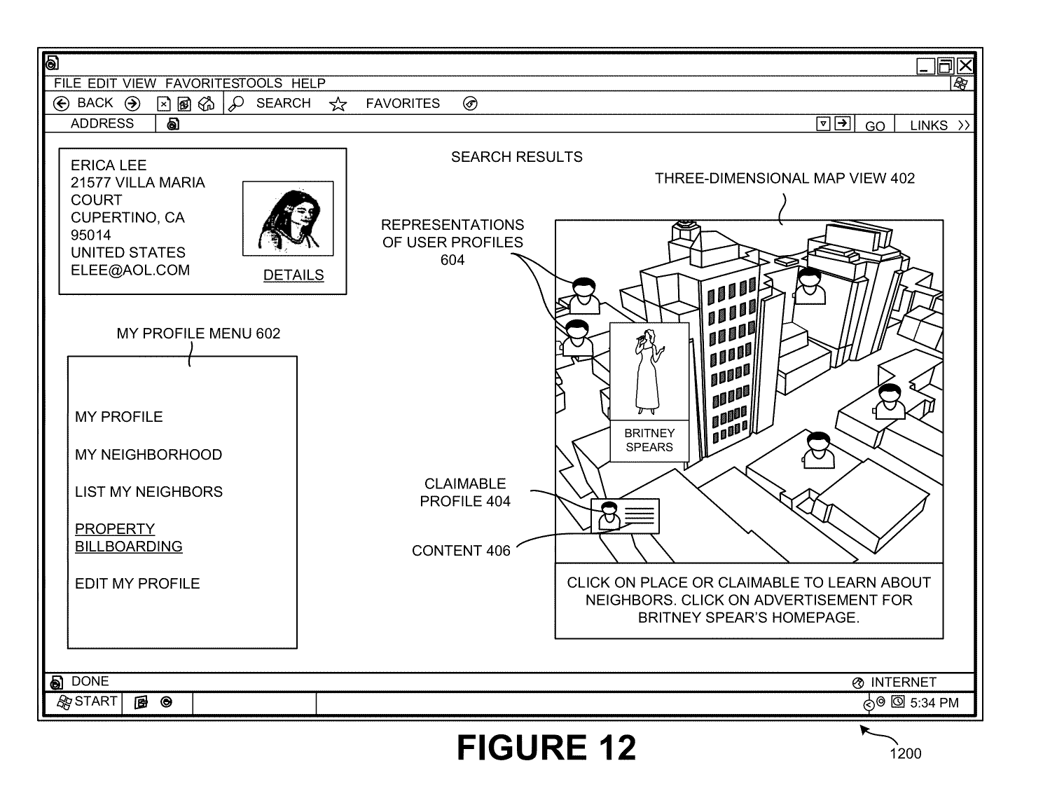

FIG. 12 is a user interface view 1200 displaying search results associated with the property billboarding, according to one embodiment. Particularly, FIG. 12 illustrates the map view 402, the claimable profile 404, the content 406, the my profile menu 602, and the representations of user profiles 604, according to one embodiment.

In the example embodiment illustrated in FIG. 12, the user interface view 1200 displays the search results when ‘Britney Spears’ is entered in the celebrity link in the type of advertisement search category. The users 102 of the geo-spatial environment 100 may click on the advertisement 212 to visualize Britney Spears' homepage. The advertisement 212 may be displayed along with the profile 204 of the user 102 (e.g., Erica Lee). The map view 402 also displays the user profiles 204 in the neighborhood.

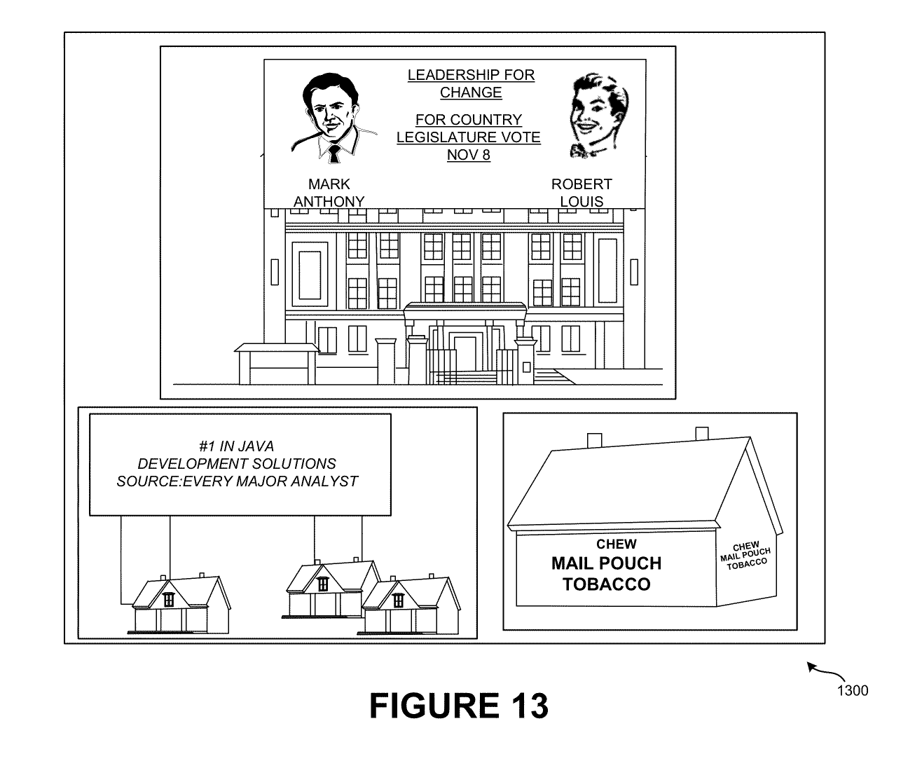

FIG. 13 is a representation 1300 of displayed advertisements 212, according to one embodiment. The advertisements 212 may be displayed on the buildings and/or the structures by advertisers (e.g., seeking to publicize and/or increase demand for their products and/or services). The advertisers may pay owners (e.g., users 102) of the buildings and/or the structures (e.g., through the revenue module 302 of FIG. 3) for displaying the advertisements 212 in specific geographic locations 206 associated with the user profiles 204 of the users 102 in the geo-spatial environment 100).

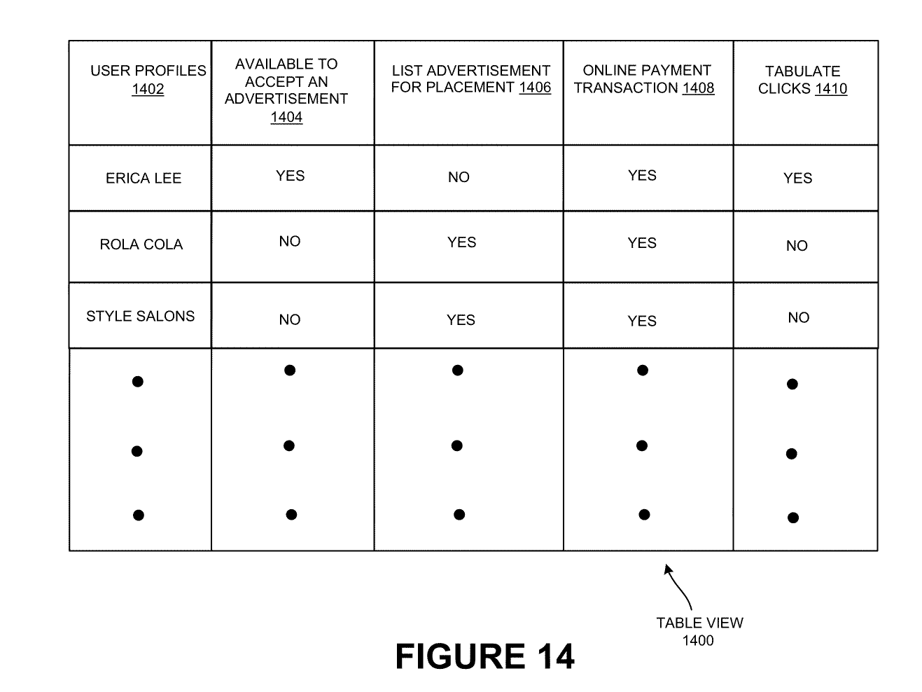

FIG. 14 is a table view 1400 displaying advertisement and commerce transaction information, according to one embodiment. Particularly, FIG. 14 illustrates a user profiles field 1402, an available to accept an advertisement field 1404, a list advertisement for placement field 1406, an online payment transaction field 1408, and a tabulate clicks field 1410, according to one embodiment.

The user profiles field 1402 may display an identifier (e.g., a name, a username, a unique key, etc.) associated with users 102 of the geo-spatial environment 100. The available to accept an advertisement field 1404 may indicate whether or not the users 102 are ready to accept any advertisements 212 to be displayed along with the user profiles, 204 in the geo-spatial environment 100. The list advertisement for placement field 1406 may indicate whether or not the user profiles 204 have any advertisements 212 to be placed along with other user profiles 204 in the geo-spatial environment 100.

The online payment transaction field 1408 may indicate whether or not facilities for online payment transaction are available for the commerce transaction associated with the advertisements 212. The tabulate clicks field 1410 may indicate whether or not clicks of a link associated with an advertisement 212 are tabulated (e.g., by the tabulate module 304 of FIG. 3).

In the example embodiment illustrated in FIG. 14, the user profiles field 1402 displays “Erica Lee” in the first row, “Rola Cola” in the second row and “Style Salons” in the third row of the user profiles field column 1402. The available to accept an advertisement field 1404 displays “Yes” in the first row, “No” in the second row and “No” in the third row of the available to accept an advertisement field column 1404 (e.g., Erica Lee is available to accept the advertisements 212 while Rola Cola and Style Salons are not available to accept any advertisements 212 in the geo-spatial environment 100). The list advertisement for placement field 1406 displays “No” in the first row, “Yes” in the second row and “Yes” in the third row of the list advertisement for placement field column 1406 (e.g., Erica Lee has no advertisement 212 to be placed while Rola Cola and Style Salons do have advertisements 212 listed to be placed in the geo-spatial environment 100). The online payment transaction field 1408 displays “Yes” in the first row, “Yes” in the second row and “Yes” in the third row of the online payment transaction field column 1408 (e.g., online payment transaction options for the advertisements 212 are associated and/or activated with Erica Lee, Rola Cola and Style Salons). The tabulate clicks field 1410 displays “Yes” in the first row, “No” in the second row and “No” in the third row of the tabulate clicks field column 1410 (e.g., clicks of the link associated with the advertisement 212 for Erica Lee are tabulated while no clicks associated with advertisements 212 of Rola Cola and Style Salons are tabulated).

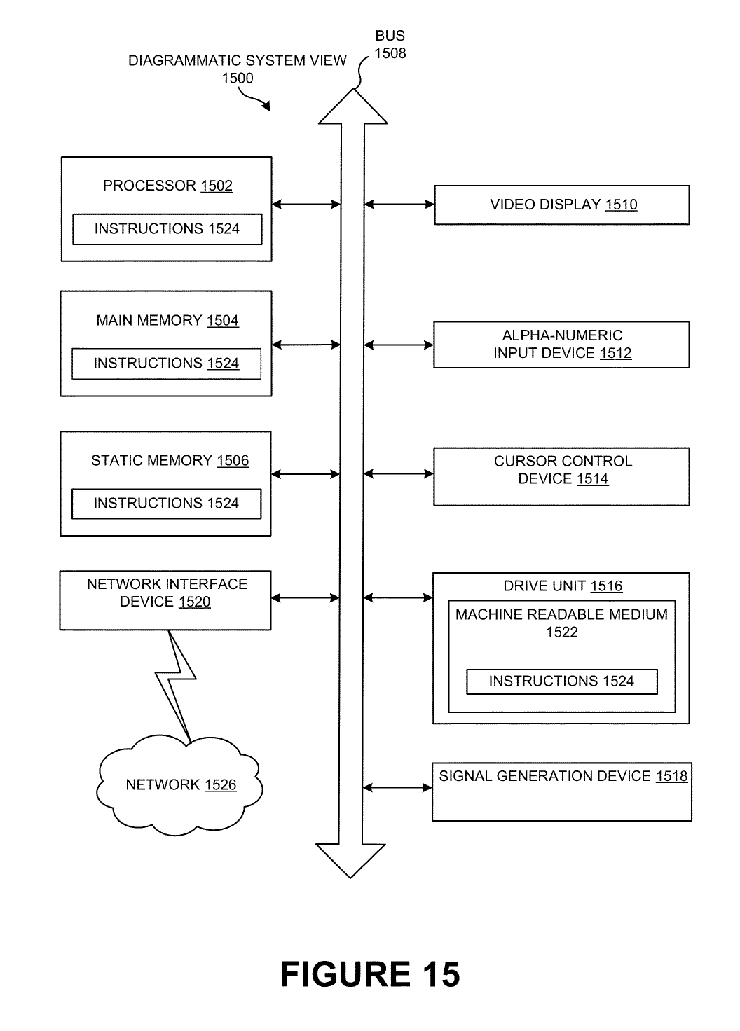

FIG. 15 is a diagrammatic system view 1500 of a data processing system in which any of the embodiments disclosed herein may be performed, according to one embodiment. Particularly, the diagrammatic system view 1500 of FIG. 15 illustrates a processor 1502, a main memory 1504, a static memory 1506, a bus 1508, a video display 1510, an alpha-numeric input device 1512, a cursor control device 1514, a drive unit 1516, a signal generation device 1518, a network interface device 1520, a machine readable medium 1522, instructions 1524, and a network 1526, according to one embodiment.

The diagrammatic system view 1500 may indicate a personal computer and/or the data processing system in which one or more operations disclosed herein are performed. The processor 1502 may be a microprocessor, a state machine, an application specific integrated circuit, a field programmable gate array, etc. (e.g., Intel@ PentiumB processor). The main memory 1504 may be a dynamic random access memory and/or a primary memory of a computer system.

The static memory 1506 may be a hard drive, a flash drive, and/or other memory information associated with the data processing system. The bus 1508 may be an interconnection between various circuits and/or structures of the data processing system. The video display 1510 may provide graphical representation of information on the data processing system. The alpha-numeric input device 1512 may be a keypad, a keyboard and/or any other input device of text (e.g., a special device to aid the physically handicapped),

The cursor control device 1514 may be a pointing device such as a mouse. The drive unit 1516 may be the hard drive, a storage system, and/or other longer term storage subsystem. The signal generation device 1518 may be a bios and/or a functional operating system of the data processing system. The network interface device 1520 may be a device that performs interface functions such as code conversion, protocol conversion and/or buffering required for communication to and from the network 1526. The machine readable medium 1522 may provide instructions on which any of the methods disclosed herein may be performed. The instructions 1524 may provide source code and/or data code to the processor 1502 to enable any one or more operations disclosed herein.

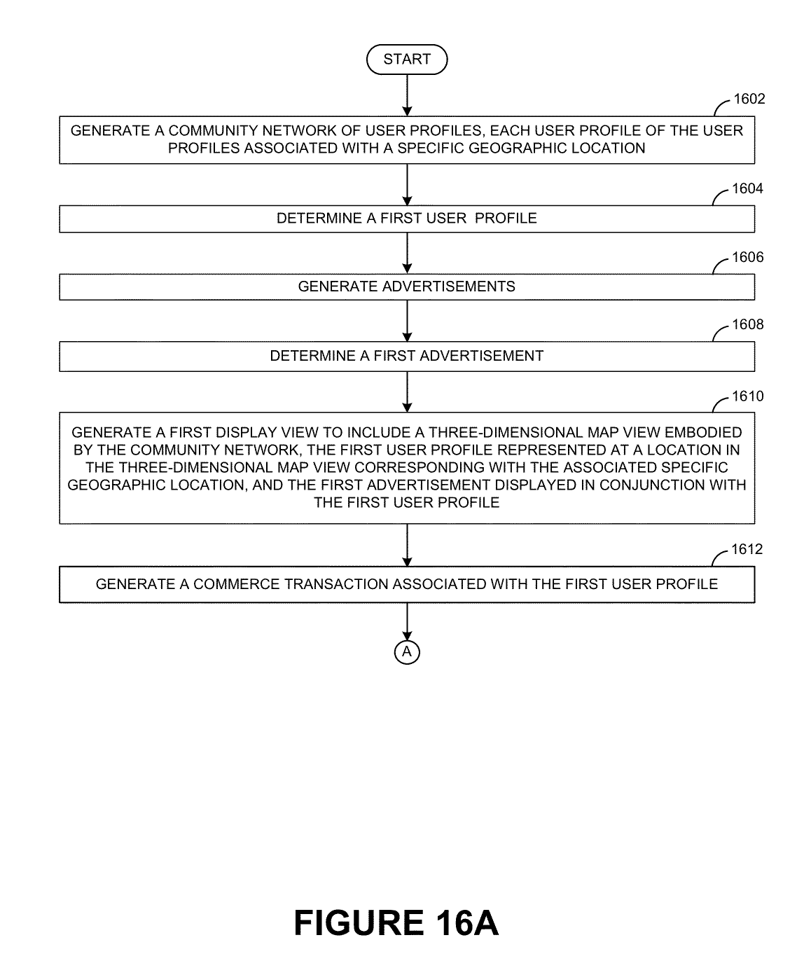

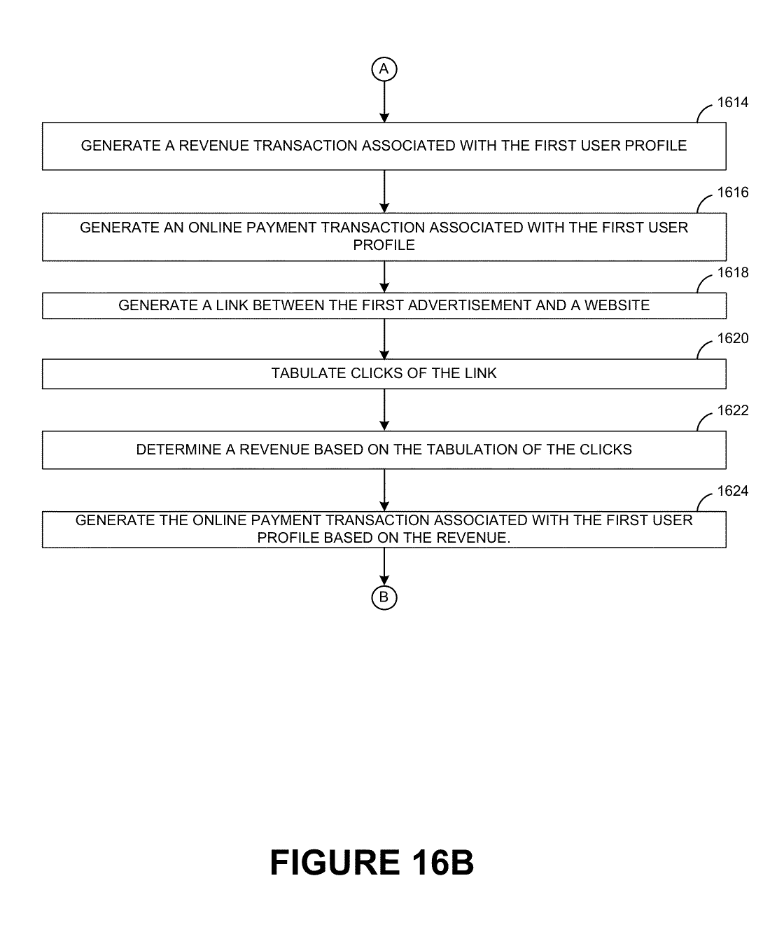

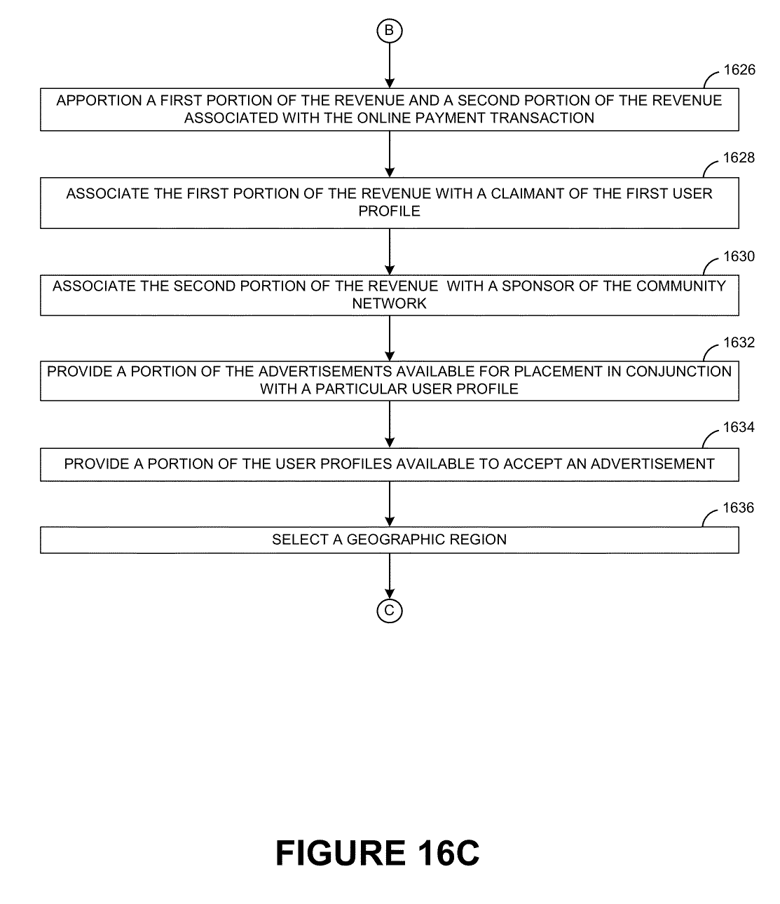

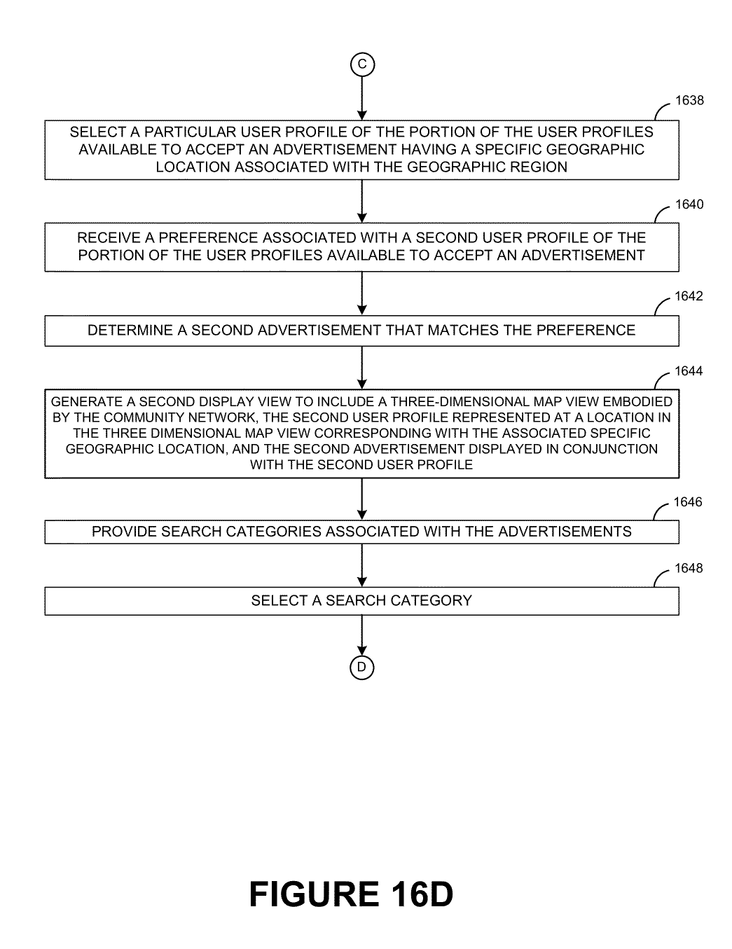

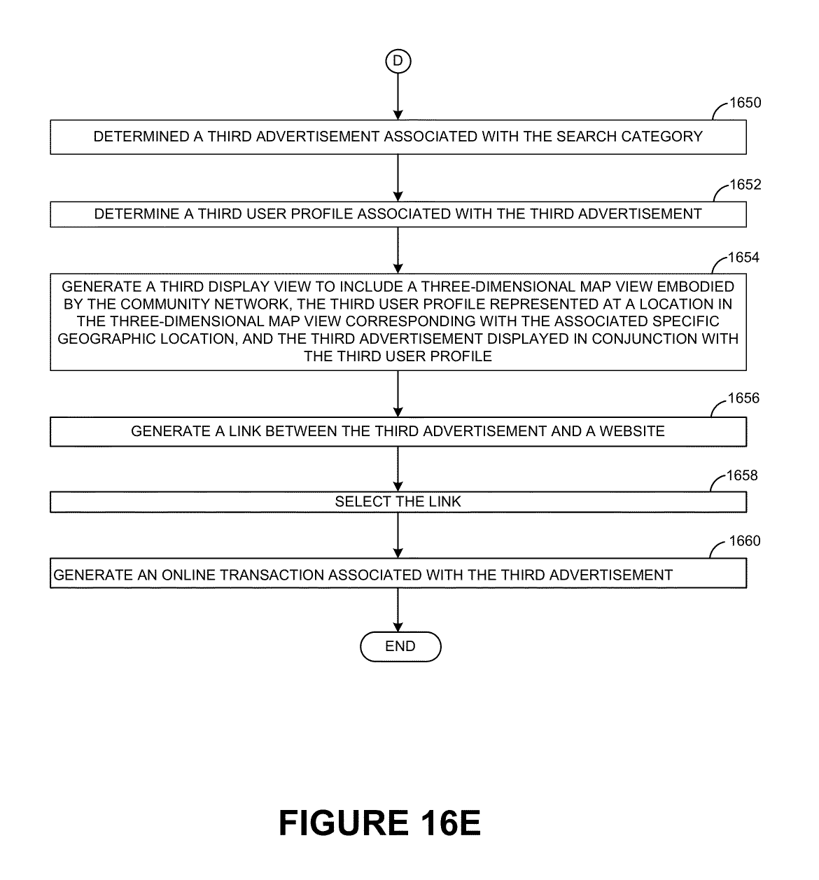

FIG. 16A is a process flow of generating, placing and commerce transaction associated with advertisements 23.2 in a geo-spatial environment 100, according to one embodiment. In operation 1602, a community network (e.g., the community network 200 of FIG. 2) of user profiles (e.g., the user profiles 204 of FIG. 2) may be generated, in which each user profile 204 is associated with a specific geographic location (e.g., the specific geographic location 206 of FIG. 2). In operation 1604, a first user profile (e.g., the first user profile 204A of FIG. 4) may be determined. In operation 1606, advertisements 212 may be generated (e.g., using the advertisement algorithm 110 of FIG. 1). In operation 1608, a first advertisement 212 may be determined.

In operation 1610, a first display view (e.g., the display view 400 of FIG. 4) may be generated to include a map view (e.g., the three-dimensional map view 402 of FIG. 4) embodied by the community network 200, the first user profile 204A represented at a location in the map view 402 corresponding with the associated specific geographic location 206, and the first advertisement 212A displayed in conjunction with the first user profile 204A. In operation 1612, a commerce transaction associated with the first user profile 204A may be generated (e.g., using the commerce transaction algorithm 114 of FIG. 1).

FIG. 16B is a continuation of the process flow of FIG. 16A, showing additional processes, according to one embodiment. In operation 1614, a revenue transaction associated with the first user profile 204A may be generated (e.g., using the revenue module 302 of FIG. 3). In operation 1616, an online payment transaction associated with the first user profile 204A may be generated (e.g., using the online payment module 302A of FIG. 3). In operation 1618, a link between the first advertisement 212A and a website may be generated (e.g., using the advertisement module 110 of FIG. 1).

In operation 1620, clicks of the link may be tabulated (e.g., using the tabulate module 304 of FIG. 3). In operation 1622, a revenue may be determined based on the tabulation of the clicks (e.g., using the revenue module 302 of FIG. 3). In operation 1624, the online payment transaction associated with the first user profile 204A may be generated (e.g., using the online payment module 302A of FIG. 3) based on the revenue.

FIG. 16C is a continuation of the process flow of FIG. 16B, showing additional processes, according to one embodiment. In operation 1626, a first portion of the revenue and a second portion of the revenue associated with the online payment transaction may be apportioned (e.g., using the revenue module 302 of FIG. 3). In operation 1628, the first portion of the revenue may be associated with a claimant of the first user profile 204A. In operation 1630, the second portion of the revenue may be associated with a sponsor of the community network 200.

In operation 1632, a portion of the advertisements 212 available for placement in conjunction with a particular user profile 204 may be provided (e.g., by the advertisement algorithm 110 of FIG. 1). In operation 1634, a portion of the user profiles 204 available to accept an advertisement 212 may be provided (e.g., through the availability module 306 of FIG. 3). In operation 1636, a geographic region (e.g., in the geo-spatial environment 100) may be selected.

FIG. 16D is a continuation of the process flow of FIG. 16C, showing additional processes, according to one embodiment. In operation 1638, a particular user profile 204 of the portion of the user profiles 204 available to accept an advertisement 212 having a specific geographic location 206 associated with the geographic region may be selected. In operation 1640, a preference associated with a second user profile 204 of the portion of the user profiles 204 available to accept an advertisement 212 may be received (e.g., through the preference module 308 of FIG. 3). In operation 1642, a second advertisement 212 that matches the preference may be determined (e.g., using the advertisement algorithm 110 of FIG. 1).

In operation 1644, a second display view may be generated (e.g., using the display algorithm 112 of FIG. 1) to include a map view 402 embodied by the community network 200, the second user profile 204 represented at a location in the map view 402 corresponding with the associated specific geographic location 206, and the second advertisement 212 displayed in conjunction with the second user profile 204. In operation 1646, search categories 502 associated with the advertisements 212 may be provided (e.g., through the search module 310 of FIG. 3). In operation 1648, a search category 502 may be selected.

FIG. 16E is a continuation of the process flow of FIG. 16D, showing additional processes, according to one embodiment. In operation 1650, a third advertisement 212 associated with the search category 502 may be determined (e.g., using the advertisement algorithm 110 of FIG. 1). In operation 1652, a third user profile 204 associated with the third advertisement 212 may be determined.

In operation 1654, a third display view may be generated to include a map view (e.g., the map view 402 of FIG. 4) embodied by the community network 200, the third user profile 204 represented at a location in the map view 402 corresponding with the associated specific geographic location 206, and the third advertisement 212 displayed in conjunction with the third user profile 204. In operation 1656, a link between the third advertisement 212 and a website may be generated (e.g., using the tabulate module 304 of FIG. 3). In operation 1658, the link may be selected. In operation 1660, an online transaction associated with the third advertisement 212 may be generated (e.g., using the online payment module 302A of FIG. 3).

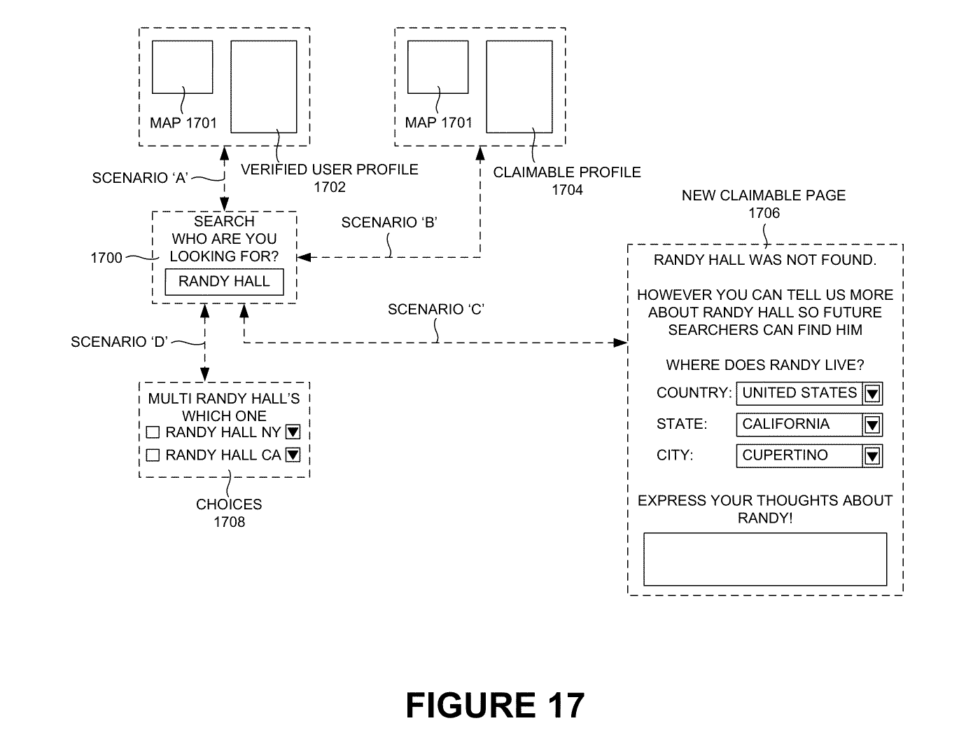

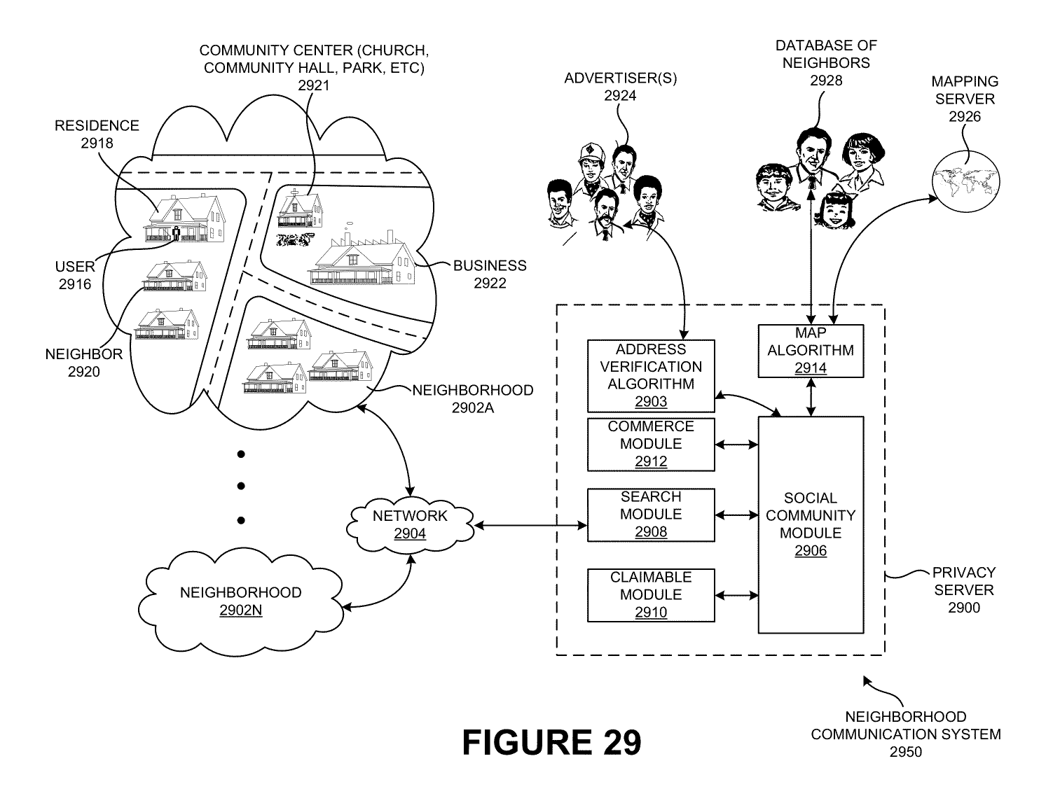

FIG. 17 is a systematic view of communication of claimable data, according to one embodiment. Particularly FIG. 17 illustrates a map 1701, verified user profile 1702, choices 1708 and a new claimable page 1706, according to one embodiment. The map 1701 may locate the details of the address of the registered user of the global neighborhood environment 1800 (e.g., the privacy server 2900 of FIG. 29). The verified user profile 1702 may store the profiles of the verified user of the global neighborhood environment 1800 (e.g., the privacy server 2900 of FIG. 29. The claimable profile 1704 may be the profiles of the registered user who may claim them in the global neighborhood environment 1800 (e.g., the privacy server 2900 of FIG. 29).

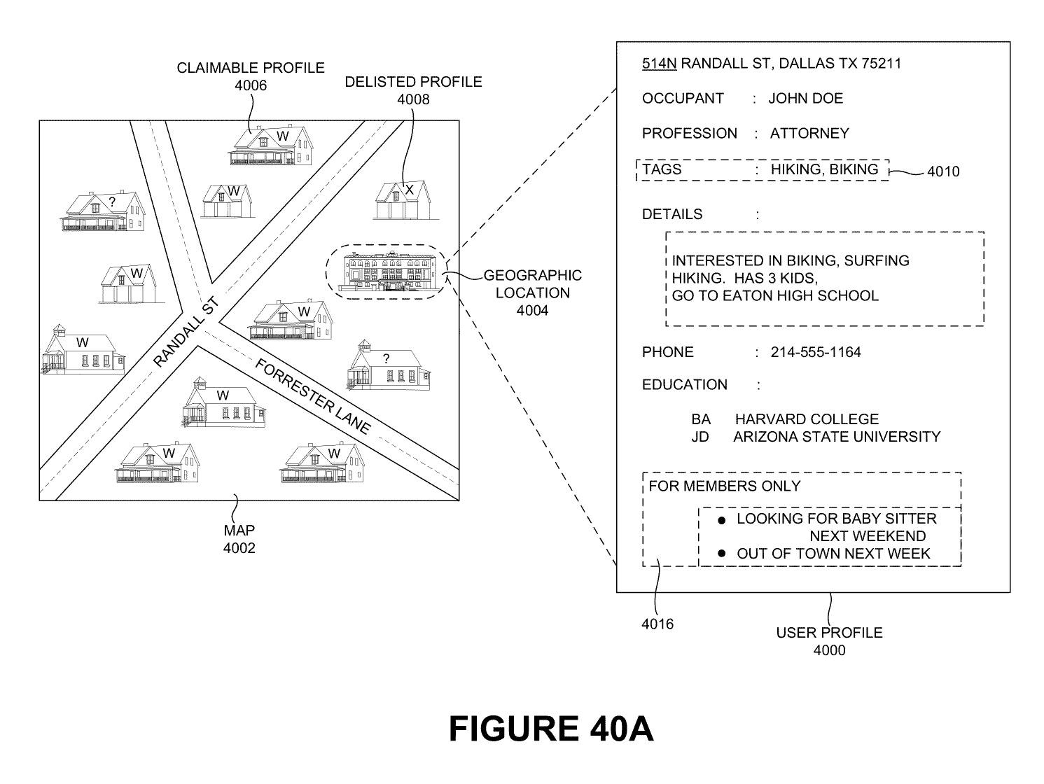

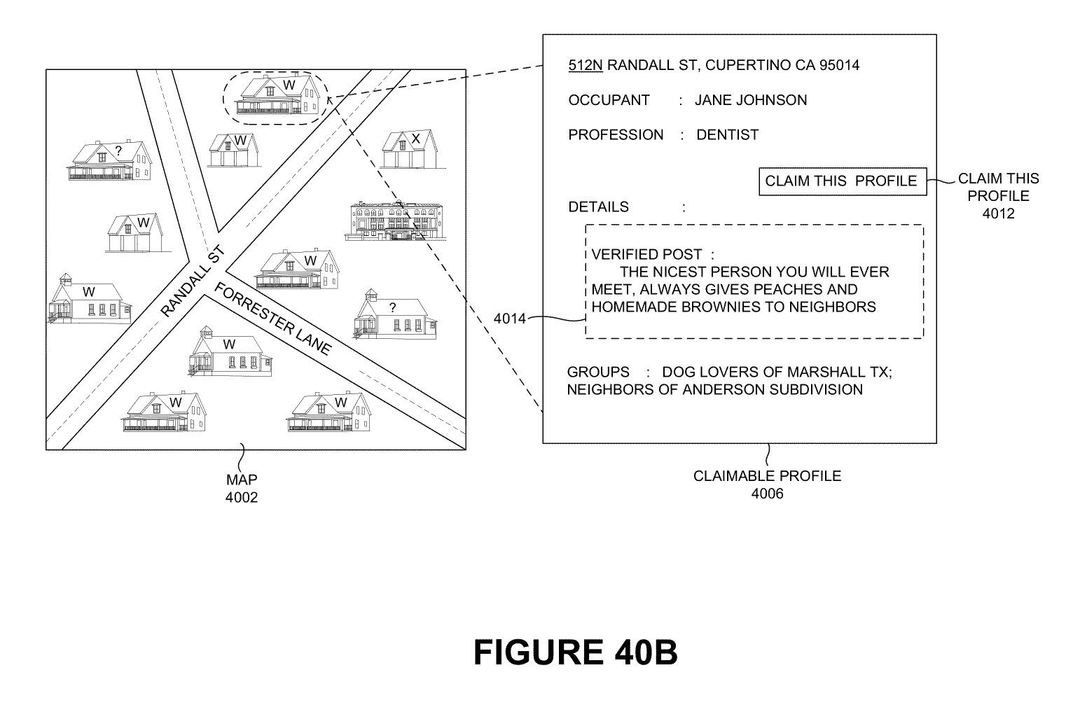

In operation 1700 the search for the user profile (e.g., the user profile 29200 of FIG. 40A) is been carried whom the registered user may be searching. The new claimable page 1706 may solicit for the details of a user whom the registered user is searching for in the global neighborhood environment 1800 (e.g., the privacy server 2900 of FIG. 29). The choices 1708 may ask whether the requested search is any among the displayed names. The new claimable page 1706 may request for the details of location such as country, state and/or city. The operation 1700 may communicate with the choices 1708, and the new claimable page 1706.

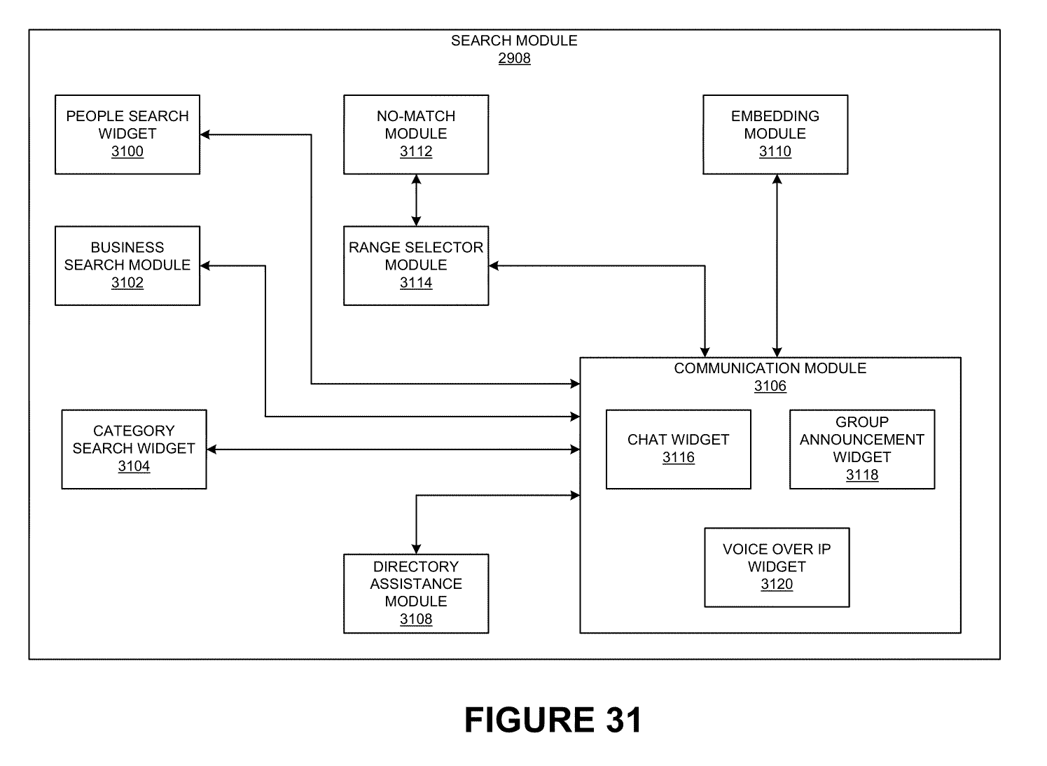

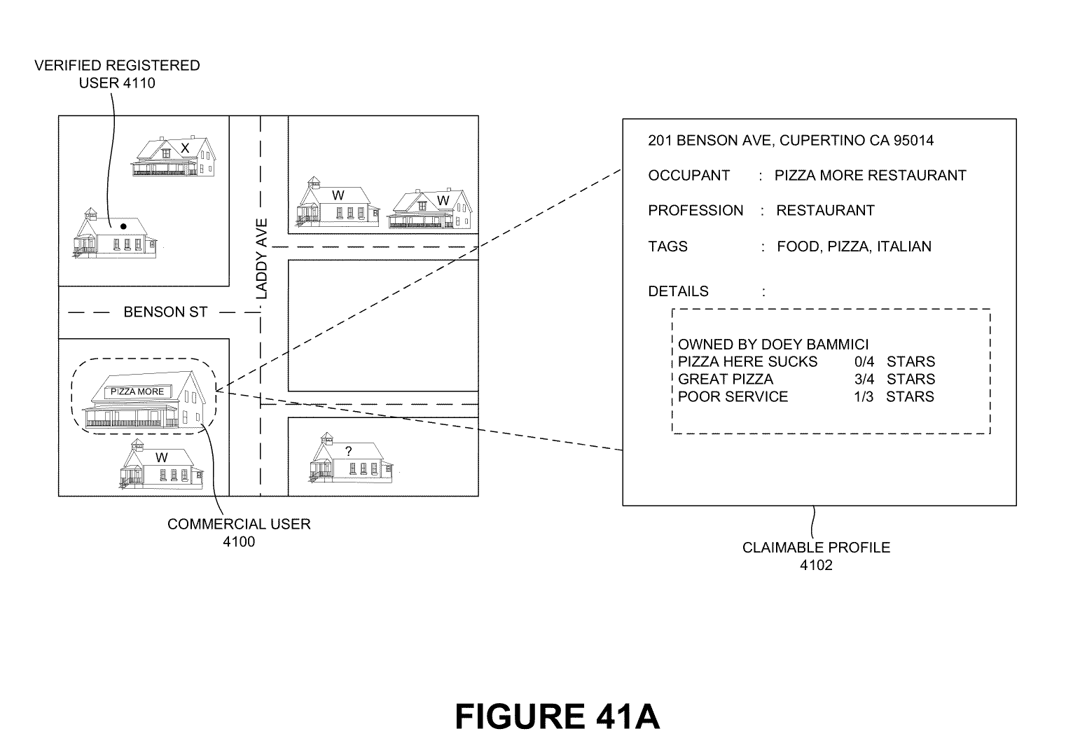

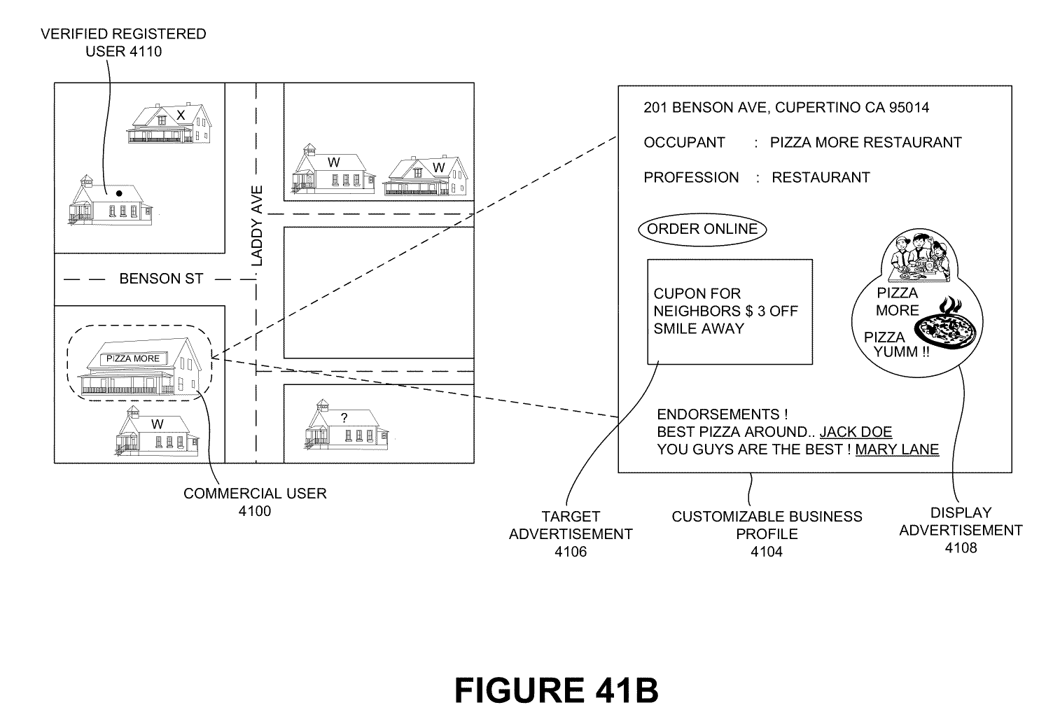

For example, a no-match module (e.g., a no-match module 3112 of FIG. 31) of the search module (e.g., the search module 2908 of FIG. 29)to request additional information from the verified registered user about a person, place, and business having no listing in the global neighborhood environment 1800 (e.g., the privacy server 2900 of FIG. 29) when no matches are found in a search query of the verified registered user (e.g., the verified registered user 4110 of FIG. 41A-B), and to create a new claimable page 1706 based on a response of the verified registered profile 1702 about the at least one person, place, and business not previously indexed in the global neighborhood environment 1800 (e.g., the privacy server 2900 of FIG. 29).

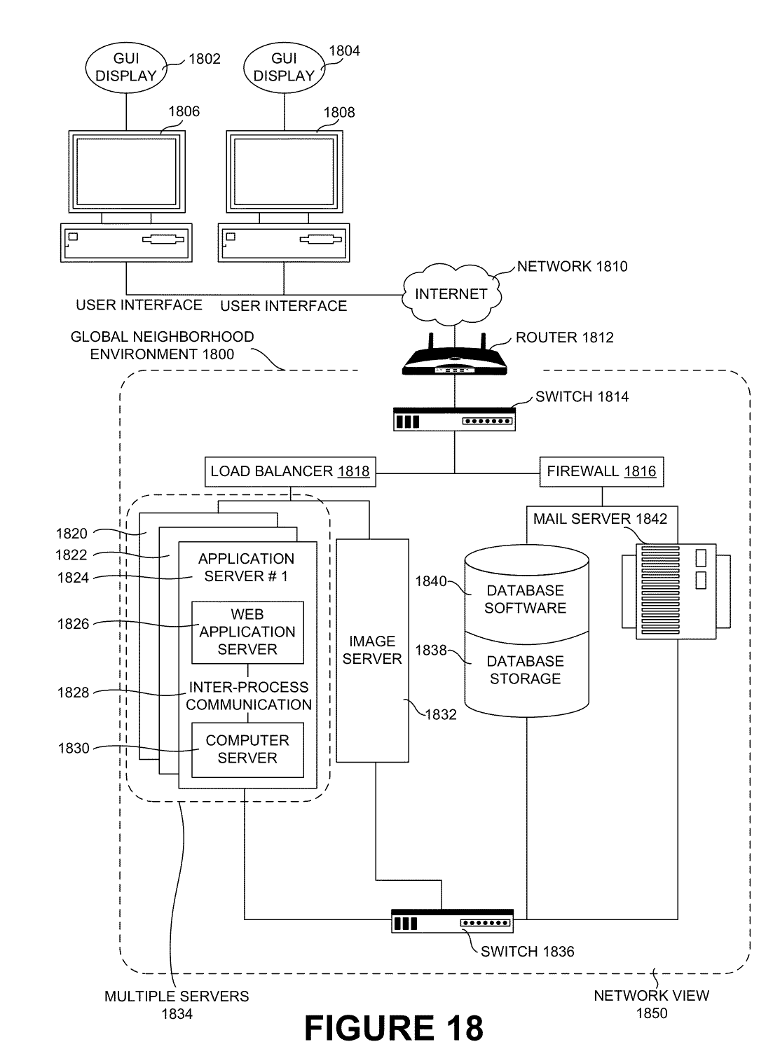

FIG. 18 is a systematic view of a network view 1850, according to one embodiment. Particularly it may include a GUI display 1802, a GUI display 1804, device 1806, a device 1808, a network 1810, a router 1812, a switch 1814, a firewall 1816, a load balancer 1818, an application server #3 1820, an application server #2 1822, an application server#1 1824, a web application server 1826, an inter-process communication 1828, a computer server 1830, an image server 1832, a multiple servers 1834, a switch 1836, a database storage 1838

, database software 1840 and a mail server 1842, according to one embodiment.

The GUI display 1802 and GUI display 1804 may display particular case of user interface for interacting with a device capable of representing data (e.g., computer, cellular telephones, television sets etc.) which employs graphical images and widgets in addition to text to represent the information and actions available to the user (e.g., the user 2916 of FIG. 29). The device 1806 and device 1808 may be any device capable of presenting data (e.g., computer, cellular telephones, television sets etc.). The network 1810 may be any collection of networks (e.g., internet, private networks, university social system, private network of a company etc.) that may transfer any data to the user (e.g., the user 2916 of FIG. 29) and the global neighborhood environment 1800 (e.g., the privacy server 2900 of FIG. 29).

The router 1812 may forward packets between networks and/or information packets between the global neighborhood environment 1800 (e.g., the privacy server 2900 of FIG. 29) and registered user over the network (e.g., internet). The switch 1814 may act as a gatekeeper to and from the network (e.g., internet) and the device. The firewall 1816 may provides protection (e.g., permit, deny or proxy data connections) from unauthorized access to the global neighborhood environment 1800 (e.g., the privacy server 2900 of FIG. 29. The load balancer 1818 may balance the traffic load across multiple mirrored servers in the global neighborhood environment 1800 (e.g., the privacy server 2900 of FIG. 29) and may be used to increase the capacity of a server farm beyond that of a single server and/or may allow the service to continue even in the face of server down time due to server failure and/or server maintenance.

The application server #2 1822 may be server computer on a computer network dedicated to running certain software applications of the global neighborhood environment 1800 (e.g., the privacy server 2900 of FIG. 29). The web application server 1826 may be server holding all the web pages associated with the global neighborhood environment 1800 (e.g., the privacy server 2900 of FIG. 29). The inter-process communication 1828 may be set of rules for organizing and un-organizing factors and results regarding the global neighborhood environment 1800 (e.g., the privacy server 2900 of FIG. 29). The computer server 1830 may serve as the application layer in the multiple servers of the global neighborhood environment 1800 (e.g., the privacy server 2900 of FIG. 29) and/or may include a central processing unit (CPU), a random access memory (RAM) temporary storage of information, and/or a read only memory (ROM) for permanent storage of information regarding the global neighborhood environment 1800 (e.g., the privacy server 2900 of FIG. 29).

The image server 1832 may store and provide digital images of the registered user of the global neighborhood environment 1800 (e.g., the privacy server 2900 of FIG. 29). The multiple servers 1834 may be multiple computers or devices on a network that may manages network resources connecting the registered user and the global neighborhood environment 1800 (e.g., the privacy server 2900 of FIG. 29). The database storage 1838 may store software, descriptive data, digital images, system data and any other data item that may be related to the user (e.g., the user 2916 of FIG. 29) of the global neighborhood environment 1800 (e.g., the privacy server 2900 of FIG. 29). The database software 1840 may be provided a database management system that may support the global neighborhood environment 1800 (e.g., the neighborhood environment 2900 of FIG. 29. The mail server 1842 may be provided for sending, receiving and storing mails. The device 1806 and 1808 may communicate with the GUI display(s) 1802 and 1804, the router 1812 through the network 1810 and the global neighborhood environment 1800 (e.g., the privacy server 2900 of FIG. 29).

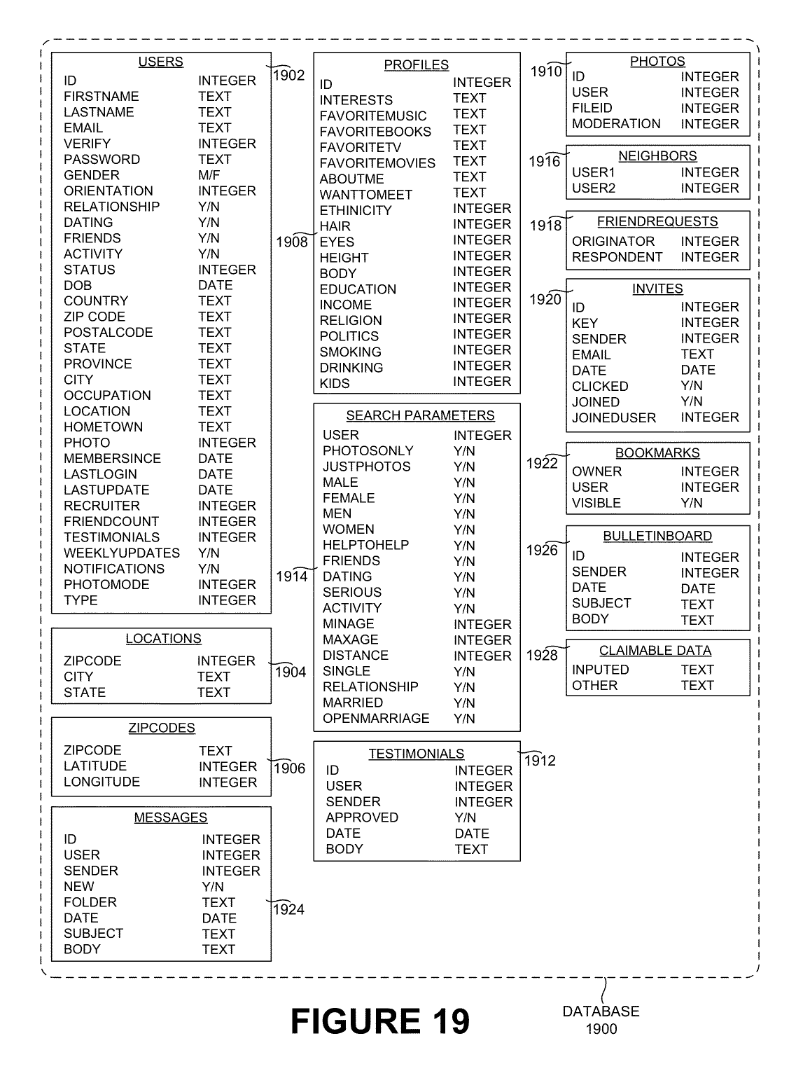

FIG. 19 is a block diagram of a database, according to one embodiment. Particularly the block diagram of the database 1900 of FIG. 19 illustrates a user data 1902, a location data, a zip codes data 1906, a profiles data 1908, a photos data 1910, a testimonials data 1912, a search parameters data,

a neighbor data 1916, a friends requests data 1918, a invites data 1920, a bookmarks data 1922, a messages data 1924 and a bulletin board data 1926, according to one embodiment.

The database 1900 be may include descriptive data, preference data, relationship data, and/or other data items regarding the registered user of the global neighborhood environment 1800 (e.g., the privacy server 2900 of FIG. 29.

The user data 1902 may be a descriptive data referring to information that may describe a user (e.g., the user 2916 of FIG. 29). It may include elements in a certain format for example Id may be formatted as integer, Firstname may be in text, Lastname may be in text, Email may be in text, Verify may be in integer, Password may be in text, Gender may be in m/f, Orientation may be in integer, Relationship may be in y/n, Dating may be in y/n, Friends may be in y/n, Activity may be in y/n, Status may be in integer, Dob may be in date, Country may be in text, Zip code may be in text, Postalcode may be in text, State may be in text, Province may be in text, City may be in text, Occupation may be in text, Location may be in text, Hometown may be in text, Photo may be in integer, Membersince may be in date, Lastlogin may be in date, Lastupdate may be in date, Recruiter may be in integer, Friendcount may be in integer, Testimonials may be in integer, Weeklypdates may be in y/n, Notifications may be in y/n, Photomode may be in integer and/or Type may be in integer.

The locations data 1904 may clarify the location details in formatted approach. For example Zip code may be formatted as integer, City may be in text and/or State may be in text. The zip codes data 1906 may provide information of a user location in formatted manner. For example Zip code may be formatted as text, Latitude may be in integer and/or Longitude may be in integer. The profile data 1908 may clutch personnel descriptive data that may be formatted.

For examples ID may be formatted as integer, Interests may be in text, Favoritemusic may be in text, Favaoritebooks may be in text, Favoritetv may be in text, Favoritemovies may be in text, Aboutme may be in text, Wanttommet may be in text, Ethnicity may be in integer, Hair may be in integer, Eyes may be in integer, Height may be in integer, Body may be in integer, Education may be in integer, Income may be in integer, Religion may be in integer, Politics may be in integer Smoking may be in integer, Drinking may be in integer and/or Kids may be in integer.

The photos data 1910 may represent a digital image and/or a photograph of the user formatted in certain approach. For example Id may be formatted as integer, User may be in integer, Field may be in integer and/or Moderation may be in integer. The testimonials data 1912 may allow users to write “testimonials” 1912, or comments, about each other and in these testimonials, users may describe their relationship to an individual and their comments about that individual. For example the user might write a testimonial that states “Rohan has been a friend of mine since graduation days. He is smart, intelligent, and a talented person.” The elements of testimonials data 1912 may be formatted as Id may be in integer, User may be in integer, Sender may be integer, Approved may be in y/n, Date may be in date and/or Body may be formatted in text.

The search parameters data 1914 may be preference data referring to the data that may describe preferences one user has with respect to another (For example, the user may indicate that he is looking for a female who is seeking a male for a serious relationship). The elements of the search parameters data 1914 may be formatted as User 1902 may be in integer, Photosonly may be in y/n, Justphotos may be in y/n, Male may be in y/n, Female may be in y/n, Men may be in y/n, Women may be in y/n, Helptohelp may be in y/n, Friends may be in y/n, Dating may be in y/n, Serious may be in y/n, Activity may be in y/n, Minage may be in integer, Maxage may be in integer, Distance may be in integer, Single may be in y/n, Relationship may be in y/n, Married may be in y/n and/or Openmarriage may be in y/n.

The neighbor's data 1916 may generally refer to relationships among registered users of the global neighborhood environment 1800 (e.g., the privacy server 2900 of FIG. 29) that have been verified and the user has requested another individual to join the system as neighbor 1916, and the request may be accepted. The elements of the neighbors data 1916 may be formatted as user1 may be in integer and/or user2 may be in integer. The friend requests data 1918 may tracks requests by users within the neighborhood (e.g., the neighborhood 2902A-N of FIG. 29) to other individuals, which requests have not yet been accepted and may contain elements originator and/or respondent formatted in integer. The invites data 1920 may describe the status of a request by the user to invite an individual outside the neighborhood (e.g., the neighborhood 2902A-N of FIG. 29) to join the neighborhood (e.g., the neighborhood 2902A-N of FIG. 29) and clarify either the request has been accepted, ignored and/or pending.

The elements of the invites data 1920 may be formatted as Id may be in integer, Key may be in integer, Sender may be in integer, Email may be in text, Date may be in date format, Clicked may be in y/n, Joined may be in y/n and/or Joineduser may be in integer. The bookmarks data 1922 may be provide the data for a process allowed wherein a registered user of the global neighborhood environment 1800 (e.g., the privacy server 2900 of FIG. 29) may indicate an interest in the profile of another registered user. The bookmark data 1922 elements may be formatted as Owner may be in integer, User may be in integer and/or Visible may be in y/n. The message data 1924 may allow the users to send one another private messages.

The message data 1924 may be formatted as Id may be in integer, User may be in integer, Sender may be in integer, New may be in y/n, Folder may be in text, Date may be in date format, Subject may be in text and/or Body may be in text format. The bulletin board data 1926 may supports the function of a bulletin board that users may use to conduct online discussions, conversation and/or debate. The claimable data 1928 may share the user profiles (e.g., the user profile 29200 of FIG. 40A) in the neighborhood (e.g., the neighborhood 2902A-N of FIG. 29) and its elements may be formatted as claimables inputted and/or others may be in text format.

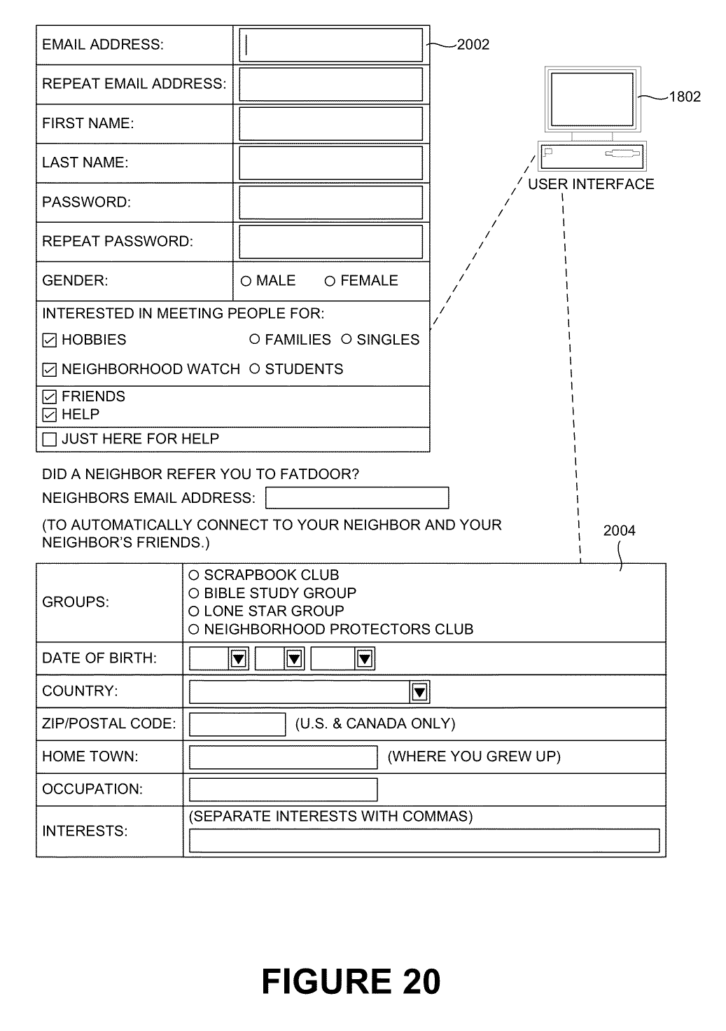

FIG. 20 is an exemplary graphical user interface view for data collection, according to one embodiment. Particularly FIG. 20 illustrates exemplary screens,

2004 that may be provided to the user (e.g., the user 2916 of FIG. 29) through a user interface 1802 may be through the network (e.g., Internet), to obtain user descriptive data. The screen 2002 may collect data allowing the user (e.g., the user 2916 of FIG. 29) to login securely and be identified by the neighborhood (e.g., the neighborhood 2902A-N of FIG. 29). This screen 2002 may allow the user to identify the reason he/she is joining the neighborhood. For example, a user may be joining the neighborhood for “neighborhood watch”. The screen 2004 may show example of how further groups may be joined. For example, the user (e.g., the user 2916 of FIG. 29) may be willing to join a group “Scrapbook club”. It may also enclose the data concerning Dob, country, zip/postal code, hometown, occupation and/or interest.

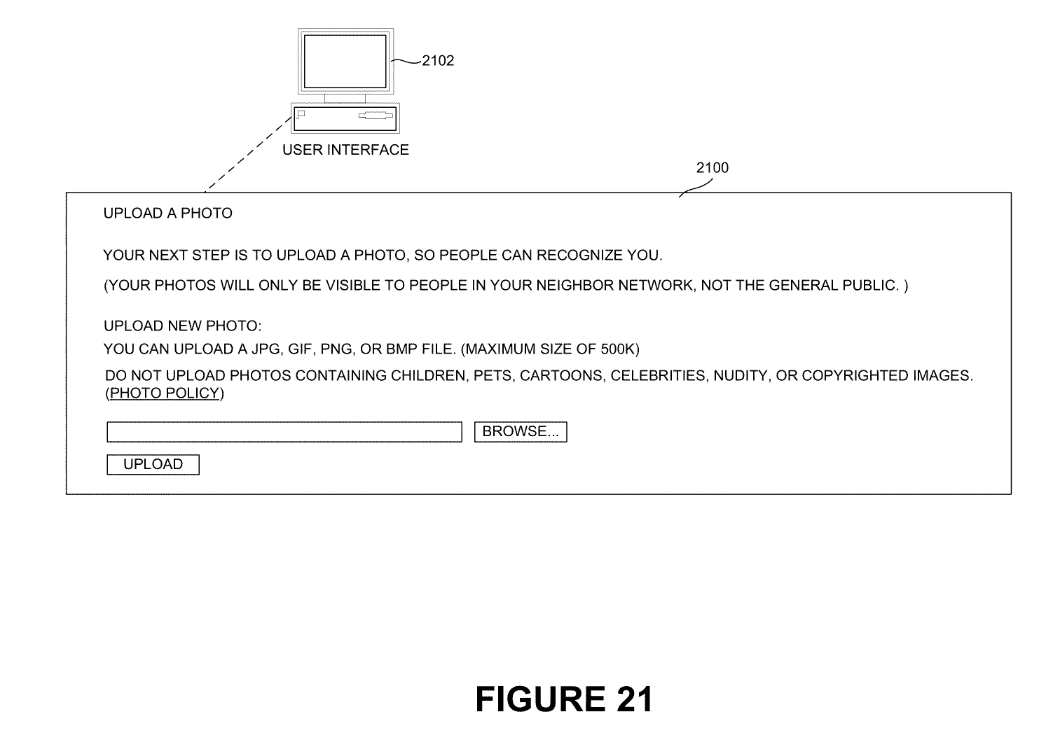

FIG. 21 is an exemplary graphical user interface view of image collection, according to one embodiment. A screen 2100 may be interface provided to the user (e.g., the user 2916 of FIG. 29) over the network (e.g., internet) may be to obtain digital images from system user. The interface 2102 may allow the user (e.g., the user 2916 of FIG. 29) to browse files on his/her computer, select them, and then upload them to the neighborhood (e.g., the neighborhood 2902A-N of FIG. 29). The user (e.g., the user 2916 of FIG. 29) may upload the digital images and/or photo that may be visible to people in the neighbor (e.g., the neighbor 2920 of FIG. 29) network and not the general public. The user may be able to upload a JPG, GIF, PNG and/or BMP file in the screen 2100.

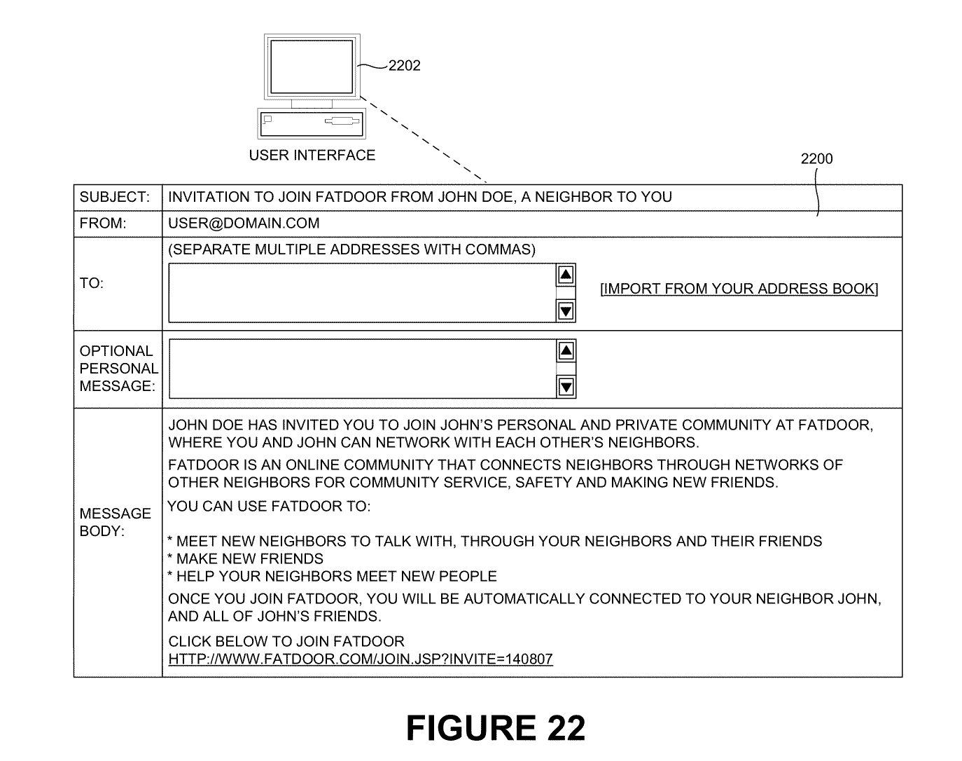

FIG. 22 is an exemplary graphical user interface view of an invitation, according to one embodiment. An exemplary screen 2200 may be provided to a user through a user interface 2202 may be over the network (e.g., internet) to allow users to invite neighbor or acquaintances to join the neighborhood (e.g., the neighborhood 2902A-N of FIG. 29). The user interface 2202 may allow the user (e.g., the user 2916 of FIG. 29) to enter one or a plurality of e-mail addresses for friends they may like to invite to the neighborhood (e.g., the neighborhood 2902A-N of FIG. 29). The exemplary screen 2200 may include the “subject”, “From”, “To”, “Optional personnel message”, and/or “Message body” sections. In the “Subject” section a standard language text may be included for joining the neighborhood (e.g., Invitation to join Fatdoor from John Doe, a neighborhood.).

The “From” section may include the senders email id (e.g., user@domain.com). The “To” section may be provided to add the email id of the person to whom the sender may want to join the neighborhood (e.g., the neighborhood 2902A-N of FIG. 29). The message that may be sent to the friends and/or acquaintances may include standard language describing the present neighborhood, the benefits of joining and the steps required to join the neighborhood (e.g., the neighborhood 2902A-N of FIG. 29). The user (e.g., the user 2916 of FIG. 29) may choose to include a personal message, along with the standard invitation in the “Optional personal message” section. In the “Message body” section the invited friend or acquaintance may initiate the process to join the system by clicking directly on an HTML link included in the e-mail message (e.g., http://www.fatdoor.com/join.jsp? Invite=140807). In one embodiment, the user (e.g., the user 2916 of FIG. 29) may import e-mail addresses from a standard computerized address book. The system may further notify the inviting user when her invitee accepts or declines the invitation to join the neighborhood (e.g., the neighborhood 2902A-N of FIG. 29).

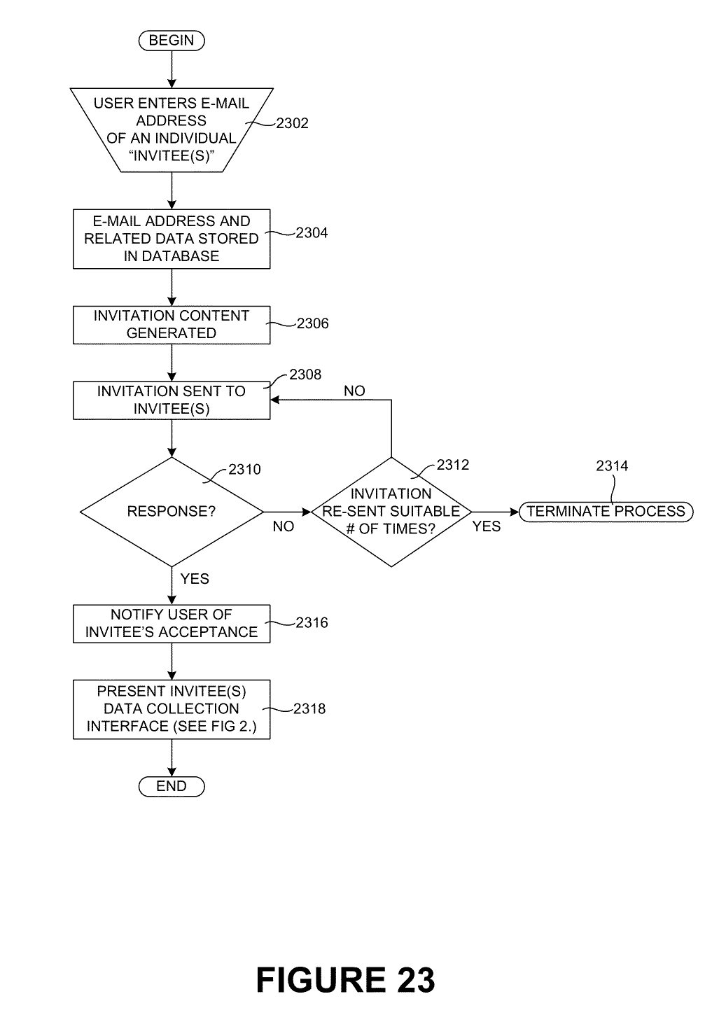

FIG. 23 is a flowchart of inviting the invitee(s) by the registered user, notifying the registered user upon the acceptance of the invitation by the invitee(s) and, processing and storing the input data associated with the user (e.g., the user 2916 of FIG. 29) in the database, according to one embodiment. In operation 2302, the verified registered user (e.g., the verified registered user 4110 of FIG. 41A-B) willing to invite the individual enters the email addresses of an individual “invitee”. In operation 2304, the email address and the related data of the invitee may be stored in the database. In operation 2306, the invitation content for inviting the invitee may be generated from the data stored in the database. In operation 2308, the registered user sends invitation to the invitee(s).

In operation 2310, response from the user (e.g., the user 2916 of FIG. 29) may be determined. The operation 2312, if the invitee doesn't respond to invitation sent by the registered user then registered user may resend the invitation for a predefined number of times. In operation 2314, if the registered user resends the invitation to the same invitee for predefined number of times and if the invitee still doesn't respond to the invitation the process may be terminated automatically.

In operation 2316, if the invitee accepts the invitation sent by the registered user then system may notify the registered user that the invitee has accepted the invitation. In operation 2318, the input from the present invitee(s) that may contain the descriptive data about the friend (e.g., registered user) may be processed and stored in the database.

For example, each registered user associated e-mail addresses of individuals who are not registered users may be stored and identified by each registered user as neighbors. An invitation to become a new user (e.g., the user 2916 of FIG. 29) may be communicated out to neighbor (e.g., the neighbors neighbor of FIG. 29) of the particular user. An acceptance of the neighbor (e.g., the neighbor 2920 of FIG. 29) to whom the invitation was sent may be processed.

The neighbor (e.g., the neighbor 2920 of FIG. 29) may be added to a database and/or storing of the neighbor (e.g., the neighbor 2920 of FIG. 29), a user ID and a set of user IDs of registered users who are directly connected to the neighbor (e.g., the neighbor 2920 of FIG. 29), the set of user IDs stored of the neighbor (e.g., the neighbor 2920 of FIG. 29) including at least the user ID of the verified registered user (e.g., the verified registered user 4110 of FIG. 41A-B). Furthermore, the verified registered user may be notified that the invitation to the neighbor (e.g., the neighbor 2920 of FIG. 29) has been accepted when an acceptance is processed. Also, inputs from the neighbor (e.g., the neighbor 2920 of FIG. 29) having descriptive data about the friend may be processed and the inputs in the database may be stored.

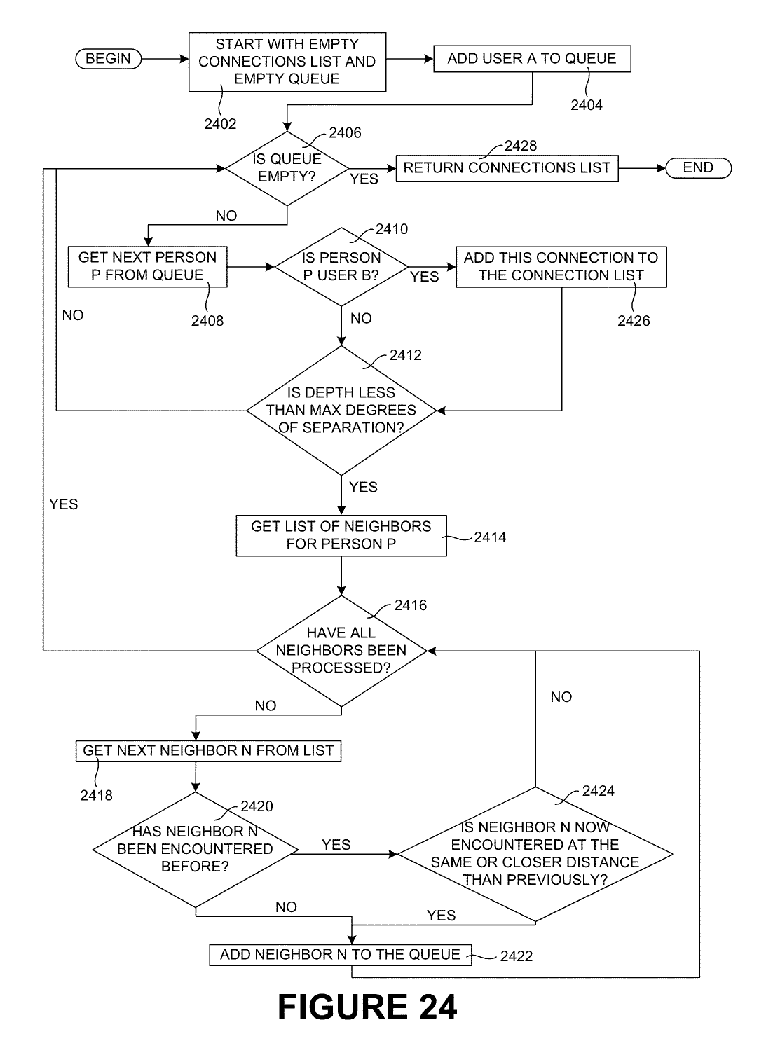

FIG. 24 is a flowchart of adding the neighbor (e.g., the neighbor 2920 of FIG. 29) to the queue, according to one embodiment. In operation 2402, the system may start with the empty connection list and empty queue. In operation 2404, the user may be added to the queue. In operation 2406, it is determined whether the queue is empty. In operation 2408, if it is determined that the queue is not empty then the next person P may be taken from the queue. In operation 2410, it may be determined whether the person P from the queue is user B or not. In operation 2412, if the person P is not user B then it may be determined whether the depth of the geographical location is less than maximum degrees of separation.

If it is determined that depth is more than maximum allowable degrees of separation then it may repeat the operation 2408. In operation 2414, if may be determined that the depth of the geographical location (e.g., the geographical location 4004 of FIG. 40A) is less than maximum degrees of separation then the neighbors (e.g., the neighbor 2920 of FIG. 29) list for person P may be processed. In operation 2416, it may be determined whether all the neighbors (e.g., the neighbor 2920 of FIG. 29) in the neighborhood (e.g., the neighborhood 2902A-N of FIG. 29) have been processed or not. If all the friends are processed it may be determined the queue is empty.

In operation 2418, if all the neighbors (e.g., the neighbor 2920 of FIG. 29) for person P are not processed then next neighbor N may be taken from the list. In operation 2420, it may be determined whether the neighbor (e.g., the neighbor 2920 of FIG. 29) N has encountered before or not. In operation 2422, if the neighbor (e.g., the neighbor 2920 of FIG. 29) has not been encountered before then the neighbor may be added to the queue. In operation 2424, if the neighbor N has been encountered before it may be further determined whether the geographical location (e.g., the geographical location 4004 of FIG. 40A) from where the neighbor (e.g., the neighbor 2920 of FIG. 29) has encountered previously is the same place or closer to that place.

If it is determined that the neighbor (e.g., the neighbor 2920 of FIG. 29) has encountered at the same or closer place then the friend may be added to the queue. If it may be determined that friend is not encountered at the same place or closer to that place then it may be again checked that all the friends have processed. In operation 2426, if it is determined that the person P is user B than the connection may be added to the connection list and after adding the connection to connection list it follows the operation 2412. In operation 2428, if it may be determined that queue is empty then the operation may return the connections list.

For example, a first user ID with the verified registered user (e.g., the verified registered user 4110 of FIG. 41A-B, the verified registered user 4110 of FIG. 41) and a second user ID may be applied to the different registered user. The verified registered user (e.g., the verified registered user 4110 of FIG. 41A-B, the verified registered user 4110 of FIG. 41) with the different registered user may be connected with each other through at least one of a geo-positioning data associated with the first user ID and the second user ID. In addition, a maximum degree of separation (Nmax) of at least two that is allowed for connecting any two registered users, (e.g., the two registered users who may be directly connected may be deemed to be separated by one degree of separation and two registered users who may be connected through no less than one other registered user may be deemed to be separated by two degrees of separation and two registered users who may be connected through not less than N other registered users may be deemed to be separated by N+1 degrees of separation).

Furthermore, the user ID of the different registered user may be searched (e.g., the method limits the searching of the different registered user in the sets of user IDs that may be stored as registered users who are less than Nmax degrees of separation away from the verified registered user (e.g., the verified registered user 4110 of FIG. 41A-B, the verified registered user 4110 of FIG. 41), such that the verified registered user (e.g., the verified registered user 4110 of FIG. 41A-B, the verified registered user 4110 of FIG. 41) and the different registered user who may be separated by more than Nmax degrees of separation are not found and connected.) in a set of user IDs that may be stored of registered users who are less than Nmax degrees of separation away from the verified registered user (e.g., the verified registered user 4110 of FIG. 41A-B, the verified registered user 4110 of FIG. 41), and not in the sets of user IDs that may be stored for registered users who are greater than or equal to Nmax degrees of separation away from the verified registered user (e.g., the verified registered user 4110 of FIG. 41A-B, the verified registered user 4110 of FIG. 41), until the user ID of the different registered user may be found in one of the searched sets. Also, the verified registered user (e.g., the verified registered user 4110 of FIG. 41A-B, the verified registered user 4110 of FIG. 41) may be connected to the different registered user if the user ID of the different registered user may be found in one of the searched sets.

Moreover, the sets of user IDs that may be stored of registered users may be searched initially who are directly connected to the verified registered user (e.g., the verified registered user 4110 of FIG. 41A-B, the verified registered user 4110 of FIG. 41). A profile of the different registered user may be communicated to the verified registered user (e.g., the verified registered user 4110 of FIG. 41A-B, the verified registered user 4110 of FIG. 41) to display through a marker associating the verified registered user (e.g., the verified registered user 4110 of FIG. 41A-B, the verified registered user 4110 of FIG. 41) with the different registered user. A connection path between the verified registered user (e.g., the verified registered user 4110 of FIG. 41A-B, the verified registered user 4110 of FIG. 41) and the different registered user, the connection path indicating at least one other registered user may be stored through whom the connection path between the verified registered user (e.g., the verified registered user 4110 of FIG. 41A-B, the verified registered user 4110 of FIG. 41) and the different registered user is made.

In addition, the connection path between the verified registered user (e.g., the verified registered user 4110 of FIG. 41A-B, the verified registered user 4110 of FIG. 41) and the different registered user may be communicated to the verified registered user to display. A hyperlink in the connection path of each of the at least one registered users may be embedded through whom the connection path between the verified registered user (e.g., the verified registered user 4110 of FIG. 41A-B, the verified registered user 4110 of FIG. 41) and the different registered user is made.

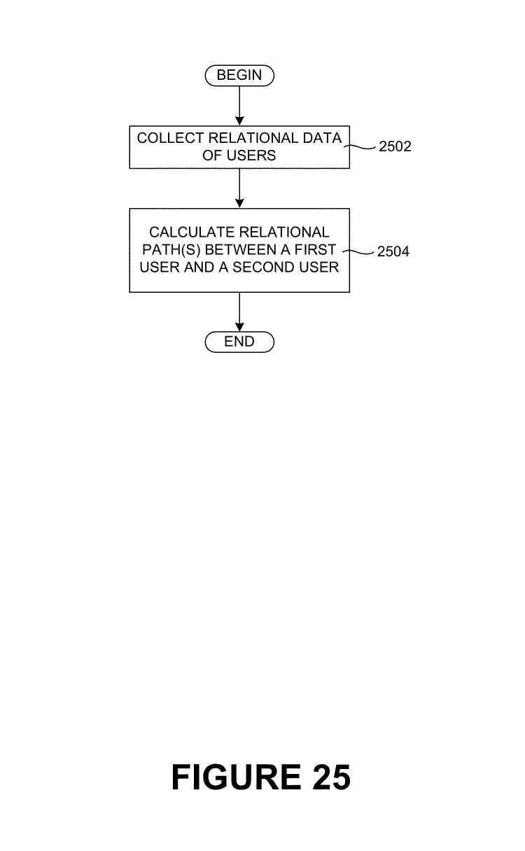

FIG. 25 is a flowchart of communicating brief profiles of the registered users, processing a hyperlink selection from the verified registered user (e.g., the verified registered user 4110 of FIG. 41A-B) and calculating and ensuring the Nmax degree of separation of the registered users away from verified registered users (e.g., the verified registered user 4110 of FIG. 41A-B), according to one embodiment. In operation 2502, the data of the registered users may be collected from the database. In operation 2504, the relational path between the first user and the second user may be calculated (e.g., the Nmax degree of separation between verified registered user (e.g., the verified registered user 4110 of FIG. 41A-B) and the registered user).

For example, the brief profiles of registered users, including a brief profile of the different registered user, to the verified registered user (e.g., the verified registered user 4110 of FIG. 41A-B) for display, each of the brief profiles including a hyperlink to a corresponding full profile may be communicated.

Furthermore, the hyperlink selection from the verified registered user (e.g., the verified registered user 4110 of FIG. 41A-B) may be processed (e.g., upon processing the hyperlink selection of the full profile of the different registered user, the full profile of the different registered user may be communicated to the verified registered user (e.g., the verified registered user 4110 of FIG. 41A-B) for display). In addition, the brief profiles of those registered users may be ensured who are more than Nmax degrees of separation away from the verified registered user (e.g., the verified registered user 4110 of FIG. 41A-B) are not communicated to the verified registered user (e.g., the verified registered user 4110 of FIG. 41A-B) for display.

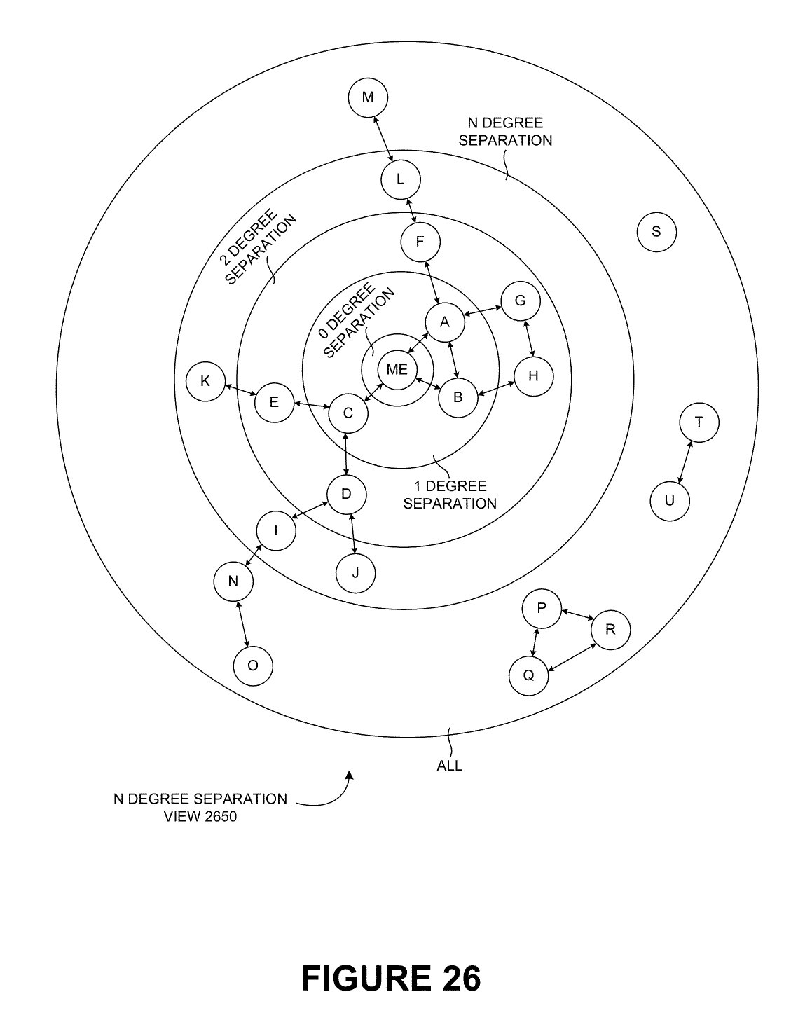

FIG. 26 is an N degree separation view 2650, according to one embodiment. ME may be a verified registered user (e.g., the verified registered user 4110 of FIG. 41A-B) of the global neighborhood environment 1800 (e.g., the privacy server 2900 of FIG. 29) centered in the neighborhood network. A, B, C, D, E, F, G, H, I, J, K, L, M, N, O, P, Q, R, S, T, and/or U may be the other registered user of the neighborhood network. The member of the neighborhood network may be separated from the centered verified registered user (e.g., the verified registered user 4110 of FIG. 41A-B) ME of the neighborhood network by certain degree of separation. The registered user A, B and C may be directly connected and are deemed to be separated by one degree of separation from verified registered user (e.g., the verified registered user 4110 of FIG. 41A-B) ME. The registered user D, E, F, G, and H may be connected through no less than one other registered user may be deemed to be separated by two degree of separation from verified registered user (e.g., the verified registered user 4110 of FIG. 41A-B) ME. The registered user I, J, K, and L may be connected through no less than N−1 other registered user may be deemed to be separated by N degree of separation from verified registered user (e.g., the verified registered user 4110 of FIG. 41A-B) ME. The registered user M, N, O, P, Q, R S, T and U may be all registered user.

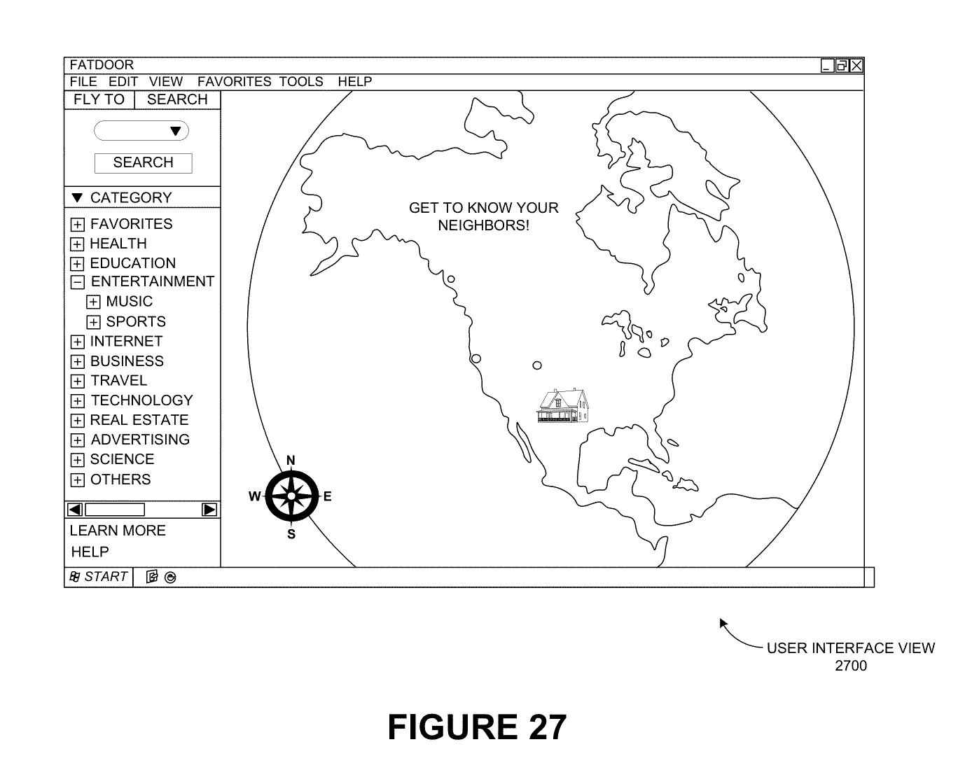

FIG. 27 is a user interface view 2700 showing a map, according to one embodiment. Particularly FIG. 27 illustrates a satellite photo of a physical world. The registered user of the global neighborhood environment 1800 (e.g., the privacy server 2900 of FIG. 29) may use this for exploring the geographical location (e.g., the geographical location 4004 of FIG. 40A) of the neighbors (e.g., the neighbor 2920 of FIG. 29). The registered user (e.g., the verified registered user 4110 of FIG. 41A-B) may navigate, zoom, explore and quickly find particular desired geographical locations of the desired neighbors (e.g., the neighbor 2920 of FIG. 29). This may help the registered user to read the map and/or plot the route of the neighbors (e.g., the neighbor 2920 of FIG. 29) on the world map.

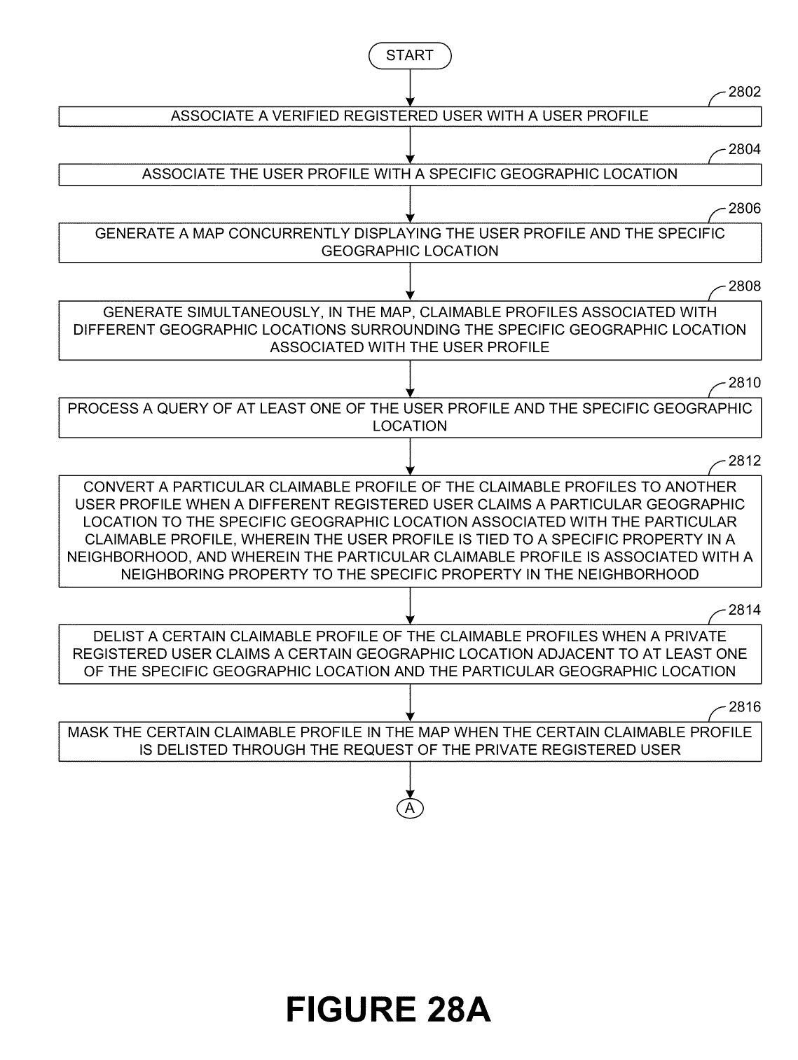

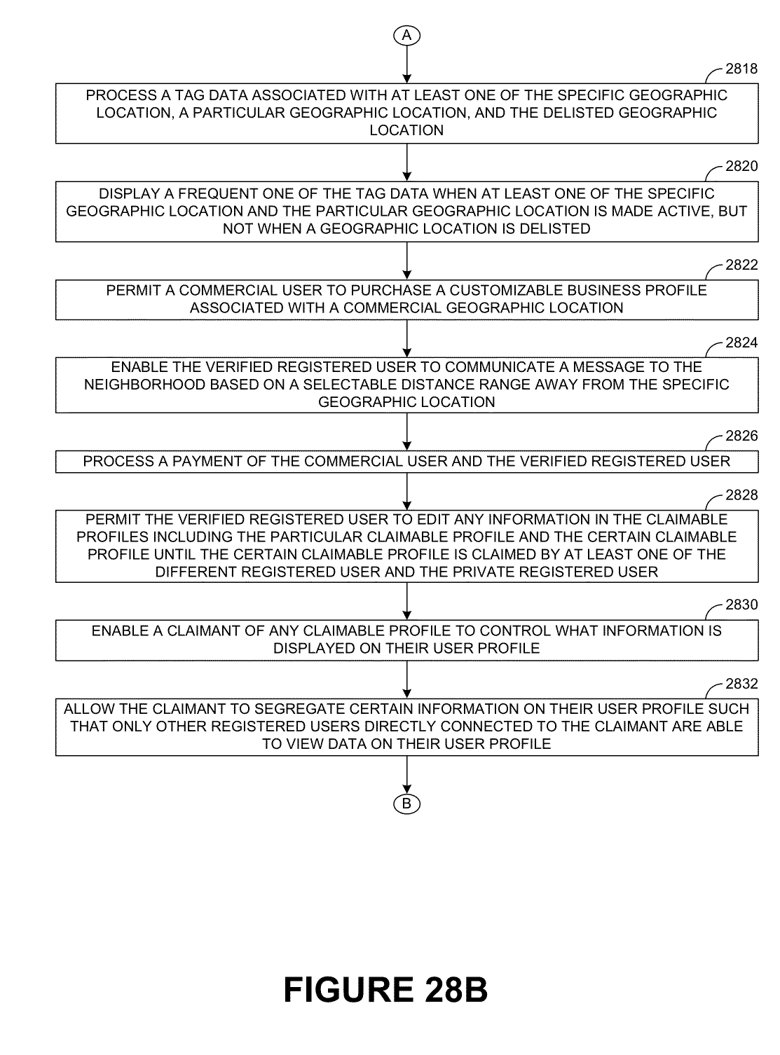

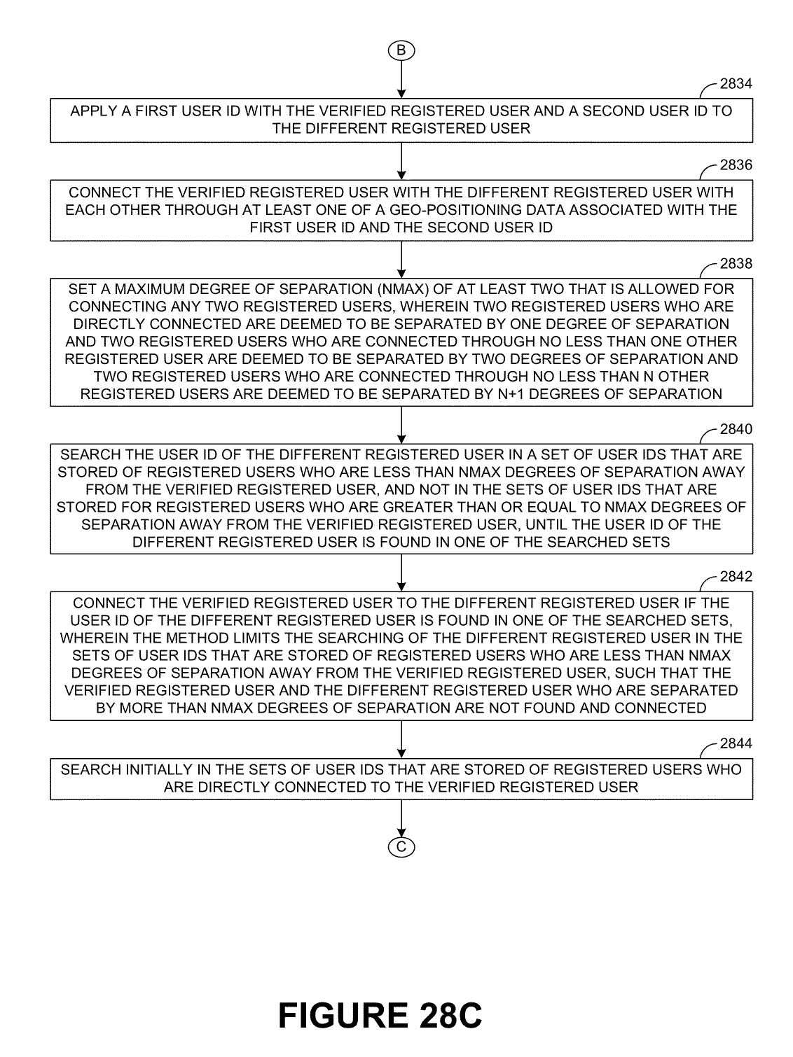

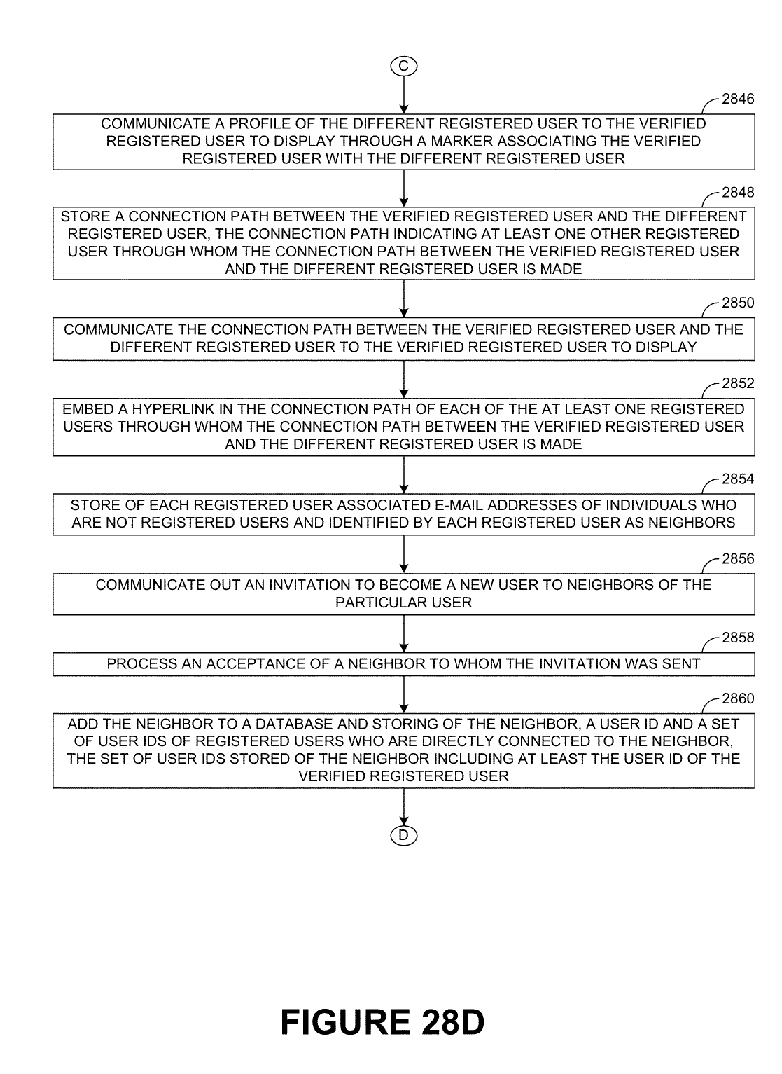

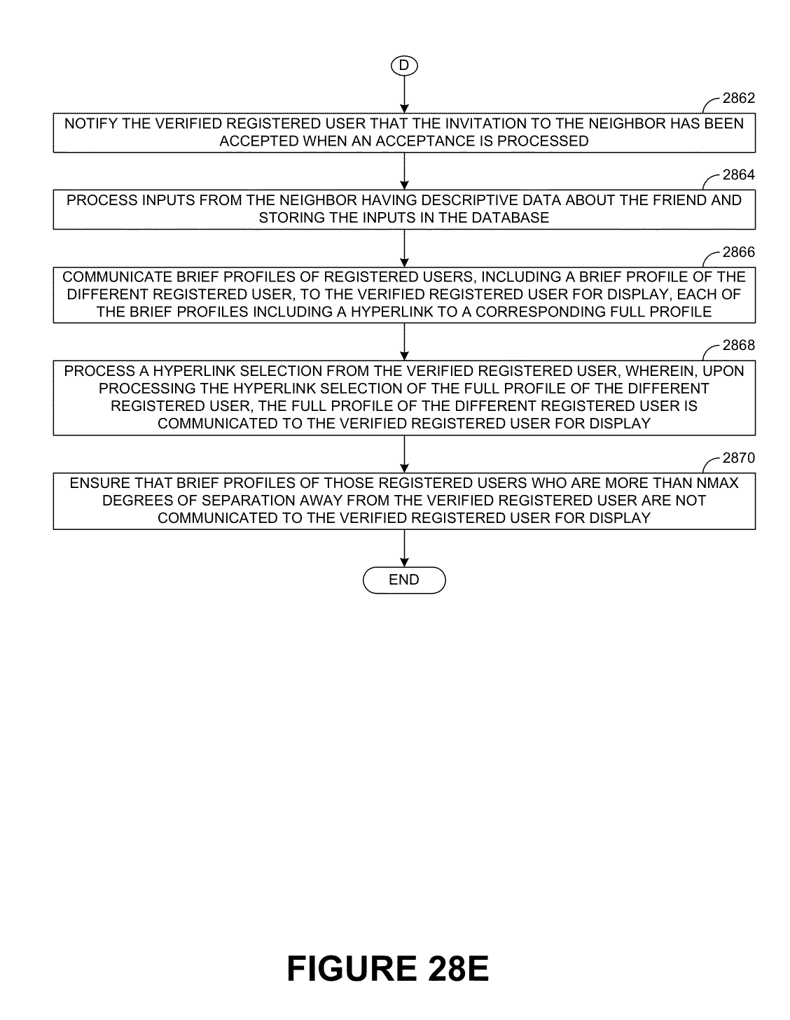

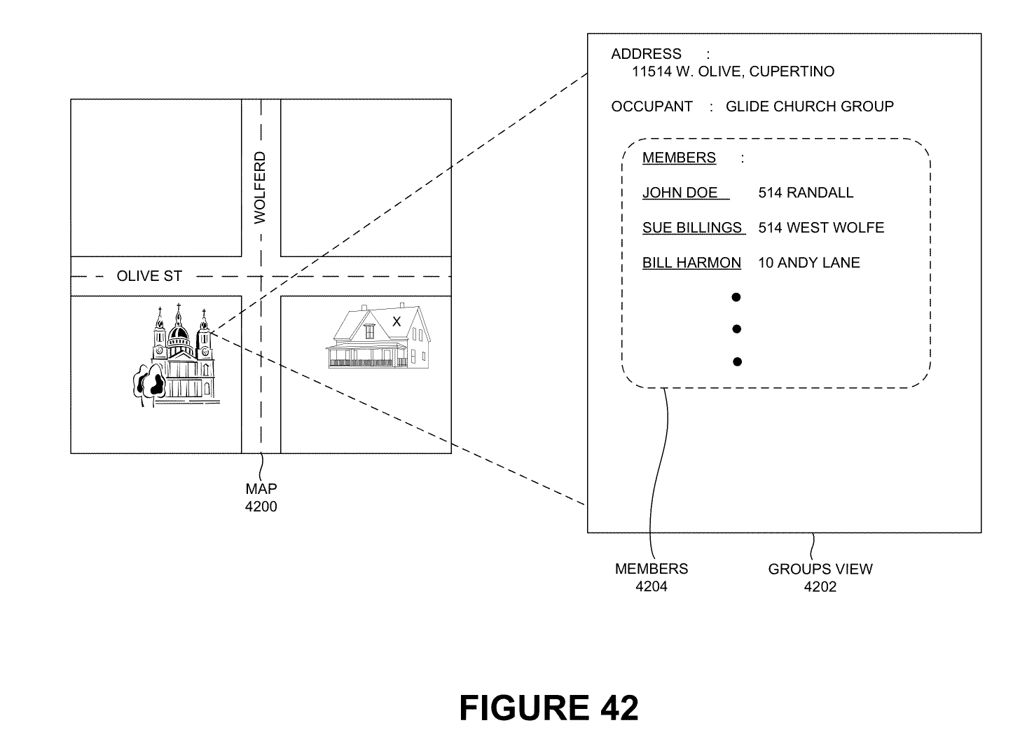

FIG. 28A is a process flow of searching map based community and neighborhood contribution, according to one embodiment. In operation 2802, a verified registered user (e.g., a verified registered user 4110 of FIG. 41A-13B, a verified registered user 4110 of FIG. 42) may be associated with a user profile (e.g., a user profile 29200 of FIG. 40A). In operation 2804, the user profile (e.g., the user profile 29200 of FIG. 40A) may be associated with a specific geographic location (e.g., a geographic location 4004 of FIG. 40A).

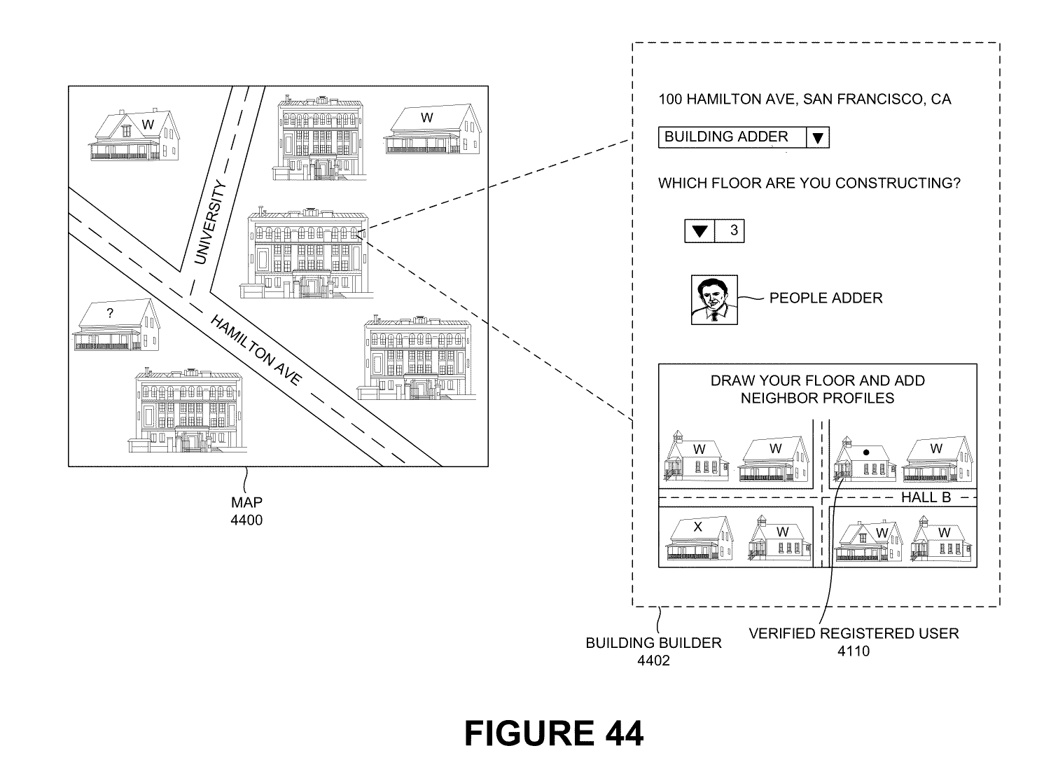

In operation 2806, a map (e.g., a map 4002 of FIG. 40B-41A, a map 4200 of FIG. 42, a map 4400 of FIG. 44, a map 1701 of FIG. 17) may be generated concurrently displaying the user profile (e.g., the user profile 29200 of FIG. 40A) and the specific geographic location (e.g., the geographic location 4004 of FIG. 40A). In operation, 2808, in the map, claimable profiles (e.g., a claimable profile 4006 of FIG. 40A-B, a claimable profile 4102 of FIG. 41A, a claimable profile 1704 of FIG. 17) associated with different geographic locations may be simultaneously generated surrounding the specific geographic location (e.g., the geographic location 4004 of FIG. 40A) associated with the user profile (e.g., the user profile 29200 of FIG. 40A).

In operation 2810, a query of at least one of the user profile (e.g., the user profile 29200 of FIG. 40A) and the specific geographic location (e.g., the geographic location 4004 of FIG. 40A) may be processed. In operation 2812, a particular claimable profile of the claimable profiles (e.g., the claimable profile 4006 of FIG. 40A-B, the claimable profile 4102 of FIG. 41A, the claimable profile 1704 of FIG. 17) may be converted to another user profile (e.g., the user profile 29200 of FIG. 40A) when a different registered user claims a particular geographic location to the specific geographic location (e.g., the geographic location 4004 of FIG. 40A) associated with the particular claimable profile (e.g., the claimable profile 4006 of FIG. 40A-B, the claimable profile 4102 of FIG. 41A, the claimable profile 1704 of FIG. 17), wherein the user profile (e.g., the user profile 29200 of FIG. 40A) may be tied to a specific property in a neighborhood (e.g., a neighborhood 2902A-2902N of FIG. 29), and wherein the particular claimable profile (e.g., the claimable profile 4006 of FIG. 40B-41A, the claimable profile 4102 of FIG. 41A, the claimable profile 1704 of FIG. 17) may be associated with a neighboring property to the specific property in the neighborhood (e.g., the neighborhood 2920A-2920N of FIG. 29).

In operation 2814, a certain claimable profile (e.g., the claimable profile 4006 of FIG. 40B-41A, the claimable profile 4102 of FIG. 41A, the claimable profile 1704 of FIG. 17) of the claimable profiles (e.g., the claimable profile 4006 of FIG. 40A-B, the claimable profile 4102 of FIG. 41A, the claimable profile 1704 of FIG. 17) may be delisted when a private registered user claims a certain geographic location (e.g., the geographic location 4004 of FIG. 40A) adjacent to at least one of the specific geographic location and the particular geographic location (e.g., the geographic location 4004 of FIG. 40A).

In operation 2816, the certain claimable profile (e.g., the claimable profile 4006 of FIG. 40A-B, the claimable profile 4102 of FIG. 41A, the claimable profile 1704 of FIG. 17) in the map (e.g., the map 4002 of FIG. 40A-B, the map 4200 of FIG. 42, the map 4400 of FIG. 44, the map 1701 of FIG. 17) when the certain claimable profile may be delisted and/or be masked through the request of the private registered user.

FIG. 28B is a continuation of process flow of FIG. 28A showing additional processes, according to one embodiment. In operation 2818, a tag data associated with at least one of the specific geographic location, the particular geographic location (e.g., the geographic location 4004 of FIG. 40A), and the delisted geographic location may be processed. In operation 2820, a frequent one of the tag data may be displayed when at least one of the specific geographic location and the particular geographic location (e.g., the geographic location 4004 of FIG. 40A) may be made active, but not when the geographic location (e.g., the geographic location 4004 of FIG. 40A) may be delisted.

In operation 2822, a commercial user (e.g., a commercial user 4100 of FIG. 41A-B) may be permitted to purchase a customizable business profile (e.g., a customizable business profile 4104 of FIG. 41B) associated with a commercial geographic location. In operation 2824, the verified registered user (e.g., the verified registered user 4110 of FIG. 41A-B) to communicate a message to the neighborhood (e.g., the neighborhood 2902A-2902N of FIG. 29) may be enabled based on a selectable distance range away from the specific geographic location.

In operation 2826, a payment of the commercial user (e.g., the commercial user 4100 of FIG. 41A-B) and the verified registered user (e.g., the verified registered user 4110 of FIG. 41A-B) may be processed. In operation 2828, the verified registered user (e.g., the verified registered user 4110 of FIG. 41A-B) may be permitted to edit any information in the claimable profiles (e.g., the claimable profile 4006 of FIG. 40A-B, the claimable profile 4102 of FIG. 41A, the claimable profile 1704 of FIG. 17) including the particular claimable profile and the certain claimable profile until the certain claimable profile may be claimed by at least one of the different registered user and the private registered user.

In operation 2830, a claimant of any claimable profile (e.g., the claimable profile 4006 of FIG. 40A-B, the claimable profile 4102 of FIG. 41A, the claimable profile 1704 of FIG. 17) may be enabled to control what information is displayed on their user profile (e.g., the user profile 29200 of FIG. 40A). In operation 2832, the claimant to segregate certain information on their user profile (e.g., the user profile 29200 of FIG. 40A) may be allowed such that only other registered users directly connected to the claimant are able to view data on their user profile (e.g., the user profile 29200 of FIG. 40A).

FIG. 28C is a continuation of process flow of FIG. 28B showing additional processes, according to one embodiment. In operation 2834, a first user ID with the verified registered user (e.g., the verified registered user 4110 of FIG. 41A-B) and a second user ID to the different registered user may be applied. In operation 2836, the verified registered user (e.g., the verified registered user 4110 of FIG. 41A-B) with the different registered user with each other may be connected through ‘A Geo-Position Data’ at least one of associated with the first user ID and the second user ID.

In operation 2838, a maximum degree of separation (Nmax) of at least two may be set that is allowed for connecting any two registered users, wherein two registered users who are directly connected may be deemed to be separated by one degree of separation and two registered users who are connected through no less than one other registered user may be deemed to be separated by two degrees of separation and two registered users who may be connected through no less than N other registered users are deemed to be separated by N+1 degrees of separation. In operation 2840, the user ID of the different registered user may be searched in a set of user IDs that are stored of registered users who are less than Nmax degrees of separation away from the verified registered user (e.g., the verified registered user 4110 of FIG. 41A-B), and not in the sets of user IDs that are stored for registered users who may be greater than or equal to Nmax degrees of separation away from the verified registered user (e.g., the verified registered user 4110 of FIG. 41A-B), until the user ID of the different registered user may be found in one of the searched sets.

In operation 2842, the verified registered user (e.g., the verified registered user 4110 of FIG. 41A-B) may be connected to the different registered user if the user ID of the different registered user may be found in one of the searched sets, wherein the method limits the searching of the different registered user in the sets of user IDs that may be stored of registered users who may be less than Nmax degrees of separation away from the verified registered user (e.g., the verified registered user 4110 of FIG. 41A-B), such that the verified registered user (e.g., the verified registered user 4110 of FIG. 41A-B) and the different registered user who may be separated by more than Nmax degrees of separation are not found and connected. In operation 2846,

initially in the sets of user IDs that are stored of registered users who may be directly connected to the verified registered user (e.g., the verified registered user 4110 of FIG. 41A-B) may be initially searched.

FIG. 28D is a continuation of process flow of FIG. 28C showing additional processes, according to one embodiment. In operation 2846, a profile of the different registered user to the verified registered user (e.g., the verified registered user 4110 of FIG. 41A-B) to display may be communicated through a marker associating the verified registered user (e.g., the verified registered user 4110 of FIG. 41A-B) with the different registered user.

In operation 2848, a connection path between the verified registered user (e.g., the verified registered user 4110 of FIG. 41A-B) and the different registered user, the connection path indicating at least one other registered user may be stored through whom the connection path between the verified registered user (e.g., the verified registered user 4110 of FIG. 41A-B) and the different registered user may be made.

In operation 2850, the connection path between the verified registered user (e.g., the verified registered user 4110 of FIG. 41A-B) and the different registered user to the verified registered user (e.g., the verified registered user 4110 of FIG. 41A-B) may be communicated to display.

In operation 2852, a hyperlink in the connection path of each of the at least one registered users may be embedded through whom the connection path between the verified registered user (e.g., the verified registered user 4110 of FIG. 41A-B) and the different registered user may be made. In operation 2854, each registered user associated e-mail addresses of individuals who are not registered users may be stored and identified by each registered user as neighbors (e.g., a neighbor 2920 of FIG. 29).

In operation 2856, an invitation may be communicated to become a new user (e.g., a user 2916 of FIG. 29) to neighbors (e.g., the neighbor 2920 of FIG. 29) of the particular user. In operation 2, an acceptance of the neighbor (e.g., the neighbor 2920 of FIG. 29) to whom the invitation was sent may be processed. In operation 2860, the neighbor (e.g., the neighbor 2920 of FIG. 29) to a database and storing of the neighbor (e.g., the neighbor 2920 21 FIG. 29), a user ID and the set of user IDs of registered users may be added who are directly connected to the neighbor (e.g., the neighbor 2920 of FIG. 29), the set of user IDs stored of the neighbor (e.g., the neighbor 2920 of FIG. 29) including at least the user ID of the verified registered user (e.g., the verified registered user 4110 of FIG. 41A-B).

FIG. 28E is a continuation of process flow of FIG. 28D showing additional processes, according to one embodiment. In operation 2862, the verified registered user (e.g., the verified registered user 4110 of FIG. 41A-B) that the invitation to the neighbor (e.g., the neighbor 2920 of FIG. 29) has been accepted may be notified when the acceptance is processed.

In operation 2864, inputs from the neighbor (e.g., the neighbor 2920 of FIG. 29) having descriptive data about the friend and storing the inputs in the database may be processed. In operation 2866, brief profiles of registered users, including a brief profile of the different registered user may be communicated, to the verified registered user (e.g., the verified registered user 4110 of FIG. 41A-B) for display, each of the brief profiles including the hyperlink to a corresponding full profile.

In operation 2868, the hyperlink selection from the verified registered user (e.g., the verified registered user 4110 of FIG. 41A-B) may be processed, wherein, upon processing the hyperlink selection of the full profile of the different registered user, the full profile of the different registered user is communicated to the verified registered user (e.g., the verified registered user 4110 of FIG. 41A-B) for display.

In operation 2870, brief profiles of those registered users who may be more than Nmax degrees of separation away from the verified registered user (e.g., the verified registered user 4110 of FIG. 41A-B) may not communicated to the verified registered user (e.g., the verified registered user 4110 of FIG. 41A-B) may be ensured for display.

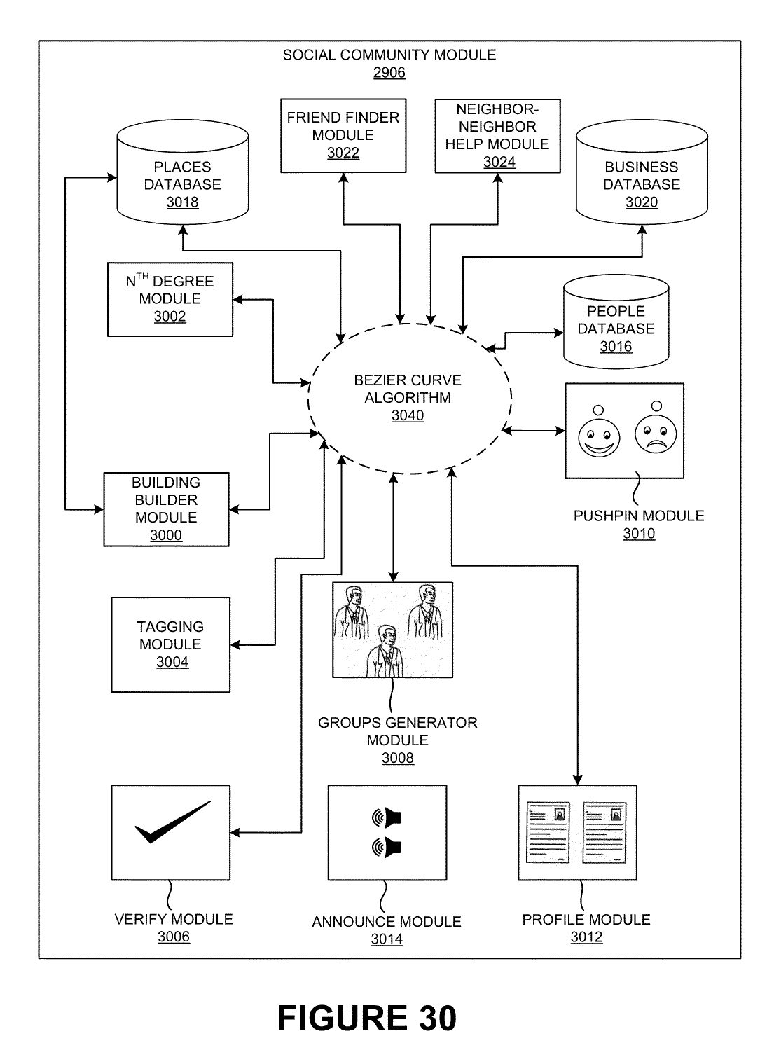

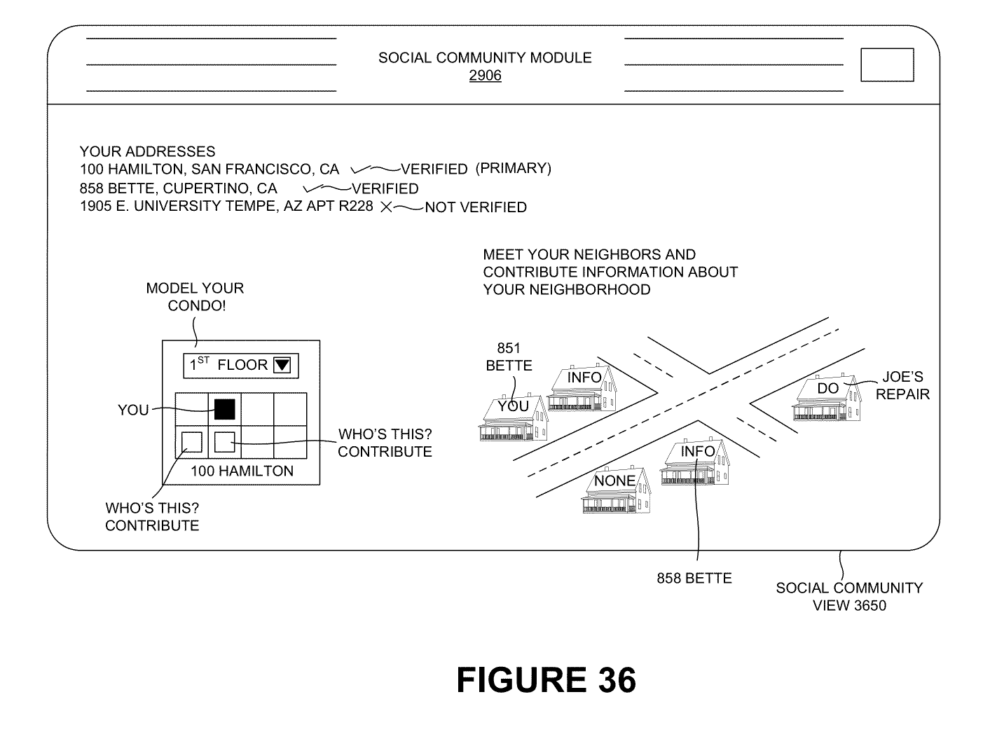

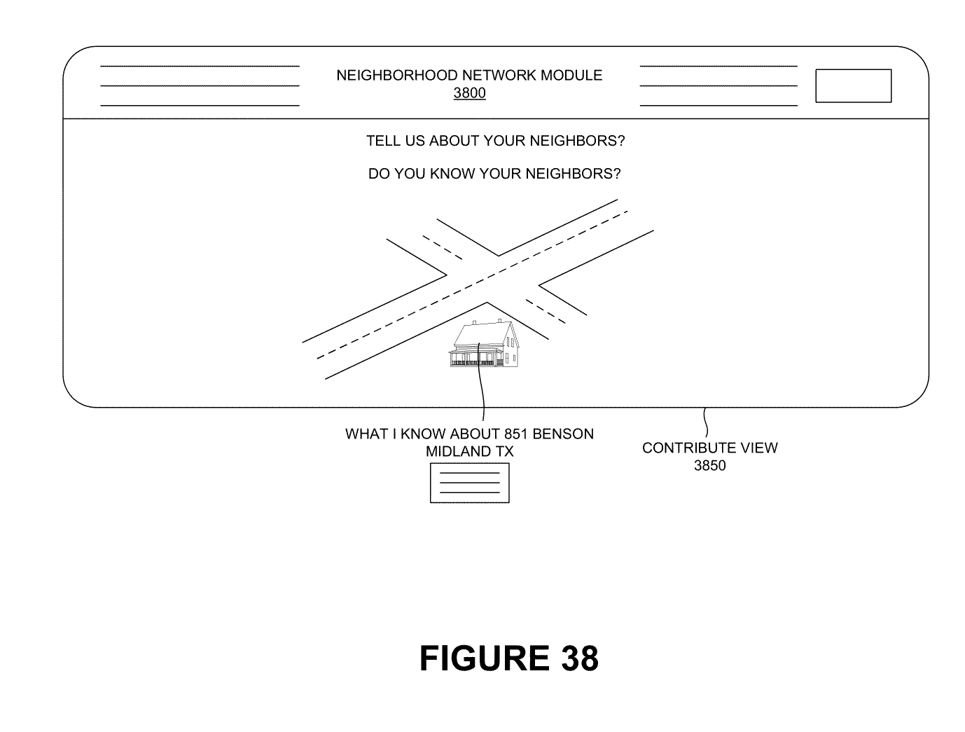

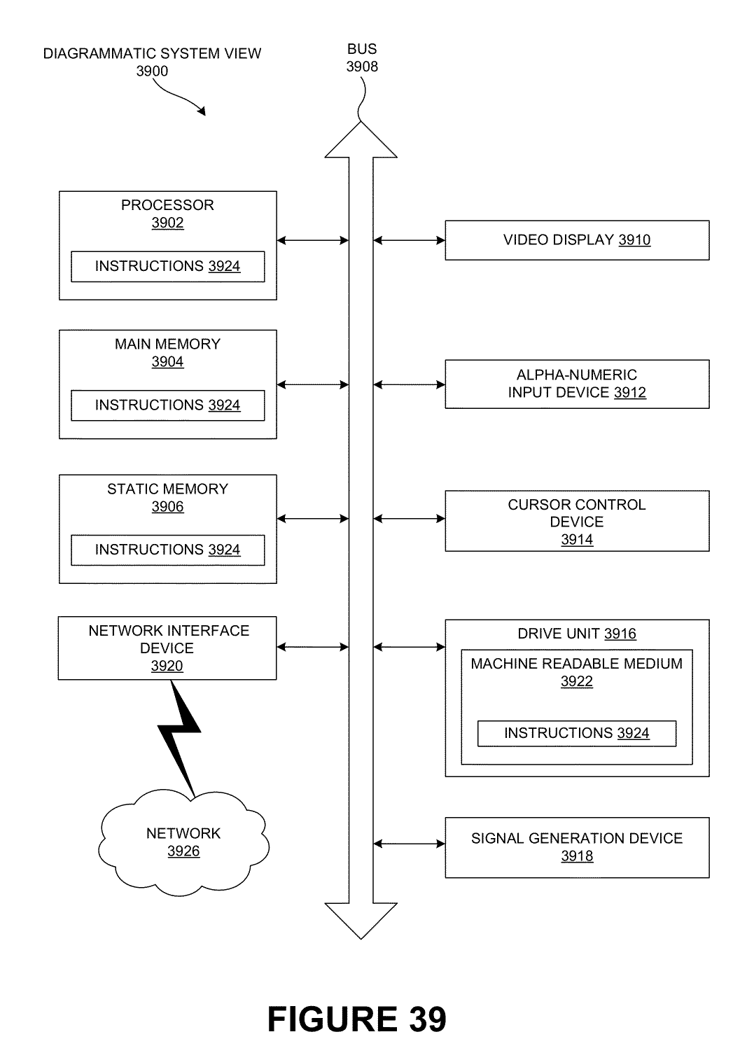

In one embodiment, a neighborhood communication system 2950 is described. This embodiment includes a privacy server 2900 to apply an address verification algorithm 2903 (e.g., using verify module 3006 of FIG. 30) associated with each user of the online community (e.g., as shown in the social community view 3650 of FIG. 36 formed through the neighborhood network module as described in FIG. 38) to verify that each user lives at a residence associated with a claimable residential address (e.g., using sub-modules of the claimable module 2910 as described in FIG. 31) of an online community (e.g., as shown in the social community view 3650 of FIG. 36 formed through the neighborhood network module as described in FIG. 38) formed through a social community module 2906 of the privacy server 2900 using a processor 3902 and a memory (e.g., as described in FIG. 39).

A network 2904, and a mapping server 2926 (e.g., providing global map data) communicatively coupled with the privacy server 2900 through the network 2904 generate a latitudinal data and a longitudinal data associated with each claimable residential address (e.g., using sub-modules of the claimable module 2910 as described in FIG. 31) of the online community (e.g., as shown in the social community view 3650 of FIG. 36 formed through the neighborhood network module as described in FIG. 38) associated with each user of the online community (e.g., as shown in the social community view 3650 of FIG. 36 formed through the neighborhood network module as described in FIG. 38) in this embodiment.

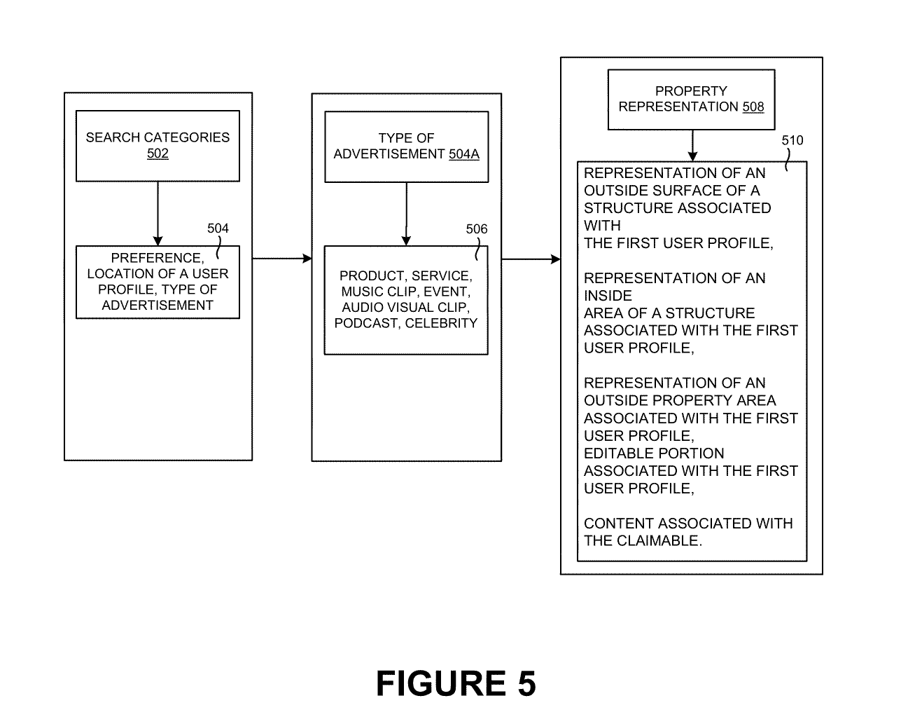

It will be appreciated that the neighborhood communication system 2950 may operate the various multi-copters 100 of FIG. 1 in a peer-to-peer topology. Particularly, the peer-to-peer (P2P) networks formed in the various embodiments described in FIGS. 1-44 may include a type of decentralized and distributed network architecture in which individual multi-copters (e.g., the multi-copters of FIG. 1) and client side devices (e.g., mobile devices of neighbors, desktop computers of neighbors) in the network (e.g., “peers”) act as both suppliers and consumers of resources, in contrast to the centralized client-server model where client nodes request access to resources provided by central servers, according to one embodiment. Through a peer-to-peer methodology of neighborhood multi-copters, each connected through a common centralized communication system (e.g., a cloud based communication system), collisions between multi-copters can be minimized by relaying positional information between a series of multi-copters and client devices presently in flight, according to one embodiment (e.g., redundant paths and communications can be simultaneously handled). In this embodiment, controlling the multi-copter 100 functions may be are shared amongst multiple interconnected peers who each make a portion of their resources (such as processing power, disk storage or network bandwidth) directly available to other network participants, without the need for centralized coordination by servers, according to one embodiment.

The privacy server 2900 automatically determines a set of access privileges in the online community (e.g., as shown in the social community view 3650 of FIG. 31 formed through the neighborhood network module as described in FIG. 38) associated with each user of the online community (e.g., as shown in the social community view 3650 of FIG. 36 formed through the neighborhood network module as described in FIG. 38) by constraining access in the online community (e.g., as shown in the social community view 3650 of FIG. 36 formed through the neighborhood network module as described in FIG. 38) based on a neighborhood boundary determined using a Bezier curve algorithm 3040 of the privacy server 2900 in this embodiment.

The privacy server 2900 (e.g., a hardware device of a global neighborhood environment 1800) may transform the claimable residential address (e.g., using sub-modules of the claimable module 2910 as described in FIG. 31) into a claimed address upon an occurrence of an event. The privacy server 2900 may instantiate the event when a particular user 2916 is associated with the claimable residential address (e.g., using sub-modules of the claimable module 2910 as described in FIG. 31) based on a verification of the particular user 2916 as living at a particular residential address (e.g., associated with the residence 2918 of FIG. 29) associated with the claimable residential address (e.g., using sub-modules of the claimable module 2910 as described in FIG. 31) using the privacy server 2900. The privacy server 2900 may constrain the particular user 2916 to communicate through the online community (e.g., as shown in the social community view 3650 of FIG. 36 formed through the neighborhood network module as described in FIG. 38) only with a database of neighbors 2928 (e.g., such as the neighbor 2920 of FIG. 29 forming an occupant data) having verified addresses using the privacy server 2900. The privacy server 2900 may define the database of neighbors 2928 (e.g., such as the neighbor 2920 of FIG. 29) as other users of the online community (e.g., as shown in the social community view 3650 of FIG. 36 formed through the neighborhood network module as described in FIG. 38) that have each verified their addresses in the online community (e.g., as shown in the social community view 3650 of FIG. 36 formed through the neighborhood network module as described in FIG. 38) using the privacy server 2900 and/or which have each claimed residential addresses that are in a threshold radial distance from the claimed address of the particular user 2916.

The privacy server 2900 may constrain the threshold radial distance to be less than a distance of the neighborhood boundary using the Bezier curve algorithm 3040. The privacy server 2900 may permit the neighborhood boundary to take on a variety of shapes based on an associated geographic connotation, a historical connotation, a political connotation, and/or a cultural connotation of neighborhood boundaries. The privacy server 2900 may apply a database of constraints (e.g., the databases of FIG. 30 including the places database 3018) associated with neighborhood boundaries that are imposed on a map view of the online community (e.g., as shown in the social community view 3650 of FIG. 36 formed through the neighborhood network module as described in FIG. 38) when permitting the neighborhood boundary to take on the variety of shapes.

The privacy server 2900 may generate a user-generated boundary in a form of a polygon describing geospatial boundaries defining the particular neighborhood when a first user of a particular neighborhood that verifies a first residential address of the particular neighborhood using the privacy server 2900 prior to other users in that particular neighborhood verifying their addresses in that particular neighborhood places a set of points defining the particular neighborhood using a set of drawing tools in the map view of the online community (e.g., as shown in the social community view 3650 of FIG. 36 formed through the neighborhood network module as described in FIG. 38). The privacy server 2900 may optionally extend the threshold radial distance to an adjacent boundary of an adjacent neighborhood based a request of the particular user 2916. The privacy server 2900 may generate a separate login to the online community (e.g., as shown in the social community view 3650 of FIG. 36 formed through the neighborhood network module as described in FIG. 38) designed to be usable by a police department, a municipal agency, a neighborhood association, and/or a neighborhood leader associated with the particular neighborhood.

The separate login may permit the police department, the municipal agency, the neighborhood association, and/or the neighborhood leader to: (1) invite residents of the particular neighborhood themselves (e.g., see the user interface view of FIG. 22) using the privacy server 2900 using a self-authenticating access code that permits new users that enter the self-authenticating access code in the online community (e.g., as shown in the social community view 3650 of FIG. 36 formed through the neighborhood network module as described in FIG. 38) to automatically join the particular neighborhood as verified users (e.g., the verified user 4110 of FIG. 41A), (2) generate a virtual neighborhood watch group and/or an emergency preparedness group restricted to users verified in the particular neighborhood using the privacy server 2900, (3) conduct high value crime and/or safety related discussions from local police and/or fire officials that is restricted to users verified in the particular neighborhood using the privacy server 2900, (4) broadcast information across the particular neighborhood, and (5) receive and/or track neighborhood level membership and/or activity to identify leaders from the restricted group of users verified in the particular neighborhood using the privacy server 2900.

The privacy server 2900 may permit each of the restricted group of users verified in the particular neighborhood using the privacy server 2900 to: (1) share information about a suspicious activity that is likely to affect several neighborhoods, (2) explain about a lost pet that might have wandered into an adjoining neighborhood, (3) rally support from neighbors 2920 (e.g., such as the neighbor 2920 of FIG. 29) from multiple neighborhoods to address civic issues, (4) spread information about events comprising a local theater production and/or a neighborhood garage sale, and/or (5) solicit advice and/or recommendations from the restricted group of users verified in the particular neighborhood and/or optionally in the adjacent neighborhood.

The privacy server 2900 may flag a neighborhood feed from the particular neighborhood and/or optionally from the adjacent neighborhood as being inappropriate. The privacy server 2900 may suspend users that repeatedly communicate self-promotional messages that are inappropriate as voted based on a sensibility of any one of the verified users (e.g., the verified user 4110 of FIG. 41A) of the particular neighborhood and/or optionally from the adjacent neighborhood. The privacy server 2900 may personalize which nearby neighborhoods that verified users (e.g., the verified user 4110 of FIG. 41A) are able to communicate through based on a request of the particular user 2916. The privacy server 2900 may permit the neighborhood leader to communicate privately with leaders of an adjoining neighborhood to plan and/or organize on behalf of an entire constituency of verified users (e.g., a plurality of the verified user 4110 of FIG. 41A) of the particular neighborhood associated with the neighborhood leader.

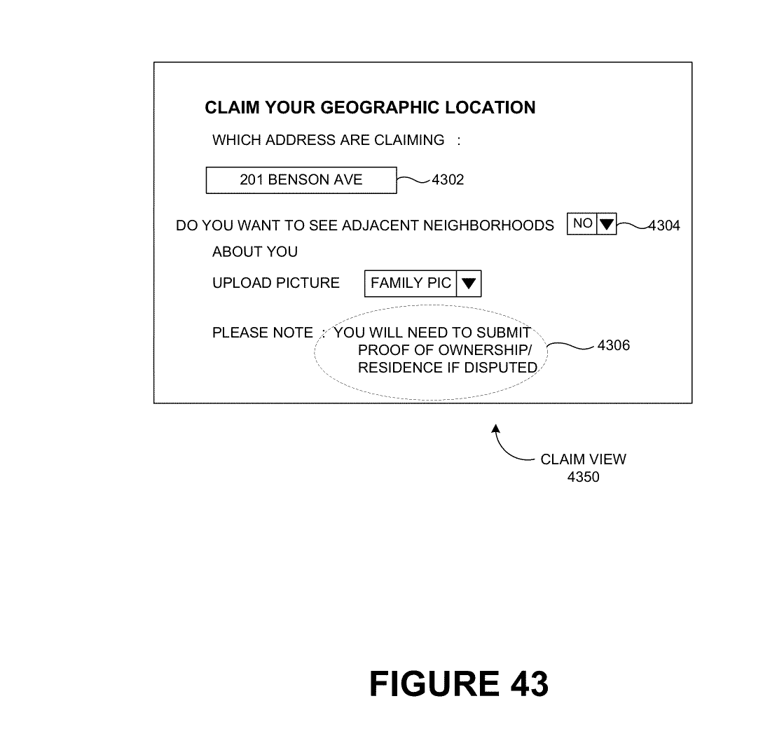

The privacy server 2900 may filter feeds to only display messages from the particular neighborhood associated with each verified user. The privacy server 2900 may restrict posts only in the particular neighborhood to verified users (e.g., the verified user 4110 of FIG. 41A) having verified addresses within the neighborhood boundary (e.g., the claim view 4350 of FIG. 43 describes a claiming process of an address). The address verification algorithm 2903 (e.g., using verify module 3006 of FIG. 30) of the privacy server 2900 utilizes a set of verification methods to perform verification of the particular user 2916 through any of a: (1) a postcard verification method through which the privacy server 2900 generates a physical postcard that is postal mailed to addresses of requesting users in the particular neighborhood and/or having a unique alphanumeric sequence in a form of an access code printed thereon which authenticates users that enter the access code to view and/or search privileges in the particular neighborhood of the online community (e.g., as shown in the social community view 3650 of FIG. 36 formed through the neighborhood network module as described in FIG. 38), (2) a credit card verification method through which the privacy server 2900 verifies the claimable residential address (e.g., using sub-modules of the claimable module 2910 as described in FIG. 31) when at least one a credit card billing address and/or a debit card billing address is matched with an inputted address through an authentication services provider, (3) a privately-published access code method through which the privacy server 2900 communicates to user profiles of the police department, the municipal agency, the neighborhood association, and/or the neighborhood leader an instant access code that is printable at town hall meetings and/or gatherings sponsored by any one of the police department, the municipal agency, the neighborhood association, and/or the neighborhood leader, (4) a neighbor vouching method through which the privacy server 2900 authenticates new users when existing verified users (e.g., the verified user 4110 of FIG. 41A) agree to a candidacy of new users in the particular neighborhood, (5) a phone verification method through which the privacy server 2900 authenticates new users whose phone number is matched with an inputted phone number through the authentication services provider, and (6) a social security verification method through which the privacy server 2900 authenticates new users whose social security number is matched with an inputted social security number through the authentication services provider.

The privacy server 2900 may initially set the particular neighborhood to a pilot phase status in which the online community (e.g., as shown in the social community view 3650 of FIG. 36 formed through the neighborhood network module as described in FIG. 38) of the particular neighborhood is provisionally defined until a minimum number of users verify their residential addresses in the particular neighborhood through the privacy server 2900. The privacy server 2900 may automatically delete profiles of users that remain unverified after a threshold window of time. The neighborhood communication system 2950 may be designed to create private websites to facilitate communication among neighbors 2920 (e.g., such as the neighbor 2920 of FIG. 29) and/or build stronger neighborhoods.

In another embodiment a method of a neighborhood communication system 2950 is described. The method includes applying an address verification algorithm 2903 (e.g., using verify module 3006 of FIG. 30) associated with each user of the online community (e.g., as shown in the social community view 3650 of FIG. 36 formed through the neighborhood network module as described in FIG. 38) using a privacy server 2900, verifying that each user lives at a residence associated with a claimable residential address (e.g., using sub-modules of the claimable module 2910 as described in FIG. 31) of an online community (e.g., as shown in the social community view 3650 of FIG. 36 formed through the neighborhood network module as described in FIG. 38) formed through a social community module 2906 of the privacy server 2900 using a processor 3902 and a memory (e.g., as described in FIG. 39), generating a latitudinal data and a longitudinal data associated with each claimable residential address (e.g., using sub-modules of the claimable module 2910 as described in FIG. 31) of the online community (e.g., as shown in the social community view 3650 of FIG. 36 formed through the neighborhood network module as described in FIG. 38) associated with each user of the online community (e.g., as shown in the social community view 3650 of FIG. 36 formed through the neighborhood network module as described in FIG. 38), and determining a set of access privileges in the online community (e.g., as shown in the social community view 3650 of FIG. 36 formed through the neighborhood network module as described in FIG. 38) associated with each user of the online community (e.g., as shown in the social community view 3650 of FIG. 36 formed through the neighborhood network module as described in FIG. 38) by constraining access in the online community (e.g., as shown in the social community view 3650 of FIG. 36 formed through the neighborhood network module as described in FIG. 38) based on a neighborhood boundary determined using a Bezier curve algorithm 3040 of the privacy server 2900.

The method may transform the claimable residential address (e.g., using sub-modules of the claimable module 2910 as described in FIG. 31) into a claimed address upon an occurrence of an event. The method may instantiate the event when a particular user 2916 is associated with the claimable residential address (e.g., using sub-modules of the claimable module 2910 as described in FIG. 31) based on a verification of the particular user 2916 as living at a particular residential address (e.g., associated with the residence 2918 of FIG. 29) associated with the claimable residential address (e.g., using sub-modules of the claimable module 2910 as described in FIG. 31) using the privacy server 2900.

The method may constrain the particular user 2916 to communicate through the online community (e.g., as shown in the social community view 3650 of FIG. 36 formed through the neighborhood network module as described in FIG. 38) only with a database of neighbors 2928 (e.g., such as the neighbor 2920 of FIG. 29) having verified addresses using the privacy server 2900. The method may define the database of neighbors 2928 (e.g., such as the neighbor 2920 of FIG. 29) as other users of the online community (e.g., as shown in the social community view 3650 of FIG. 36 formed through the neighborhood network module as described in FIG. 38) that have each verified their addresses in the online community (e.g., as shown in the social community view 3650 of FIG. 36 formed through the neighborhood network module as described in FIG. 38) using the privacy server 2900 and/or which have each claimed residential addresses that are in a threshold radial distance from the claimed address of the particular user 2916.

The method may constrain the threshold radial distance to be less than a distance of the neighborhood boundary using the Bezier curve algorithm 3040.

In addition, the method may define a neighborhood boundary to take on a variety of shapes based on an associated geographic connotation, a historical connotation, a political connotation, and/or a cultural connotation of neighborhood boundaries. The method may apply a database of constraints (e.g., the databases of FIG. 30 including the places database 3018) associated with neighborhood boundaries that are imposed on a map view of the online community (e.g., as shown in the social community view 3650 of FIG. 36 formed through the neighborhood network module as described in FIG. 38) when permitting the neighborhood boundary to take on the variety of shapes.

The method may generate a user-generated boundary in a form of a polygon describing geospatial boundaries defining the particular neighborhood when a first user of a particular neighborhood that verifies a first residential address of the particular neighborhood using the privacy server 2900 prior to other users in that particular neighborhood verifying their addresses in that particular neighborhood places a set of points defining the particular neighborhood using a set of drawing tools in the map view of the online community (e.g., as shown in the social community view 3650 of FIG. 36 formed through the neighborhood network module as described in FIG. 38). The method may optionally extend the threshold radial distance to an adjacent boundary of an adjacent neighborhood based a request of the particular user 2916.

The method may generate a separate login to the online community (e.g., as shown in the social community view 3650 of FIG. 36 formed through the neighborhood network module as described in FIG. 38) designed to be usable by a police department, a municipal agency, a neighborhood association, and/or a neighborhood leader associated with the particular neighborhood.

The method may permit the police department, the municipal agency, the neighborhood association, and/or the neighborhood leader to: (1) invite residents of the particular neighborhood themselves (e.g., see the user interface view of FIG. 22) using the privacy server 2900 using a self-authenticating access code that permits new users that enter the self-authenticating access code in the online community (e.g., as shown in the social community view 3650 of FIG. 36 formed through the neighborhood network module as described in FIG. 38) to automatically join the particular neighborhood as verified users (e.g., the verified user 4110 of FIG. 41A), (2) generate a virtual neighborhood watch group and/or an emergency preparedness group restricted to users verified in the particular neighborhood using the privacy server 2900, (3) conduct high value crime and/or safety related discussions from local police and/or fire officials that is restricted to users verified in the particular neighborhood using the privacy server 2900, (4) broadcast information across the particular neighborhood, and/or (5) receive and/or track neighborhood level membership and/or activity to identify leaders from the restricted group of users verified in the particular neighborhood using the privacy server 2900.

The method may permit each of the restricted group of users verified in the particular neighborhood using the privacy server 2900 to: (1) share information about a suspicious activity that is likely to affect several neighborhoods, (2) explain about a lost pet that might have wandered into an adjoining neighborhood, (3) rally support from neighbors 2920 (e.g., such as the neighbor 2920 of FIG. 29) from multiple neighborhoods to address civic issues, (4) spread information about events comprising a local theater production and/or a neighborhood garage sale, and/or (5) solicit advice and/or recommendations from the restricted group of users verified in the particular neighborhood and/or optionally in the adjacent neighborhood.

The method may flag a neighborhood feed from the particular neighborhood and/or optionally from the adjacent neighborhood as being inappropriate. The method may suspend users that repeatedly communicate self-promotional messages that are inappropriate as voted based on a sensibility of any one of the verified users (e.g., the verified user 4110 of FIG. 41A) of the particular neighborhood and/or optionally from the adjacent neighborhood. The method may personalize which nearby neighborhoods that verified users (e.g., the verified user 4110 of FIG. 41A) are able to communicate through based on a request of the particular user 2916. The method may permit the neighborhood leader to communicate privately with leaders of an adjoining neighborhood to plan and/or organize on behalf of an entire constituency of verified users of the particular neighborhood associated with the neighborhood leader.

The method may filter feeds to only display messages from the particular neighborhood associated with each verified user. The method may restrict posts only in the particular neighborhood to verified users (e.g., the verified user 4110 of FIG. 41A) having verified addresses within the neighborhood boundary (e.g., the claim view 4350 of FIG. 43 describes a claiming process of an address). The method may utilize a set of verification methods to perform verification of the particular user 2916 through: (1) generating a physical postcard that is postal mailed to addresses of requesting users in the particular neighborhood and/or having a unique alphanumeric sequence in a form of an access code printed thereon which authenticates users that enter the access code to view and/or search privileges in the particular neighborhood of the online community (e.g., as shown in the social community view 3650 of FIG. 36 formed through the neighborhood network module as described in FIG. 38). (2) verifying the claimable residential address (e.g., using sub-modules of the claimable module 2910 as described in FIG. 31) when at least one a credit card billing address and/or a debit card billing address is matched with an inputted address through an authentication services provider. (3) communicating to user profiles of the police department, the municipal agency, the neighborhood association, and/or the neighborhood leader an instant access code that is printable at town hall meetings and/or gatherings sponsored by any one of the police department, the municipal agency, the neighborhood association, and/or the neighborhood leader. (4) authenticating new users when existing verified users (e.g., the verified user 4110 of FIG. 41A) agree to a candidacy of new users in the particular neighborhood. (5) authenticating new users whose phone number is matched with an inputted phone number through the authentication services provider. (6) authenticating new users whose social security number is matched with an inputted social security number through the authentication services provider.

The method may initially set the particular neighborhood to a pilot phase status in which the online community (e.g., as shown in the social community view 3650 of FIG. 36 formed through the neighborhood network module as described in FIG. 38) of the particular neighborhood is provisionally defined until a minimum number of users verify their residential addresses in the particular neighborhood through the privacy server 2900. The method may automatically delete profiles of users that remain unverified after a threshold window of time. The neighborhood communication system 2950 may be designed to create private websites to facilitate communication among neighbors 2920 (e.g., such as the neighbor 2920 of FIG. 29) and/or build stronger neighborhoods.

In yet another embodiment, another neighborhood communication system 2950 is described. This embodiment includes a privacy server 2900 to apply an address verification algorithm 2903 (e.g., using verify module 3006 of FIG. 30) associated with each user of the online community (e.g., as shown in the social community view 3650 of FIG. 36 formed through the neighborhood network module as described in FIG. 38) to verify that each user lives at a residence associated with a claimable residential address (e.g., using sub-modules of the claimable module 2910 as described in FIG. 31) of an online community (e.g., as shown in the social community view 3650 of FIG. 36 formed through the neighborhood network module as described in FIG. 38) formed through a social community module 2906 of the privacy server 2900 using a processor 3902 and a memory (e.g., as described in FIG. 39), a network 2904, and a mapping server 2926 (e.g., providing global map data) communicatively coupled with the privacy server 2900 through the network 2904 to generate a latitudinal data and a longitudinal data associated with each claimable residential address (e.g., using sub-modules of the claimable module 2910 as described in FIG. 31) of the online community (e.g., as shown in the social community view 3650 of FIG. 36 formed through the neighborhood network module as described in FIG. 38) associated with each user of the online community (e.g., as shown in the social community view 3650 of FIG. 36 formed through the neighborhood network module as described in FIG. 38). The privacy server 2900 automatically determines a set of access privileges in the online community (e.g., as shown in the social community view 3650 of FIG. 36 formed through the neighborhood network module as described in FIG. 38) associated with each user of the online community (e.g., as shown in the social community view 3650 of FIG. 36 formed through the neighborhood network module as described in FIG. 38) by constraining access in the online community (e.g., as shown in the social community view 3650 of FIG. 36 formed through the neighborhood network module as described in FIG. 38) based on a neighborhood boundary determined using a Bezier curve algorithm 3040 of the privacy server 2900 in this embodiment.

In addition, in this yet another embodiment the privacy server 2900 transforms the claimable residential address (e.g., using sub-modules of the claimable module 2910 as described in FIG. 31) into a claimed address upon an occurrence of an event. The privacy server 2900 instantiates the event when a particular user 2916 is associated with the claimable residential address (e.g., using sub-modules of the claimable module 2910 as described in FIG. 31) based on a verification of the particular user 2916 as living at a particular residential address (e.g., associated with the residence 2918 of FIG. 29) associated with the claimable residential address (e.g., using sub-modules of the claimable module 2910 as described in FIG. 31) using the privacy server 2900 in this yet another embodiment. The privacy server 2900 constrains the particular user 2916 to communicate through the online community (e.g., as shown in the social community view 3650 of FIG. 36 formed through the neighborhood network module as described in FIG. 38) only with a database of neighbors 2928 (e.g., such as the neighbor 2920 of FIG. 29) having verified addresses using the privacy server 2900 in this yet another embodiment. The privacy server 2900 defines the database of neighbors 2928 (e.g., such as the neighbor 2920 of FIG. 29) as other users of the online community (e.g., as shown in the social community view 3650 of FIG. 36 formed through the neighborhood network module as described in FIG. 38) that have each verified their addresses in the online community (e.g., as shown in the social community view 3650 of FIG. 36 formed through the neighborhood network module as described in FIG. 38) using the privacy server 2900 and which have each claimed residential addresses that are in a threshold radial distance from the claimed address of the particular user 2916 in this yet another embodiment.

FIG. 29 is a system view of a privacy server 2900 communicating with neighborhood(s) 2902A-N through a network 2904, an advertiser(s) 2924, a mapping server 2926, an a database of neighbors 2928 (e.g., occupant data), according to one embodiment. Particularly FIG. 29 illustrates the privacy server 2900, the neighborhood 2902A-N, the network 2904, advertiser(s) 2924, mapping server 2926, and the database of neighbors 2928 (e.g., occupant data), according to one embodiment. The privacy server 2900 may contain a social community module 2906, a search module 2908, a claimable module 2910, a commerce module 2912, and a map algorithm 2914. The neighborhood may include a user 2916, a community center 2921, a residence 2918, a neighbor 2920 and a business 2922, according to one embodiment.

The privacy server 2900 may include any number of neighborhoods having registered users and/or unregistered users. The neighborhood(s) 2902 may be a geographically localized community in a larger city, town, and/or suburb. The network 2904 may be search engines, blogs, social networks, professional networks and static website that may unite individuals, groups and/or community. The social community module 2906 may generate a building creator in which the registered users may create and/or modify empty claimable profiles (e.g., a claimable profile 4006 of FIG. 40B-41A, a claimable profile 4102 of FIG. 41A, a claimable profile 1704 of FIG. 17). The search module 2908 may include searching of information of an individual, group and/or community.

The social community module 2906 (e.g., that applies the Bezier curve algorithm 3040 of FIG. 30 using a series of modules working in concert as described in FIG. 30), as a function/module of the emergency response server, may determine the location of the user 2916, the distance between the user 2916 and other verified users (e.g., the verified user 4110 of FIG. 41A), and the distance between the user 2916 and locations of interest. With that information, the social community module 2906 (e.g., that applies the Bezier curve algorithm 3040 of FIG. 30 using a series of modules working in concert as described in FIG. 30) may further determine which verified users (e.g., the verified user 4110 of FIG. 41A) are within a predetermined vicinity of a user 2916. This set of verified users within the vicinity of another verified user may then be determined to be receptive to broadcasts transmitted by the user 2916 and to be available as transmitters of broadcasts to the user 2916.

The social community module 2906 (e.g., that applies the Bezier curve algorithm 3040 of FIG. 30 using a series of modules working in concert as described in FIG. 30) in effect may create a link between verified users of the network 2904 that allows the users to communicate with each other, and this link may be based on the physical distance between the users as measured relative to a current geospatial location of the device (e.g., the device 1806, the device 1808 of FIG. 18) with a claimed and verified (e.g., through a verification mechanism such as a postcard verification, a utility bill verification, and/or a vouching of the user with other users) non-transitory location (e.g., a home location, a work location) of the user and/or other users. In an alternate embodiment, the transitory location of the user (e.g., their current location, a current location of their vehicle and/or mobile phone) and/or the other users may also be used by the radial algorithm (e.g., the Bezier curve algorithm 3040 of FIG. 30) to determine an appropriate threshold distance for broadcasting a message.

Furthermore, the social community module 2906 (e.g., that applies the Bezier curve algorithm 3040 of FIG. 30 using a series of modules working in concert as described in FIG. 30) may automatically update a set of pages associated with profiles of individuals and/or businesses that have not yet joined the network based on preseeded address information. In effect, the social community module 2906 (e.g., that applies the Bezier curve algorithm 3040 of FIG. 30 using a series of modules working in concert as described in FIG. 30) may update preseeded pages in a geo-constrained radial distance from where a broadcast originates (e.g., using an epicenter calculated from the current location of the device (e.g., the device 1806, the device 1808 of FIG. 18) (e.g., a mobile version of the device 1806 of FIG. 18 (e.g., a mobile phone, a tablet computer) with information about the neighborhood broadcast data. In effect, through this methodology, the social community module 2906 (e.g., that applies the Bezier curve algorithm 3040 of FIG. 30 using a series of modules working in concert as described in FIG. 30) may leave ‘inboxes’ and/or post ‘alerts’ on pages created for users that have not yet signed up based on a confirmed address of the users through a public and/or a private data source (e.g., from Infogroup®, from a white page directory, etc.).

The social community module 2906 (e.g., that applies the Bezier curve algorithm 3040 of FIG. 30 using a series of modules working in concert as described in FIG. 30) of the privacy server 2900 may be different from previous implementations because it is the first implementation to simulate the experience of local radio transmission between individuals using the internet and non-radio network technology by basing their network broadcast range on the proximity of verified users to one another, according to one embodiment.

The Bezier curve algorithm 3040 may operate as follows, according to one embodiment. The radial algorithm (e.g., the Bezier curve algorithm 3040 of FIG. 30) may utilize a radial distribution function (e.g., a pair correlation function)

g(r)

In the neighborhood communication system 2950. The radial distribution function may describe how density varies as a function of distance from a user 2916, according to one embodiment.

If a given user 2916 is taken to be at the origin O (e.g., the epicenter), and if ρ=N/V is the average number density of recipients (e.g., other users of the neighborhood communication system 2950 such as neighbors 2920 of FIG. 29) in the neighborhood communication system 2950, then the local time-averaged density at a distance from O is τg(r) according to one embodiment. This simplified definition may hold for a homogeneous and isotropic type of recipients (e.g., other users of the neighborhood communication system 2950 such as neighbors 2920 of FIG. 29), according to one embodiment of the Bezier curve algorithm 3040.

A more anisotropic distribution (e.g., exhibiting properties with different values when measured in different directions) of the recipients (e.g., other users of the neighborhood communication system 2950 such as neighbors 2920 of FIG. 29) will be described below, according to one embodiment of the Bezier curve algorithm 3040. In simplest terms it may be a measure of the probability of finding a recipient at a distance of r away from a given user 2916, relative to that for an ideal distribution scenario, according to one embodiment. The anisotropic algorithm involves determining how many recipients (e.g., other users of the neighborhood communication system 2950 such as neighbors 2920 of FIG. 29) are within a distance of r and r+dr away from the user 2916, according to one embodiment. The Bezier curve algorithm 3040 may be determined by calculating the distance between all user pairs and binning them into a user histogram, according to one embodiment.

The histogram may then be normalized with respect to an ideal user at the origin o, where user histograms are completely uncorrelated, according to one embodiment. For three dimensions (e.g., such as a building representation in the privacy server 2900 in which there are multiple residents in each floor), this normalization may be the number density of the system multiplied by the volume of the spherical shell, which mathematically can be expressed as g(r)_{I}=4πr²ρdr, where P may be the user density, according to one embodiment of the Bezier curve algorithm 3040.

The radial distribution function of the Bezier curve algorithm 3040 can be computed either via computer simulation methods like the Monte Carlo method, or via the Ornstein-Zernike equation, using approximative closure relations like the Percus-Yevick approximation or the Hypernetted Chain Theory, according to one embodiment.

This may be important because by confining the broadcast reach of a verified user in the neighborhood communication system 2950 to a specified range, the social community module 2906 (e.g., that applies the Bezier curve algorithm 3040 of FIG. 30 using a series of modules working in concert as described in FIG. 30) may replicate the experience of local radio broadcasting and enable verified users to communicate information to their immediate neighbors as well as receive information from their immediate neighbors in areas that they care about, according to one embodiment. Such methodologies can be complemented with hyperlocal advertising targeted to potential users of the privacy server 2900 on preseeded profile pages and/or active user pages of the privacy server 2900. Advertisement communications thus may become highly specialized and localized resulting in an increase in their value and interest to the local verified users of the network through the privacy server 2900. For example, advertisers may wish to communicate helpful home security devices to a set of users located in a geospatial area with a high concentration of home break-in broadcasts.

The social community module 2906 (e.g., that applies the Bezier curve algorithm 3040 of FIG. 30 using a series of modules working in concert as described in FIG. 30) may also have wide application as it may solve the problem of trying to locate a receptive audience to a verified user's broadcasts, whether that broadcast may a personal emergency, an one's personal music, an advertisement for a car for sale, a solicitation for a new employee, and/or a recommendation for a good restaurant in the area. This social community module 2906 (e.g., that applies the Bezier curve algorithm 3040 of FIG. 30 using a series of modules working in concert as described in FIG. 30) may eliminate unnecessarily broadcasting that information to those who are not receptive to it, both as a transmitter and as a recipient of the broadcast. The radial algorithm (e.g., the Bezier curve algorithm 3040 of FIG. 30) saves both time (which may be critical and limited in an emergency context) and effort of every user involved by transmitting information only to areas that a user cares about, according to one embodiment.

In effect, the radial algorithm (e.g., the Bezier curve algorithm 3040 of FIG. 30) of the emergency response server enables users to notify people around locations that are cared about (e.g., around where they live, work, and/or where they are physically located). In one embodiment, the user 2916 can be provided ‘feedback’ and/or a communication that the neighbor 2920 may be responding to the emergency after the neighborhood broadcast data may be delivered to the recipients (e.g., other users of the neighborhood communication system 2950 such as neighbors 2920 of FIG. 29) and/or to the neighborhood services using the social community module 2906 (e.g., that applies the Bezier curve algorithm 3040 of FIG. 30 using a series of modules working in concert as described in FIG. 30) of the privacy server 2900. For example, after the neighborhood broadcast data may be delivered, the device (e.g., the device 1806, the device 1808 of FIG. 18) (e.g., a mobile version of the device 1806 of FIG. 18 (e.g., a mobile phone, a tablet computer)) may display a message saying: “3256 neighbors around a 1 radius from you have been notified on their profile pages of your crime broadcast in Menlo Park and 4 people are responding” and/or “8356 neighbors and two hospitals around a 2.7 radius from you have been notified of your medical emergency.”

The various embodiments described herein of the privacy server 2900 using the social community module 2906 (e.g., that applies the Bezier curve algorithm 3040 of FIG. 30 using a series of modules working in concert as described in FIG. 30) may solve a central problem of internet radio service providers (e.g., Pandora) by retaining cultural significance related to a person's locations of association. For example, the social community module 2906 (e.g., that applies the Bezier curve algorithm 3040 of FIG. 30 using a series of modules working in concert as described in FIG. 30) may be used to ‘create’ new radio stations, television stations, and/or mini alert broadcasts to a geospatially constrained area on one end, and provide a means for those ‘tuning in’ to consume information posted in a geospatial area that the listener cares about and/or associates themselves with. The information provided can be actionable in that the user 2916 may be able to secure new opportunities through face to face human interaction and physical meeting not otherwise possible in internet radio scenarios.

The radial algorithm (e.g., the Bezier curve algorithm 3040 of FIG. 30) may be a set of instructions that may enable users (e.g., verified users, non-verified users) of the Nextdoor.com and Fatdoor.com websites and applications to broadcast their activities (e.g., garage sale, t-shirt sale, crime alert) to surrounding neighbors within a claimed neighborhood and to guests of a claimed neighborhood, according to one embodiment. The radial algorithm (e.g., the Bezier curve algorithm 3040 of FIG. 30) may be new because current technology does not allow for users of a network (e.g., Nextdoor.com, Fatdoor.com) to locally broadcast their activity to a locally defined geospatial area. With the radial algorithm (e.g., the Bezier curve algorithm 3040 of FIG. 30), users of the network may communicate with one another in a locally defined manner, which may present more relevant information and activities, according to one embodiment. For example, if a verified user of the network broadcasts an emergency, locally defined neighbors of the verified user may be much more interested in responding than if they observed an emergency on a general news broadcast on traditional radio, according to one embodiment. The social community module 2906 may solve the problem of neighbors living in the locally defined geospatial area who don't typically interact, and allows them to connect within a virtual space that did not exist before, according to one embodiment. Community boards (e.g., stolen or missing item boards) may have been a primary method of distributing content in a surrounding neighborhood effectively prior to the disclosures described herein. However, there was no way to easily distribute content related to exigent circumstances and/or with urgency in a broadcast-like manner to those listening around a neighborhood through mobile devices until the various embodiments applying the social community module 2906 as described herein.

A Bezier curve algorithm 3040 may be a method of calculating a sequence of operations, and in this case a sequence of radio operations, according to one embodiment. Starting from an initial state and initial input, the Bezier curve algorithm 3040 describes a computation that, when executed, proceeds through a finite number of well-defined successive states, eventually producing radial patterned distribution (e.g., simulating a local radio station), according to one embodiment.

The privacy server 2900 may solve technical challenges through the social community module 2906 (e.g., that applies the Bezier curve algorithm 3040 of FIG. 30 using a series of modules working in concert as described in FIG. 30) by implementing a vigorous screening process to screen out any lewd or vulgar content in one embodiment. For example, what may be considered lewd content sometimes could be subjective, and verified users could argue that the operator of the privacy server 2900 is restricting their constitutional right to freedom of speech (e.g., if the emergency response server is operated by a government entity) through a crowd-moderation capability enabled by the social community module 2906 (e.g., that applies the Bezier curve algorithm 3040 of FIG. 30 using a series of modules working in concert as described in FIG. 30), according to one embodiment. In one embodiment, verified users may sign an electronic agreement to screen their content and agree that the neighborhood communication system 2950 may delete any content that it deems inappropriate for broadcasting, through the social community module 2906 (e.g., that applies the Bezier curve algorithm 3040 of FIG. 30 using a series of modules working in concert as described in FIG. 30) according to one embodiment. For example, it may be determined that a lost item such as a misplaced set of car keys does not qualify as an “emergency” that should be broadcast.

The social community module 2906 (e.g., that applies the Bezier curve algorithm 3040 of FIG. 30 using a series of modules working in concert as described in FIG. 30), in addition to neighborhood broadcasts (e.g., such as emergency broadcasts), may allow verified users to create and broadcast their own radio show, e.g., music, talk show, commercial, instructional contents, etc., and to choose their neighborhood(s) for broadcasting based on a claimed location, according to one embodiment. The social community module 2906 (e.g., that applies the Bezier curve algorithm 3040 of FIG. 30 using a series of modules working in concert as described in FIG. 30) may allow users to choose the neighborhoods that they would want to receive the broadcasts, live and recorded broadcasts, and/or the types and topics (e.g., minor crimes, property crimes, medical emergencies) of broadcasts that interest them.

The social community module 2906 (e.g., that applies the Bezier curve algorithm 3040 of FIG. 30 using a series of modules working in concert as described in FIG. 30) based approach of the privacy server 2900 may be a completely different concept from the currently existing neighborhood (e.g., geospatial) social networking options. The social community module 2906 (e.g., that applies the Bezier curve algorithm 3040 of FIG. 30 using a series of modules working in concert as described in FIG. 30) may also allow the user to create his/her own radio station, television station and/or other content such as the neighborhood broadcast data and distribute this content around locations to users and preseeded profiles around them. For example, the user may wish to broadcast their live reporting of a structure fire or interview eye-witnesses to a robbery. The social community module 2906 (e.g., that applies the Bezier curve algorithm 3040 of FIG. 30 using a series of modules working in concert as described in FIG. 30) can allow verified users to create their content and broadcast in the selected geospatial area. It also allows verified listeners to listen to only the relevant local broadcasts of their choice.

The social community module 2906 (e.g., that applies the Bezier curve algorithm 3040 of FIG. 30 using a series of modules working in concert as described in FIG. 30) may be important because it may provide any verified user the opportunity to create his/her own radial broadcast message (e.g., can be audio, video, pictorial and/or textual content) and distribute this content to a broad group. Social community module 2906 (e.g., that applies the Bezier curve algorithm 3040 of FIG. 30 using a series of modules working in concert as described in FIG. 30) may also allow verified listeners to listen to any missed live broadcasts through the prerecorded features, according to one embodiment. Through this, the social community module 2906 (e.g., that applies the Bezier curve algorithm 3040 of FIG. 30 using a series of modules working in concert as described in FIG. 30) changes the way social networks (e.g., Nextdoor®, Fatdoor®, Facebook®, Path®, etc.) operate by enabling location centric broadcasting to regions that a user cares about, according to one embodiment. Social community module 2906 (e.g., that applies the Bezier curve algorithm 3040 of FIG. 30 using a series of modules working in concert as described in FIG. 30) may solve a technical challenge by defining ranges based on a type of an emergency type, a type of neighborhood, and/or boundary condition of a neighborhood by analyzing whether the neighborhood broadcast data may be associated with a particular kind of recipient, a particular neighborhood, a temporal limitation, and/or through another criteria.

By using the social community module 2906 (e.g., that applies the Bezier curve algorithm 3040 of FIG. 30 using a series of modules working in concert as described in FIG. 30) of the privacy server 2900 the user 2916 may be able to filter irrelevant offers and information provided by broadcasts. In one embodiment, only the broadcasting user (e.g., the user 2916) may be a verified user to create accountability for a particular broadcast and/or credibility of the broadcaster. In this embodiment, recipients (e.g., other users of the neighborhood communication system 2950 such as neighbors 2920 of FIG. 29) of the broadcast may not need to be verified users of the emergency response network. By directing traffic and organizing the onslaught of broadcasts, the social community module 2906 (e.g., that applies the Bezier curve algorithm 3040 of FIG. 30 using a series of modules working in concert as described in FIG. 30) of the privacy server 2900 may be able to identify the origins and nature of each group of incoming information and locate recipients (e.g., other users of the neighborhood communication system 2950 such as neighbors 2920 of FIG. 29) that are relevant/interested in the neighborhood broadcast data, maximizing the effective use of each broadcast. For example, the neighbor 2920 may be able to specify that they own a firearm so that they would be a relevant neighbor 2920 for broadcast data to respond to a school shooting. In another example, the neighbor 2920 may specify that they are a medical professional (e.g., paramedic, physician) such that they may receive medical emergency broadcasts, according to one embodiment.

The social community module 2906 (e.g., that applies the Bezier curve algorithm 3040 of FIG. 30 using a series of modules working in concert as described in FIG. 30) of the privacy server 2900 may process the input data from the device (e.g., the device 1806, the device 1808 of FIG. 18) (e.g., a mobile version of the device 1806 of FIG. 18 (e.g., a mobile phone, a tablet computer)) in order to identify which notification(s) to broadcast to which individual(s). This may be separate from a traditional radio broadcast as it not only geographically constrains broadcasters and recipients (e.g., other users of the neighborhood communication system 2950 such as neighbors 2920 of FIG. 29) but also makes use of user preferences in order to allow broadcasters to target an optimal audience and allow recipients (e.g., other users of the neighborhood communication system 2950 such as neighbors 2920 of FIG. 29) to alter and customize what they consume. The user 2916 may associate him/herself with a non-transitory address in order to remain constantly connected to their neighborhood and/or neighbors even when they themselves or their neighbors are away. The Bezier curve algorithm 3040 may be also unique from a neighborhood social network (e.g., the privacy server 2900) as it permits users to broadcast emergencies, information, audio, video etc. to other users, allowing users to create their own stations.

In order to implement the social community module 2906 (e.g., that applies the Bezier curve algorithm 3040 of FIG. 30 using a series of modules working in concert as described in FIG. 30), geospatial data may need to be collected and amassed in order to create a foundation on which users may sign up and verify themselves by claiming a specific address, associating themselves with that geospatial location. The social community module 2906 (e.g., that applies the Bezier curve algorithm 3040 of FIG. 30 using a series of modules working in concert as described in FIG. 30) may then be able to utilize the business 2922 to filter out surrounding noise and deliver only relevant data to recipients (e.g., other users of the neighborhood communication system 2950 such as neighbors 2920 of FIG. 29). In order to accomplish this, the social community module 2906 (e.g., that applies the Bezier curve algorithm 3040 of FIG. 30 using a series of modules working in concert as described in FIG. 30) may be able to verify the reliability of geospatial coordinates, time stamps, and user information associated with the device (e.g., the device 1806, the device 1808 of FIG. 18) (e.g., a a mobile version of the device 1806 of FIG. 18 (e.g., a mobile phone, a tablet computer)). In addition, threshold geospatial radii, private neighborhood boundaries, and personal preferences may be established in the privacy server 2900 and accommodated using the social community module 2906 (e.g., that applies the Bezier curve algorithm 3040 of FIG. 30 using a series of modules working in concert as described in FIG. 30). The business 2922 may work in concert with the social community module 2906 (e.g., that applies the Bezier curve algorithm 3040 of FIG. 30 using a series of modules working in concert as described in FIG. 30) to store, organize, and manage broadcasts, pushpins, user profiles, preseeded user profiles, metadata, and epicenter locations associated with the privacy server 2900 (e.g., a neighborhood social network such as Fatdoor.com, Nextdoor.com).

The Bezier curve algorithm 3040 may be used to calculate relative distances between each one of millions of records as associated with each placed geo-spatial coordinate in the privacy server 2900 (e.g., a neighborhood social network such as Fatdoor.com, Nextdoor.com). Calculations of relative distance between each geospatial coordinate can be a large computational challenge because of the high number of reads, writes, modify, and creates associated with each geospatial coordinate added to the privacy server 2900 and subsequent recalculations of surrounding geospatial coordinates associated with other users and/or other profile pages based a relative distance away from a newly added set of geospatial coordinates (e.g., associated with the neighborhood broadcast data and/or with other pushpin types). To overcome this computational challenge, the radial algorithm (e.g., the Bezier curve algorithm 3040 of FIG. 30) may leverage a massively parallel computing architecture through which processing functions are distributed across a large set of processors accessed in a distributed computing system through the network 2904.

In order to achieve the utilization of the massively parallel computing architecture in a context of a radial distribution function of a privacy server 2900, a number of technical challenges have been overcome in at least one embodiment. Particularly, the social community module 2906 constructs a series of tables based on an ordered geospatial ranking based on frequency of interaction through a set of ‘n’ number of users simultaneously interacting with the privacy server 2900, in one preferred embodiment. In this manner, sessions of access between the privacy server 2900 and users of the privacy server 2900 (e.g., the user 2916) may be monitored based on geospatial claimed areas of the user (e.g., a claimed work and/or home location of the user), and/or a present geospatial location of the user. In this manner, tables associated with data related to claimed geospatial areas of the user and/or the present geospatial location of the user may be anticipatorily cached in the memory 2924 to ensure that a response time of the privacy server 2900 may be not constrained by delays caused by extraction, retrieval, and transformation of tables that are not likely to be required for a current and/or anticipated set of sessions between users and the privacy server 2900.

In a preferred embodiment, an elastic computing environment may be used by the social community module 2906 to provide for increase/decreases of capacity within minutes of a database function requirement. In this manner, the social community module 2906 can adapt to workload changes based on number of requests of processing simultaneous and/or concurrent requests associated with neighborhood broadcast data by provisioning and de-provisioning resources in an autonomic manner, such that at each point in time the available resources match the current demand as closely as possible.

The social community module 2906 (e.g., that applies the Bezier curve algorithm 3040 of FIG. 30 using a series of modules working in concert as described in FIG. 30) may be a concept whereby a server communicating data to a dispersed group of recipients (e.g., other users of the neighborhood communication system 2950 such as neighbors 2920 of FIG. 29) over a network 2904, which may be an internet protocol based wide area network (as opposed to a network communicating by radio frequency communications) communicates that data only to a geospatially-constrained group of recipients (e.g., other users of the neighborhood communication system 2950 such as neighbors 2920 of FIG. 29). The social community module 2906 (e.g., that applies the Bezier curve algorithm 3040 of FIG. 30 using a series of modules working in concert as described in FIG. 30) may apply a geospatial constraint related to a radial distance away from an origin point, or a constraint related to regional, state, territory, county, municipal, neighborhood, building, community, district, locality, and/or other geospatial boundaries.

The social community module 2906 (e.g., that applies the Bezier curve algorithm 3040 of FIG. 30 using a series of modules working in concert as described in FIG. 30) may be new as applied to data traveling over wide area networks using internet protocol topology in a geospatial social networking and commerce context, according to one embodiment. While radio broadcasts, by their nature, are transmitted in a radial pattern surrounding the origin point, there may be no known mechanism for restricting access to the data only to verified users of a service subscribing to the broadcast. As applied to wired computer networks, while techniques for applying geospatial constraints have been applied to search results, and to other limited uses, there has as yet been no application of geospatial constraint as applied to the various embodiments described herein using the social community module 2906 (e.g., that applies the Bezier curve algorithm 3040 of FIG. 30 using a series of modules working in concert as described in FIG. 30).

The social community module 2906 (e.g., that applies the Bezier curve algorithm 3040 of FIG. 30 using a series of modules working in concert as described in FIG. 30) may be roughly analogous to broadcast radio communications such as a) in broadcast radio, b) in wireless computer networking, and c) in mobile telephony. However, all of these systems broadcast their information promiscuously, making the data transmitted available to anyone within range of the transmitter who may be equipped with the appropriate receiving device. In contrast, the social community module 2906 (e.g., that applies the Bezier curve algorithm 3040 of FIG. 30 using a series of modules working in concert as described in FIG. 30) herein describes a system in which networks are used to transmit data in a selective manner in that information may be distributed around a physical location of homes or businesses in areas of interest/relevancy.

The social community module 2906 (e.g., that applies the Bezier curve algorithm 3040 of FIG. 30 using a series of modules working in concert as described in FIG. 30) may solve a problem of restricting data transmitted over networks to specific users who are within a specified distance from the individual who originates the data. In a broad sense, by enabling commerce and communications that are strictly limited within defined neighborhood boundaries, the social community module 2906 (e.g., that applies the Bezier curve algorithm 3040 of FIG. 30 using a series of modules working in concert as described in FIG. 30) may enable the privacy server 2900 (e.g., a neighborhood social network such as Fatdoor.com, Nextdoor.com) communications, attacking the serious social conditions of anonymity and disengagement in community that afflict the nation and, increasingly, the world.

The social community module 2906 (e.g., that applies the Bezier curve algorithm 3040 of FIG. 30 using a series of modules working in concert as described in FIG. 30) may comprise one or more modules that instruct the privacy server 2900 to restrict the broadcasting of the neighborhood broadcast data to one or more parts of the geospatial area 117. For example, in the embodiment of FIG. 29, the social community module 2906 (e.g., that applies the Bezier curve algorithm 3040 of FIG. 30 using a series of modules working in concert as described in FIG. 30) may instruct the privacy server 2900 to broadcast the neighborhood broadcast data to the recipients (e.g., other users of the neighborhood communication system 2950 such as neighbors 2920 of FIG. 29) but not to the area outside the threshold radial distance.

In one or more embodiments, the social community module 2906 (e.g., that applies the Bezier curve algorithm 3040 of FIG. 30 using a series of modules working in concert as described in FIG. 30) may allow the privacy server 2900 to function in manner that simulates a traditional radio broadcast (e.g., using a radio tower to transmit a radio frequency signal) in that both the privacy server 2900 and the radio broadcast are restricted in the geospatial scope of the broadcast transmission. In one or more embodiments, the social community module 2906 (e.g., that applies the Bezier curve algorithm 3040 of FIG. 30 using a series of modules working in concert as described in FIG. 30) may prevent the broadcast of the neighborhood broadcast data to any geospatial area to which the user 2916 does not wish to transmit the neighborhood broadcast data, and/or to users that have either muted and/or selectively subscribed to a set of broadcast feeds.

The social community module 2906 (e.g., that applies the Bezier curve algorithm 3040 of FIG. 30 using a series of modules working in concert as described in FIG. 30) may analyze the neighborhood broadcast data to determine which recipients (e.g., other users of the neighborhood communication system 2950 such as neighbors 2920 of FIG. 29) may receive notification data within the threshold radial distance (e.g., set by the user 2916 and/or auto calculated based on a type of emergency posting). The social community module 2906 (e.g., that applies the Bezier curve algorithm 3040 of FIG. 30 using a series of modules working in concert as described in FIG. 30) may use a variety of parameters, including information associated with the neighborhood broadcast data (e.g., location of the broadcast, type of broadcast, etc.) to determine the threshold radial distance.

The social community module 2906 (e.g., that applies the Bezier curve algorithm 3040 of FIG. 30 using a series of modules working in concert as described in FIG. 30) may also determine which verified addresses associated with recipients (e.g., other users of the neighborhood communication system 2950 such as neighbors 2920 of FIG. 29) having verified user profiles are located within the threshold radial distance. The social community module 2906 (e.g., that applies the Bezier curve algorithm 3040 of FIG. 30 using a series of modules working in concert as described in FIG. 30) may then broadcast the notification data to the profiles and/or mobile devices of the verified users having verified addresses within the threshold radial distance.

The social community module 2906 (e.g., that applies the Bezier curve algorithm 3040 of FIG. 30 using a series of modules working in concert as described in FIG. 30) may therefore simulate traditional radio broadcasting (e.g., from a radio station transmission tower) over the IP network. Thus, the social community module 2906 (e.g., that applies the Bezier curve algorithm 3040 of FIG. 30 using a series of modules working in concert as described in FIG. 30) may allow the broadcast to include information and data that traditional radio broadcasts may not be able to convey, for example geospatial coordinates and/or real-time bi-directional communications. Additionally, the social community module 2906 (e.g., that applies the Bezier curve algorithm 3040 of FIG. 30 using a series of modules working in concert as described in FIG. 30) may allow individual users low-entry broadcast capability without resort to expensive equipment and/or licensing by the Federal Communications Commission (FCC).

Another advantage of this broadcast via the social community module 2906 (e.g., that applies the Bezier curve algorithm 3040 of FIG. 30 using a series of modules working in concert as described in FIG. 30) may be that it may bypass obstructions that traditionally disrupt radio waves such as mountains and/or atmospheric disturbances. Yet another advantage of the social community module 2906 (e.g., that applies the Bezier curve algorithm 3040 of FIG. 30 using a series of modules working in concert as described in FIG. 30) may be that it may expand the physical distance of broadcast capability without resort to the expense ordinarily associated with generating powerful carrier signals. In yet another advantage, the social community module 2906 (e.g., that applies the Bezier curve algorithm 3040 of FIG. 30 using a series of modules working in concert as described in FIG. 30) may allow for almost unlimited channels and/or stations as compared to traditional radio where only a narrow band of electromagnetic radiation has been appropriated for use among a small number of entities by government regulators (e.g., the FCC).

The claimable module 2910 may enable the registered users to create and/or update their information. A ‘claimable’ (e.g., may be enabled through the claimable module 2910) can be defined as a perpetual collective work of many authors. Similar to a blog in structure and logic, a claimable allows anyone to edit, delete or modify content that has been placed on the Web site using a browser interface, including the work of previous authors. In contrast, a blog (e.g., or a social network page), typically authored by an individual, may not allow visitors to change the original posted material, only add comments to the original content. The term claimable refers to either the web site or the software used to create the site. The term ‘claimable’ also implies fast creation, ease of creation, and community approval in many software contexts (e.g., claimable means “quick” in Hawaiian).

The commerce module may provide an advertisement system to a business that may enable the users to purchase location in the neighborhood(s) 2902. The map algorithm 2914 may be indulged in study, practice, representing and/or generating maps, or globes. The user 2916 may be an individuals and/or households that may purchase and/or use goods and services and/or be an active member of any group or community and/or resident and/or a part of any neighborhood(s) 2902. The residence 2918 may be a house, a place to live and/or like a nursing home in a neighborhood(s) 2902.

The community center 2921 may be public locations where members of a community may gather for group activities, social support, public information, and other purposes. The business 2922 may be a customer service, finance, sales, production, communications/public relations and/or marketing organization that may be located in the neighborhood(s) 2902. The advertiser(s) 2924 may be an individual and/or a firm drawing public who may be responsible in encouraging the people attention to goods and/or services by promoting businesses, and/or may perform through a variety of media. The mapping server 2926 may contain the details/maps of any area, region and/or neighborhood. The social community module 2906 of the privacy server 2900 may communicate with the neighborhood(s) 2902 through the network 2904 and/or the search module 2908. The social community module 2906 of the privacy server 2900 may communicate with the advertiser(s) 2924 through the commerce module, the database of neighbors 2928 (e.g., occupant data) and/or mapping server 2926 through the map algorithm 2914.

For example, the neighborhoods 2902A-N may have registered users and/or unregistered users of a privacy server 2900. Also, the social community module 2906 of the privacy server 2900 may generate a building creator (e.g., building builder 4402 of FIG. 44) in which the registered users may create and/or modify empty claimable profiles, building layouts, social network pages, and/or floor levels structures housing residents and/or businesses in the neighborhood.

In addition, the claimable module 2910 of the privacy server 2900 may enable the registered users to create a social network page of themselves, and/or may edit information associated with the unregistered users identifiable through a viewing of physical properties in which, the unregistered users reside when the registered users have knowledge of characteristics associated with the unregistered users.

Furthermore, the search module 2908 of the privacy server 2900 may enable a people search (e.g., the people search widget 3100 of FIG. 31), a business search (e.g., the business search module 3102 of FIG. 31), and/or a category search (e.g., the category search widget 3104 of FIG. 31) of any data in the social community module 2906 and/or may enable embedding of any content in the privacy server 2900 in other search engines, blogs, social networks, professional networks and/or static websites.

The commerce module of the privacy server 2900 may provide an advertisement system to a business who purchase their location in the privacy server 2900 in which the advertisement may be viewable concurrently with a map indicating a location of the business, and/or in which revenue may be attributed to the privacy server 2900 when the registered users and/or the unregistered users click-in on a simultaneously displayed data of the advertisement along with the map indicating a location of the business.

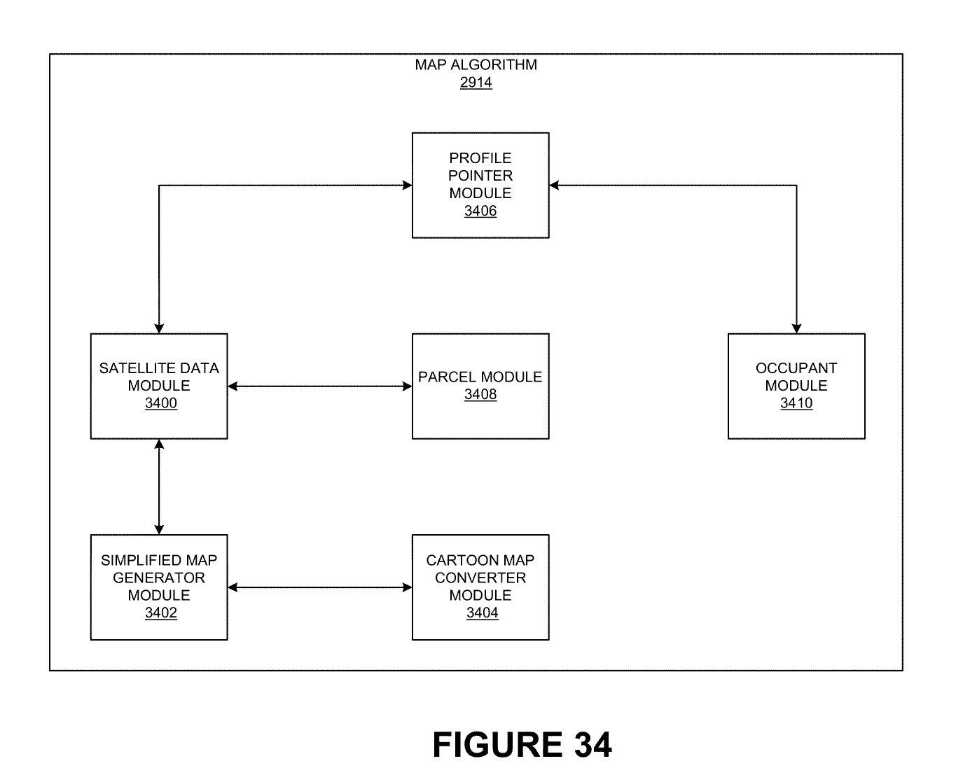

Moreover, a map algorithm 2914 of the privacy server 2900 may include a map data associated with a satellite data (e.g., generated by the satellite data module 3400 of FIG. 34) which may serve as a basis of rendering the map in the privacy server 2900 and/or which includes a simplified map generator which may transform the map to a fewer color and/or location complex form using a parcel data which identifies some residence, civic, and/or business locations in the satellite data.

In addition, a first instruction set may enable a social network to reside above a map data, in which the social network may be associated with specific geographical locations identifiable in the map data. Also, a second instruction set integrated with the first instruction set may enable users of the social network to create profiles of other people through a forum which provides a free form of expression of the users sharing information about any entities and/or people residing in any geographical location identifiable in the satellite map data, and/or to provide a technique of each of the users to claim a geographic location (e.g., a geographic location 29024 of FIG. 40A) to control content in their respective claimed geographic locations (e.g., a geographic location 29024 of FIG. 40A).

Furthermore, a third instruction set integrated with the first instruction set and the second instruction set may enable searching of people in the privacy server 2900 by indexing each of the data shared by the user 2916 of any of the people and/or the entities residing in any geographic location (e.g., a geographic location 29024 of FIG. 40A). A fourth instruction set may provide a moderation of content about each other posted of the users 2916 through trusted users of the privacy server 2900 who have an ability to ban specific users and/or delete any offensive and libelous content in the privacy server 2900.

Also, a fifth instruction set may enable an insertion of any content generated in the privacy server 2900 in other search engines through a syndication and/or advertising relationship between the privacy server 2900 and/or other internet commerce and search portals.

Moreover, a sixth instruction set may grow the social network through neighborhood groups, local politicians, block watch communities, issue activism groups, and neighbor(s) 2920 who invite other known parties and/or members to share profiles of themselves and/or learn characteristics and information about other supporters and/or residents in a geographic area of interest through the privacy server 2900.

Also, a seventh instruction set may determine quantify an effect on at least one of a desirability of a location, a popularity of a location, and a market value of a location based on an algorithm that considers a number of demographic and social characteristics of a region surrounding the location through a reviews module.

FIG. 30 is an exploded view of the social community module 2906 of FIG. 29, according to one embodiment. Particularly FIG. 30 illustrates a building builder module 3000, an N^{th} degree module 3002, a tagging module 3004, a verify module 3006, a groups generator module 3008, a pushpin module 3010, a profile module 3012, an announce module 3014, a people database 3016, a places database 3018, a business database 3020, a friend finder module 3022 and a neighbor-neighbor help module 3024, according to one embodiment.

The N^{th} degree module 3002 may enable the particular registered user to communicate with an unknown registered user through a common registered user who may be a friend and/or a member of a common community. The tagging module 3004 may enable the user 2916 to leave brief comments on each of the claimable profiles (e.g., the claimable profile 4006 of FIG. 40B-41A, the claimable profile 4102 of FIG. 41A, the claimable profile 1704 of FIG. 17) and social network pages in the global neighborhood environment 1800 (e.g., the privacy server 2900 of FIG. 29).

The verify module 3006 may validate the data, profiles and/or email addresses received from various registered user(s) before any changes may be included. The groups generator module 3008 may enable the registered users to form groups may be depending on common interest, culture, style, hobbies and/or caste. The pushpin module 3010 may generate customized indicators of different types of users, locations, and interests directly in the map. The profile module 3012 may enable the user to create a set of profiles of the registered users and to submit media content of themselves, identifiable through a map.

The announce module 3014 may distribute a message in a specified range of distance away from the registered users when a registered user purchases a message to communicate to certain ones of the registered users surrounding a geographic vicinity adjacent to the particular registered user originating the message. The people database 3016 may keep records of the visitor/users (e.g., a user 2916 of FIG. 29). The places database module 3018 may manage the data related to the location of the user (e.g., address of the registered user). The business database 3020 may manage an extensive list of leading information related to business. The friend finder module 3022 may match the profile of the registered user with common interest and/or help the registered user to get in touch with new friends or acquaintances.

For example, the verify module 3006 of the social community module 2906 of FIG. 29 may authenticate an email address of a registered user prior to enabling the registered user to edit information associated with the unregistered users through an email response and/or a digital signature technique. The groups generator module 3008 of the social community module (e.g., the social community module 2906 of FIG. 29) may enable the registered users to form groups with each other surrounding at least one of a common neighborhood (e.g., a neighborhood 2902A-N of FIG. 29), political, cultural, educational, professional and/or social interest.

In addition, the tagging module 3004 of the social community module (e.g., the social community module 2906 of FIG. 29) may enable the registered users and/or the unregistered users to leave brief comments on each of the claimable profiles (e.g., the claimable profile 4006 of FIG. 40B-41A, the claimable profile 4102 of FIG. 41A, the claimable profile 1704 of FIG. 17) and/or social network pages in the global neighborhood environment 1800 (e.g., the privacy server 2900 of FIG. 29), in which the brief comments may be simultaneously displayed when a pointing device rolls over a pushpin indicating a physical property associated with any of the registered users and/or the unregistered users. Also, the pushpin module 3010 of the social community module 2906 of FIG. 29 may be generating customized indicators of different types of users, locations, and/or interests directly in the map.

Further, the announce module 3014 of the social community module 2906 of FIG. 29 may distribute a message in a specified range of distance away from the registered users when a registered user purchases a message to communicate to certain ones of the registered users surrounding a geographic vicinity adjacent to the particular registered user originating the message, wherein the particular registered user purchases the message through a governmental currency and/or a number of tokens collected by the particular user (e.g. the user 2916 of FIG. 29) through a creation of content in the global neighborhood environment 1800 (e.g., the privacy server 2900 of FIG. 29).

In addition, the N^{th} degree module 3002 of the social community module 2906 of FIG. 29 may enable the particular registered user to communicate with an unknown registered user through a common registered user known by the particular registered user and/or the unknown registered user that is an N^{th} degree of separation away from the particular registered user and/or the unknown registered user.

Moreover, the profile module 3012 of the social community module 2906 of FIG. 29 may create a set of profiles of each one of the registered users and to enable each one of the registered users to submit media content of themselves, other registered users, and unregistered users identifiable through the map.

FIG. 31 is an exploded view of the search module 2908 of FIG. 29, according to one embodiment. Particularly FIG. 31 illustrates a people search widget 300, a business search module 3102, a category search widget 3104, a communication module 3106, a directory assistance module 3108, an embedding module 3110, a no-match module 3112, a range selector module 3114, a chat widget 3116, a group announcement widget 3118, a Voice Over IP widget 3120, according to one embodiment.

The people search widget 3100 may help in getting the information like the address, phone number and/or e-mail id of the people of particular interest from a group and/or community. The business search module 3102 may help the users (e.g., the user 2916 of FIG. 29) to find the companies, products, services, and/or business related information they need to know about.

The category search widget 3104 may narrow down searches from a broader scope (e.g., if one is interested in information from a particular center, one can go to the category under the center and enter one's query there and it will return results from that particular category only). The communication module 3106 may provide/facilitate multiple by which one can communicate, people to communicate with, and subjects to communicate about among different members of the global neighborhood environment 1800 (e.g., the privacy server 2900 of FIG. 29).

The directory assistance module 3108 may provide voice response assistance to users (e.g., the user 2916 of FIG. 29) assessable through a web and telephony interface of any category, business and search queries of user's of any search engine contents. The embedding module 3110 may automatically extract address and/or contact info from other social networks, search engines, and content providers.

The no-match module 3112 may request additional information from a verified registered user (e.g., a verified registered user 4110 of FIG. 41A-B, a verified registered user 4110 of FIG. 42) about a person, place, and business having no listing in the global neighborhood environment 1800 (e.g., the privacy server 2900 of FIG. 29) when no matches are found in a search query of the verified registered user (e.g., a verified registered user 4110 of FIG. 41A-B, a verified registered user 4110 of FIG. 42).

The chat widget 3116 may provide people to chat online, which is a way of communicating by broadcasting messages to people on the same site in real time. The group announcement widget 3118 may communicate with a group and/or community in may be by Usenet, Mailing list, calling and/or E-mail message sent to notify subscribers. The Voice over IP widget 3120 may help in routing of voice conversations over the Internet and/or through any other IP-based network. The communication module 3106 may communicate directly with the people search widget 300, the business search module 3102, the category search widget 3104, the directory assistance module 3108, the embedding module 3110 may communicate with the no-match module 3112 through the range selector module 3114.

For example, a search module 2908 of the global neighborhood environment 1800 (e.g., the privacy server 2900 of FIG. 29) may enable the people search, the business search, and the category search of any data in the social community module (e.g., the social community module 2906 of FIG. 29) and/or may enable embedding of any content in the global neighborhood environment 1800 (e.g., the privacy server 2900 of FIG. 29) in other search engines, blogs, social networks, professional networks and/or static websites.

In addition, the communicate module 3106 of the search module 2906 may enable voice over internet, live chat, and/or group announcement functionality in the global neighborhood environment 1800 (e.g., the privacy server 2900 of FIG. 29) among different members of the global neighborhood environment 1800 (e.g., the privacy server 2900 of FIG. 29).

Also, the directory assistance module 3108 of the search module 2908 may provide voice response assistance to users (e.g., the user 2916 of FIG. 29) assessable through a web and/or telephony interface of any category, business, community, and residence search queries of users (e.g., the user 2916 of FIG. 29) of any search engine embedding content of the global neighborhood environment 1800 (e.g., the privacy server 2900 of FIG. 29).

The embedding module 3110 of the search module 2908 may automatically extract address and/or contact info from other social networks, search engines, and content providers, and/or to enable automatic extraction of group lists from contact databases of instant messaging platforms.

Furthermore, the no-match module 3112 of the search module 2908 to request additional information from the verified registered user (e.g., the verified registered user 4110 of FIG. 41A-B) about a person, place, and/or business having no listing in the global neighborhood environment 1800 (e.g., the privacy server 2900 of FIG. 29) when no matches are found in a search query of the verified registered user (e.g., the verified registered user 4110 of FIG. 41A-B) and to create a new claimable page based on a response of the verified registered user (e.g., the verified registered user 4110 of FIG. 41A-B) about the at least one person, place, and/or business not previously indexed in the global neighborhood environment 1800 (e.g., the privacy server 2900 of FIG. 29).

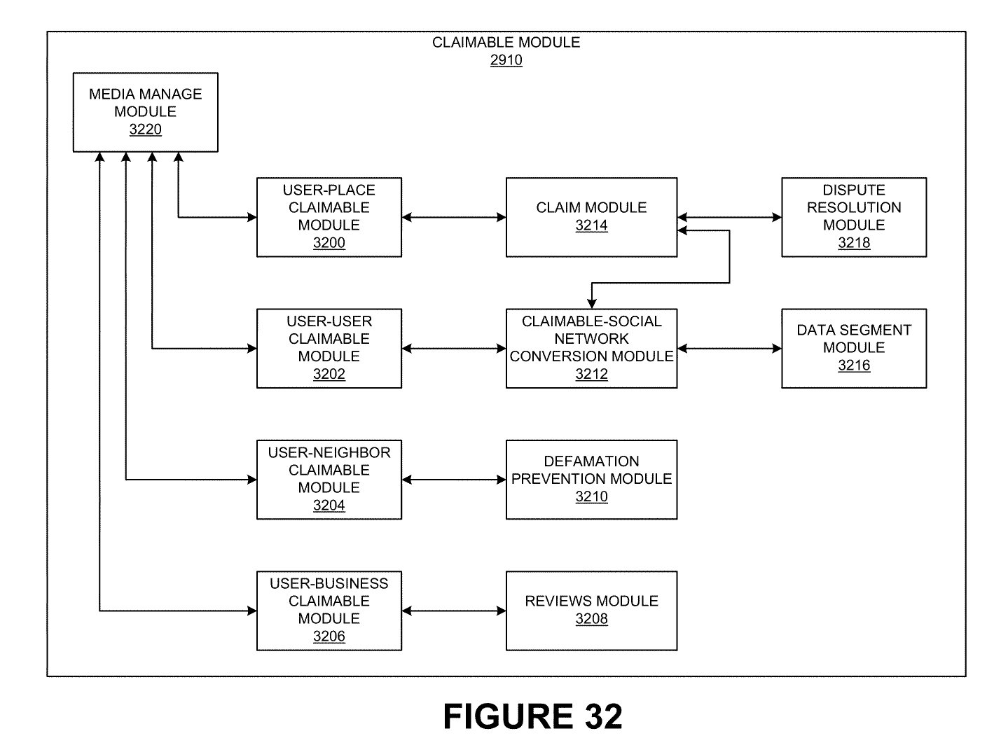

FIG. 32 is an exploded view of the claimable module 2910 of FIG. 29, according to one embodiment. Particularly FIG. 32 illustrates a user-place claimable module 3200, a user-user claimable module 3202, a user-neighbor claimable module 3204, a user-business claimable module 3206, a reviews module 3208, a defamation prevention module 3210, a claimable-social network conversion module 3212, a claim module 3214, a data segment module 3216, a dispute resolution module 3218 and a media manage module 3220, according to one embodiment.

The user-place claimable module 3200 may manage the information of the user (e.g., the user 2916 of FIG. 29) location in the global neighborhood environment 1800 (e.g., the privacy server 2900 of FIG. 29). The user-user claimable module 3202 may manage the user (e.g., the user 2916 of FIG. 29) to view a profile of another user and geographical location in the neighborhood. The user-neighbor claimable module 3204 may manage the user (e.g., the users 2916 of FIG. 29) to view the profile of the registered neighbor and/or may trace the geographical location of the user in the global neighborhood environment 1800 (e.g., the privacy server 2900 of FIG. 29). The user-business claimable module 3206 may manage the profile of the user (e.g., the user 2916 of FIG. 29) managing a commercial business in the neighborhood environment. The reviews module 3208 may provide remarks, local reviews and/or ratings of various businesses as contributed by the users (e.g., the user 2916 of FIG. 29) of the global neighborhood environment 1800 (e.g., the privacy server 2900 of FIG. 29). The defamation prevention module 3210 may enable the registered users to modify the information associated with the unregistered users identifiable through the viewing of the physical properties.

The claimable-social network conversion module 3212 of the claimable module 2910 of FIG. 29 may transform the claimable profiles (e.g., the claimable profile 4006 of FIG. 40B-41A, the claimable profile 4102 of FIG. 41A, the claimable profile 1704 of FIG. 17) to social network profiles when the registered users claim the claimable profiles (e.g., the claimable profile 4006 of FIG. 40B-41A, the claimable profile 4102 of FIG. 41A, the claimable profile 1704 of FIG. 17).

The claim module 3214 may enable the unregistered users to claim the physical properties associated with their residence (e.g., the residence 2918 of FIG. 29). The dispute resolution module 3218 may determine a legitimate user among different unregistered users who claim a same physical property. The media manage module 3220 may allow users (e.g., the user 2916 of FIG. 29) to manage and/or review a list any product from product catalog using a fully integrated, simple to use interface.

The media manage module 3220 may communicate with the user-place claimable module 3200, user-place claimable module 3200, user-user claimable module 3202, the user-neighbor claimable module 3204 and the reviews module 3208 through user-business claimable module 3206. The user-place claimable module 3200 may communicate with the dispute resolution module 3218 through the claim module 3214. The user-user claimable module 3202 may communicate with the data segment module 3216 through the claimable-social network conversion module 3212. The user-neighbor claimable module 3204 may communicate with the defamation prevention module 3210. The user-business claimable module 3206 may communicate with the reviews module 3208. The claimable-social network conversion module 3212 may communicate with the claim module 3214.

For example, the claimable module 2910 of the global neighborhood environment 1800 (e.g., the privacy server 2900 of FIG. 29) may enable the registered users to create the social network page of themselves, and may edit information associated with the unregistered users identifiable through a viewing of physical properties in which the unregistered users reside when the registered users have knowledge of characteristics associated with the unregistered users. Also, the claim module 3214 of claimable module 2910 may enable the unregistered users to claim the physical properties associated with their residence.

Furthermore, the dispute resolution module 3218 of the claimable module 2910 may determine a legitimate user of different unregistered users who claim a same physical property. The defamation prevention module 3210 of the claimable module 2910 may enable the registered users to modify the information associated with the unregistered users identifiable through the viewing of the physical properties, and/or to enable registered user voting of an accuracy of the information associated with the unregistered users.

Moreover, the reviews module of the claimable module 2910 may provide comments, local reviews and/or ratings of various businesses as contributed by the registered users and/or unregistered users of the global network environment (e.g., the privacy server 2900 of FIG. 29). The claimable-social network conversion module 3212 of the claimable module 2910 of FIG. 29 may transform the claimable profiles (e.g., the claimable profile 4006 of FIG. 40B-41A, the claimable profile 4102 of FIG. 41A, the claimable profile 1704 of FIG. 17) to social network profiles when the registered users claim the claimable profiles (e.g., the claimable profile 4006 of FIG. 40B-41A, the claimable profile 4102 of FIG. 41A, the claimable profile 1704 of FIG. 17).

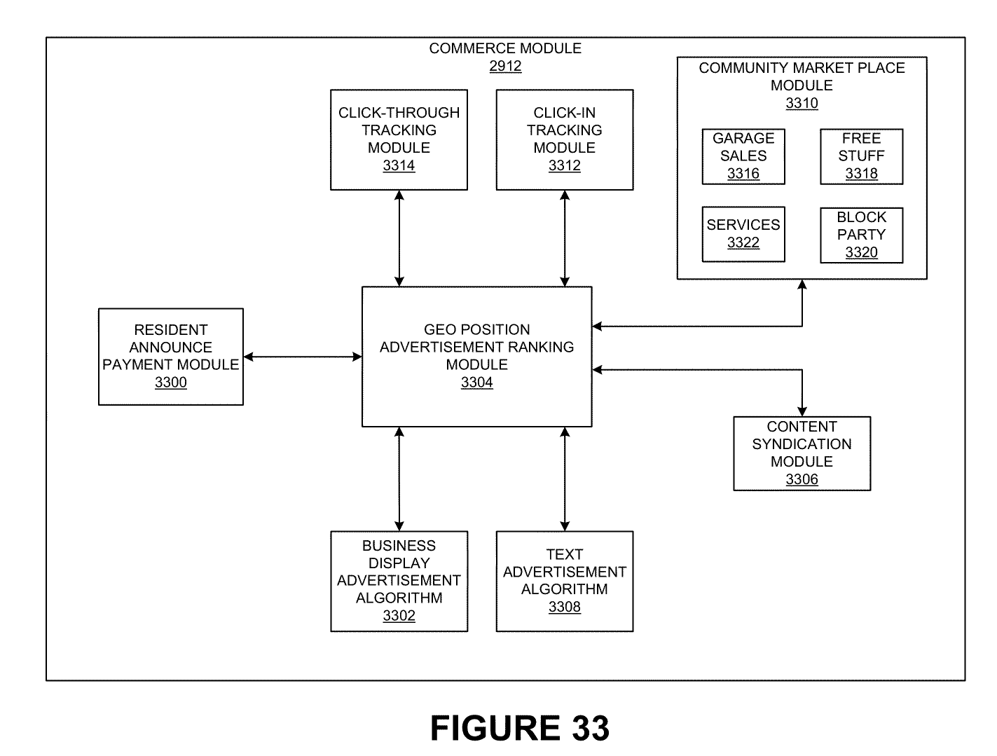

FIG. 33 is an exploded view of the commerce module of FIG. 29, according to one embodiment. Particularly FIG. 33 illustrates a resident announce payment module 3300, a business display advertisement algorithm 3302, a geo position advertisement ranking module 3304, a content syndication module 3306, a text advertisement algorithm 3308, a community marketplace module 3310, a click-in tracking module 3312, a click-through tracking module 3314, according to one embodiment.

The community marketplace module 3310 may contain garage sales 3316, a free stuff 3318, a block party 3320 and a services 3322, according to one embodiment. The geo-position advertisement ranking module 3304 may determine an order of the advertisement in a series of other advertisements provided in the global neighborhood environment 1800 (e.g., the privacy server 2900 of FIG. 29) by other advertisers. The click-through tracking module 3314 may determine a number of clicks-through from the advertisement to a primary website of the business.

A click-in tracking module 3312 may determine a number of user (e.g., the user 2916 of FIG. 29) who clicked in to the advertisement simultaneously. The community marketplace module 3310 may provide a forum in which the registered users can trade and/or announce messages of trading events with at least each other. The content syndication module 3306 may enable any data in the commerce module (e.g., the commerce module of FIG. 29) to be syndicated to other network based trading platforms.

The business display advertisement algorithm 3302 may impart advertisements related to business (e.g., the business 2922 of FIG. 29), public relations, personal selling, and/or sales promotion to promote commercial goods and services. The text advertisement algorithm 3308 may enable visibility of showing advertisements in the form of text in all dynamically created pages in the directory. The resident announce payment module 3300 may take part as component in a broader and complex process, like a purchase, a contract, etc.

The block party 3320 may be a large public celebration in which many members of a single neighborhood (e.g., the neighborhood 2902A-N of FIG. 29) congregate to observe a positive event of some importance. The free stuff 3318 may be the free services (e.g., advertisement, links, etc.) available on the net. The garage sales 3316 may be services that may be designed to make the process of advertising and/or may find a garage sale more efficient and effective. The services 3322 may be non-material equivalent of a good designed to provide a list of services that may be available for the user (e.g., the user 2916 of FIG. 29).

The geo position advertisement ranking module 3304 may communicate with the resident announce payment module 3300, the business display advertisement algorithm 3302, the content syndication module 3306, the text advertisement algorithm 3308, the community marketplace module 3310, the click-in tracking module 3312 and the click-through tracking module 3314.

For example, the commerce module 2908 of the global neighborhood environment 1800 (e.g., the privacy server 2900 of FIG. 29) may provide an advertisement system to a business which may purchase their location in the global neighborhood environment 1800 (e.g., the privacy server 2900 of FIG. 29) in which the advertisement may be viewable concurrently with a map indicating a location of the business, and/or in which revenue may be attributed to the global neighborhood environment 1800 (e.g., the privacy server 2900 of FIG. 29) when the registered users and/or the unregistered users click-in on a simultaneously displayed data of the advertisement along with the map indicating a location of the business.

Also, the geo-position advertisement ranking module 3304 of the commerce module to determine an order of the advertisement in a series of other advertisements provided in the global neighborhood environment 1800 (e.g., the privacy server 2900 of FIG. 29) by other advertisers, wherein the advertisement may be a display advertisement, a text advertisement, and/or an employment recruiting portal associated with the business that may be simultaneously displayed with the map indicating the location of the business.

Moreover, the click-through tracking module 3314 of the commerce module of FIG. 29 may determine a number of click-through from the advertisement to a primary website of the business. In addition, the click in tracking module 3312 of the commerce module may determine the number of users (e.g., the user 2916 of FIG. 29) who clicked in to the advertisement simultaneously displayed with the map indicating the location of the business.

The community marketplace module 3310 of the commerce module of FIG. 29 may provide a forum in which the registered users may trade and/or announce messages of trading events with certain registered users in geographic proximity from each other. Also, the content syndication module 3306 of the commerce module of the FIG. 29 may enable any data in the commerce module to be syndicated to other network based trading platforms.

FIG. 34 is an exploded view of a map algorithm 2914 of FIG. 29, according to one embodiment. Particularly FIG. 34 may include a satellite data module 3400, a simplified map generator module 3402, a cartoon map converter module 3404, a profile pointer module 3406, a parcel module 3408 and occupant module 3410, according to one embodiment. The satellite data module 3400 may help in mass broadcasting (e.g., maps) and/or as telecommunications relays in the map algorithm 2914 of FIG. 29.

The simplified map generator module 3402 may receive the data (e.g., maps) from the satellite data module 3400 and/or may convert this complex map into a simplified map with fewer colors. The cartoon map converter module 3404 may apply a filter to the satellite data (e.g., data generated by the satellite data module 3400 of FIG. 34) into a simplified polygon based representation.

The parcel module 3408 may identify some residence, civic, and business locations in the satellite data (e.g., the satellite data module 3400 of FIG. 34). The occupant module 3410 may detect the geographical location of the registered user in the global neighborhood environment 1800 (e.g., the privacy server 2900 of FIG. 29). The profile pointer module 3406 may detect the profiles of the registered user via the data received from the satellite. The cartoon map converter module 3404 may communicate with, the satellite data module 3400, the simplified map generator module 3402, the profile pointer module 3406 and the occupant module 3410. The parcel module 3408 may communicate with the satellite data module 3400.

For example, a map algorithm 2914 of the global neighborhood environment 1800 (e.g., the privacy server 2900 of FIG. 29) may include a map data associated with a satellite data (e.g., data generated by the satellite data module 3400 of FIG. 34) which serves as a basis of rendering the map in the global neighborhood environment 1800 (e.g., the privacy server 2900 of FIG. 29) and/or which includes a simplified map generator (e.g., the simplified map generator module 3402 of FIG. 34) which may transform the map to a fewer color and location complex form using a parcel data which identifies residence, civic, and business locations in the satellite data.

Also, the cartoon map converter module 3404 in the map algorithm 2914 may apply a filter to the satellite data (e.g., data generated by the satellite data module 3400 of FIG. 34) to transform the satellite data into a simplified polygon based representation using a Bezier curve algorithm that converts point data of the satellite data to a simplified form.

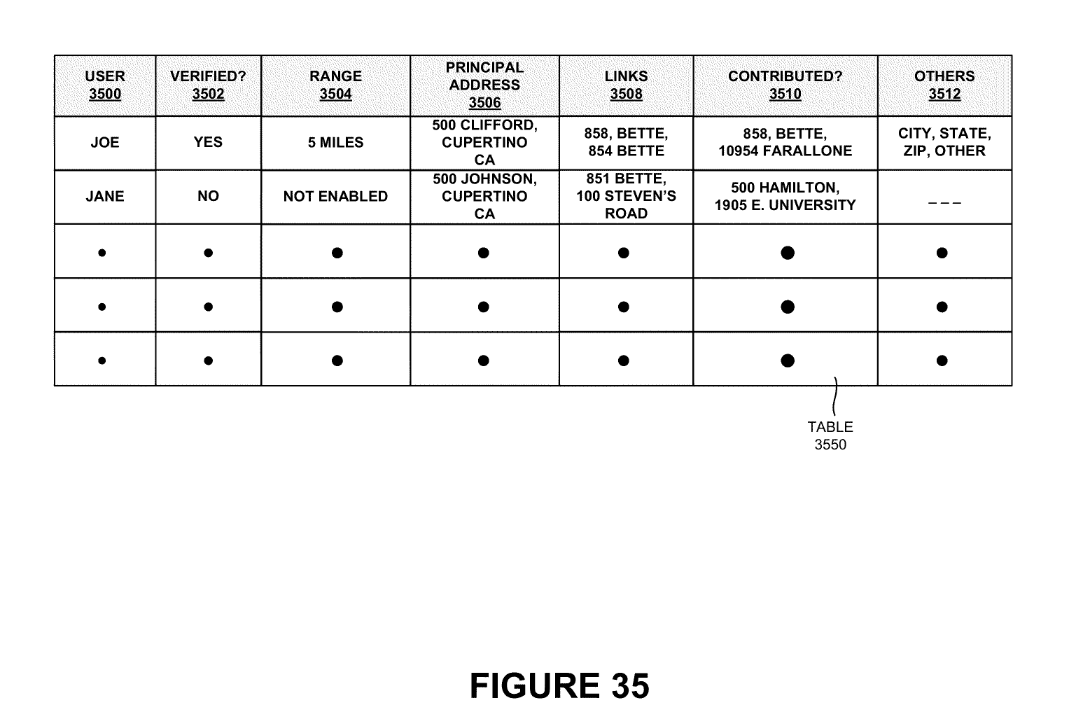

FIG. 35 is a table view of user address details, according to one embodiment. Particularly the table 3550 of FIG. 35 illustrates a user field 3500, a verified? field 3502, a range field 3504, a principle address field 3506, a links field 3508, a contributed? field 3510 and an others field 3512, according to one embodiment. The table 3550 may include the information related to the address verification of the user (e.g., the user 2916 of FIG. 29). The user field 3500 may include information such as the names of the registered users in a global neighborhood environment 1800 (e.g., a privacy server 2900 of FIG. 29).

The verified? field 3502 may indicate the status whether the data, profiles and/or email address received from various registered user are validated or not. The range field 3504 may correspond to the distance of a particular registered user geographical location in the global neighborhood environment 1800 (e.g., the privacy server 2900 of FIG. 29).

The principal address field 3506 may display primary address of the registered user in the global neighborhood environment 1800 (e.g., the privacy server 2900 of FIG. 29). The links field 3508 may further give more accurate details and/or links of the address of the user (e.g., the user 2916 of FIG. 29). The contributed? field 3510 may provide the user with the details of another individual and/or users contribution towards the neighborhood environment (e.g., the privacy server 2900 of FIG. 29). The other(s) field 3512 may display the details like the state, city, zip and/or others of the user's location in the global neighborhood environment 1800 (e.g., the privacy server 2900 of FIG. 29).

The user field 3500 displays “Joe” in the first row and “Jane” in the second row of the user field 3500 column of the table 3550 illustrated in FIG. 7. The verified field? 3502 displays “Yes” in the first row and “No” in the second row of the verified? field 3502 column of the table 3550 illustrated in FIG. 7. The range field 3504 displays “5 miles” in the first row and “Not enabled” in the second row of the range field 3504 column of the table 3550 illustrated in FIG. 7. The principal address field 3506 displays “500 Clifford Cupertino, Calif.” in the first row and “500 Johnson Cupertino, Calif.” in the second row of the principle address field 3506 column of the table 3550 illustrated in FIG. 7. The links field 3508 displays “859 Bette, 854 Bette” in the first row and “851 Bette 2900 Steven's Road” in the second row of the links field 3508 column of the table 3550 illustrated in FIG. 7.

The contributed? field 3510 displays “858 Bette Cupertino, Calif., Farallone, Calif.” in the first row and “500 Hamilton, Palo Alto, Calif., 1905E. University” in the second row of the contributed field 3510 column of the table 3550 illustrated in FIG. 7. The other(s) field 3512 displays “City, State, Zip, other” in the first row of the other(s) field 3512 column of the table 3550 illustrated in FIG. 7.

FIG. 36 is a user interface view of the social community module 2906, according to one embodiment. The user interface view 3650 may display the information associated with the social community module (e.g., the social community module 2906 of FIG. 29). The user interface 3650 may display map of the specific geographic location associated with the user profile of the social community module (e.g., the social community module 2906 of FIG. 29). The user interface view 3650 may display the map based geographic location associated with the user profile (e.g., the user profile 4000 of FIG. 40A) only after verifying the address of the registered user of the global neighborhood environment 1800 (e.g., the privacy server 2900 of FIG. 29).

In addition, the user interface 3650 may provide a building creator (e.g., the building builder 4402 of FIG. 44), in which the registered users of the global neighborhood environment 1800 (e.g., the privacy server 2900 of FIG. 29) may create and/or modify empty claimable profiles (e.g., a claimable profile 4006 of FIG. 40B-41A, a claimable profile 4102 of FIG. 41A, a claimable profile 1704 of FIG. 17), building layouts, social network pages, etc. The user interface view 3650 of the social community module 2906 may enable access to the user (e.g., the user 2916 of FIG. 29) to model a condo on any floor (e.g., basement, ground floor, first floor, etc.) selected through the drop down box by the registered user of the global neighborhood environment 1800 (e.g., the privacy server 2900 of FIG. 29). The user interface 3650 of the social community module (e.g., the social community module 2906 of FIG. 29) may enable the registered user of the global neighborhood environment 1800 (e.g., the privacy server 2900 of FIG. 29) to contribute information about their neighbors (e.g., the neighbor 2920 of FIG. 29).

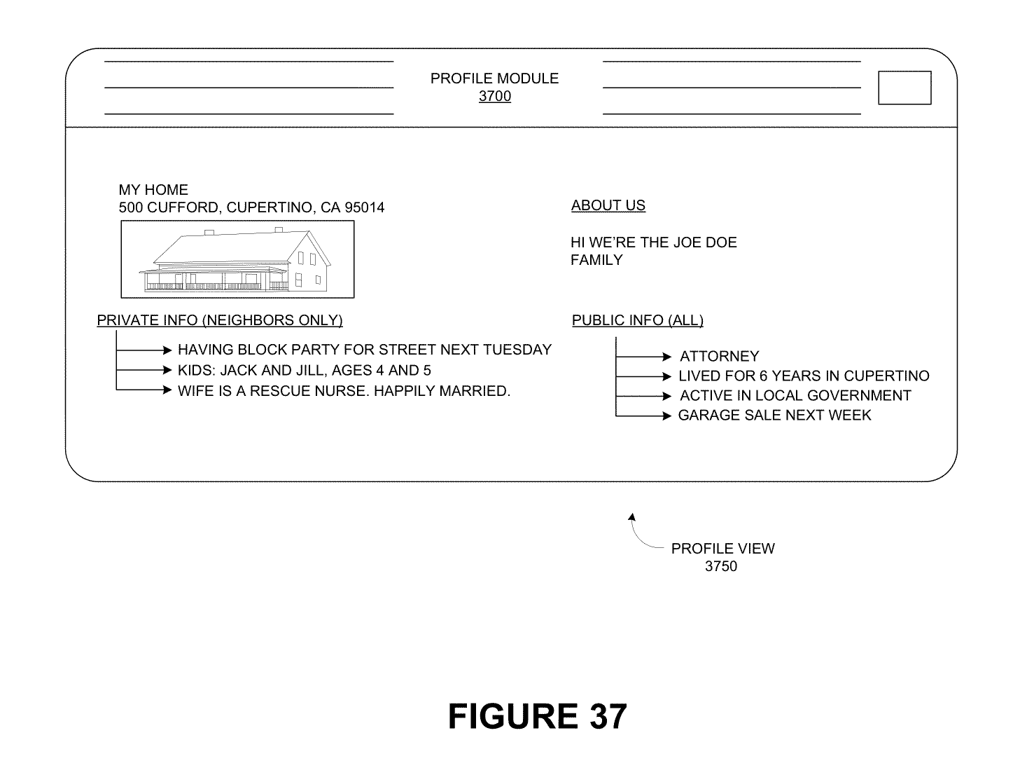

FIG. 37 is a profile view 3750 of a profile module 3700, according to one embodiment. The profile view 3750 of profile module 3700 may offer the registered user to access the profile about the neighbors (e.g., the neighbor 2920 of FIG. 29). The profile view 3750 of profile module 3700 may indicate the information associated with the profile of the registered user of the global neighborhood environment 1800 (e.g., the privacy server 2900 of FIG. 29). The profile view 3750 may display the address of the registered user. The profile view 3750 may also display events organized by the neighbors (e.g., the neighbor 2920 of FIG. 29), history of the neighbors (e.g., the neighbor 2920 of FIG. 29), and/or may also offer the information (e.g., public, private, etc.) associated with the family of the neighbors (e.g., the neighbor 2920 of FIG. 29) located in the locality of the user (e.g., the user(s) 2916 of FIG. 29) of the global neighborhood environment 1800 (e.g., the privacy server 2900 of FIG. 29).

FIG. 38 is a contribute view 3850 of a neighborhood network module 3800, according to one embodiment. The contribute view 3850 of the neighborhood network module 3800 may enable the registered user of the global neighborhood environment 1800 (e.g., the privacy server 2900 of FIG. 29) to add information about their neighbors in the neighborhood network. The contribute view 3850 of the neighborhood network module 3800 may offer registered user of the global neighborhood environment 1800 (e.g., the privacy server 2900 of FIG. 29) to add valuable notes associated with the family, events, private information, etc.

FIG. 39 is a diagrammatic system view, according to one embodiment. FIG. 39 is a diagrammatic system view 3900 of a data processing system in which any of the embodiments disclosed herein may be performed, according to one embodiment. Particularly, the diagrammatic system view 3900 of FIG. 39 illustrates a processor 3902, a main memory 3904, a static memory 3906, a bus 3908, a video display 3910, an alpha-numeric input device 3912, a cursor control device 3914, a drive unit 3916, a signal generation device 3918, a network interface device 3920, a machine readable medium 3922, instructions 3924, and a network 3926, according to one embodiment.

The diagrammatic system view 3900 may indicate a personal computer and/or a data processing system in which one or more operations disclosed herein are performed. The processor 3902 may be microprocessor, a state machine, an application specific integrated circuit, a field programmable gate array, etc. (e.g., Intel® Pentium® processor). The main memory 3904 may be a dynamic random access memory and/or a primary memory of a computer system.

The static memory 3906 may be a hard drive, a flash drive, and/or other memory information associated with the data processing system. The bus 3908 may be an interconnection between various circuits and/or structures of the data processing system. The video display 3910 may provide graphical representation of information on the data processing system. The alpha-numeric input device 3912 may be a keypad, keyboard and/or any other input device of text (e.g., a special device to aid the physically handicapped). The cursor control device 3914 may be a pointing device such as a mouse.

The drive unit 3916 may be a hard drive, a storage system, and/or other longer term storage subsystem. The signal generation device 3918 may be a bios and/or a functional operating system of the data processing system. The machine readable medium 3922 may provide instructions on which any of the methods disclosed herein may be performed. The instructions 3924 may provide source code and/or data code to the processor 3902 to enable any one/or more operations disclosed herein.

FIG. 40A is a user interface view of mapping a user profile 4000 of the geographic location 4004, according to one embodiment. In the example embodiment illustrated in FIG. 40A, the user profile 4000 may contain the information associated with the geographic location 4004. The user profile 4000 may contain the information associated with the registered user. The user profile 4000 may contain information such as address user of the specific geographic location, name of the occupant, profession of the occupant, details, phone number, educational qualification, etc.

The map 4002 may indicate the global neighborhood environment 1800 (e.g., the privacy server 2900 of FIG. 29) of the geographical location 4004, a claimable profile 4006 (e.g., the claimable profile 4102 of FIG. 41A, the claimable profile 1704 of FIG. 17), and a delisted profile 4008. The geographical location 4004 may be associated with the user profile 4000. The claimable profile 4006 may be the claimable profile 4006 associated with the neighboring property surrounding the geographic location 4004. The delisted profile 4008 illustrated in example embodiment of FIG. 40A, may be the claimable profile 4006 that may be delisted when the registered user claims the physical property. The tag 4010 illustrated in the example embodiment of FIG. 40A may be associated with hobbies, personal likes, etc. The block 4016 may be associated with events, requirements, etc. that may be displayed by the members of the global neighborhood environment 1800 (e.g., the privacy server 2900 of FIG. 29).

For example, a verified registered user (e.g., a verified registered user 4110 of FIG. 41A-B, a verified registered user 4110 of FIG. 42) may be associated with a user profile 4000. The user profile 4000 may be associated with a specific geographic location. A map concurrently displaying the user profile 4000 and the specific geographic location 4004 may be generated. Also, the claimable profiles 4006 associated with different geographic locations surrounding the specific geographic location associated with the user profile 4000 may be simultaneously generated in the map. In addition, a query of the user profile 4000 and/or the specific geographic location may be processed.

Similarly, a tag data (e.g., the tags 4010 of FIG. 40A) associated with the specific geographic locations, a particular geographic location, and the delisted geographic location may be processed. A frequent one of the tag data (e.g., the tags 4010 of FIG. 40A) may be displayed when the specific geographic location and/or the particular geographic location is made active, but not when a geographic location is delisted.

FIG. 40B is a user interface view of mapping of the claimable profile 4006, according to one embodiment. In the example embodiment illustrated in FIG. 40B, the map 4002 may indicate the geographic locations in the global neighborhood environment 1800 (e.g., the privacy server 2900 of FIG. 29) and/or may also indicate the geographic location of the claimable profile 4006. The claimable profile 4006 may display the information associated with the registered user of the global neighborhood environment 1800 (e.g., the privacy server 2900 of FIG. 29). The link claim this profile 4012 may enable the registered user to claim the claimable profile 4006 and/or may also allow the verified registered user (e.g., the verified registered user 4110 of FIG. 41A-B) to edit any information in the claimable profiles 4006. The block 4014 may display the information posted by any of the verified registered users (e.g., the verified registered user 4110 of FIG. 41A-B) of the global neighborhood environment 1800 (e.g., the privacy server 2900 of FIG. 29).

For example, a particular claimable profile (e.g., the particular claimable profile may be associated with a neighboring property to the specific property in the neighborhood) of the claimable profiles (e.g., the claimable profile 4102 of FIG. 41A, the claimable profile 1704 of FIG. 17) may be converted to another user profile (e.g., the user profile may be tied to a specific property in a neighborhood) when a different registered user (e.g., the user 2916 of FIG. 29) claims a particular geographic location to the specific geographic location associated with the particular claimable profile.

In addition, a certain claimable profile of the claimable profiles may be delisted when a private registered user claims a certain geographic location (e.g., the geographical location 4004 of FIG. 40A) adjacent to the specific geographic location and/or the particular geographic location. Also, the certain claimable profile in the map 4002 may be masked when the certain claimable profile is delisted through the request of the private registered user.

Furthermore, a tag data (e.g., the tags 4010 of FIG. 40A) associated with the specific geographic location, the particular geographic location, and the delisted geographic location may be processed. A frequent one of the tag data may be displayed when the specific geographic location and/or the particular geographic location are made active, but not when a geographic location is delisted.

Moreover, the verified registered user (e.g., the verified registered user 4110 of FIG. 41A-B) may be permitted to edit any information in the claimable profiles 4006 including the particular claimable profile 4006 and/or the certain claimable profile until the certain claimable profile may be claimed by the different registered user and/or the private registered user. In addition, a claimant of any claimable profile 4006 may be enabled to control what information is displayed on their user profile. Also, the claimant may be allowed to segregate certain information on their user profile 4000 such that only other registered users directly connected to the claimant are able to view data on their user profile 4000.

FIG. 41A is a user interface view of mapping of a claimable profile 4102 of the commercial user 4100, according to one embodiment. In the example embodiment illustrated in FIG. 41A, the commercial user 4100 may be associated with the customizable business profile 4104 located in the commercial geographical location. The claimable profile 4102 may contain the information associated with the commercial user 4100. The claimable profile 4102 may contain the information such as address, name, profession, tag, details (e.g., ratings), and educational qualification etc. of the commercial user 4100. The verified registered user 4110 may be user associated with the global neighborhood environment 1800 (e.g., the privacy server 2900 of FIG. 29) and may communicate a message to the neighborhood commercial user 4100. For example, a payment of the commercial user 4100 and the verified registered user 4110 may be processed.

FIG. 41B is a user interface view of mapping of customizable business profile 4104 of the commercial user 4100, according to one embodiment. In the example embodiment illustrated in FIG. 41B, the commercial user 4100 may be associated with the customizable business profile 4104. The customizable business profile 4104 may be profile of any business firm (e.g., restaurant, hotels, supermarket, etc.) that may contain information such as address, occupant name, profession of the customizable business. The customizable business profile 4104 may also enable the verified registered user 4110 to place online order for the products.

For example, the commercial user 4100 may be permitted to purchase a customizable business profile 4104 associated with a commercial geographic location. Also, the verified registered user 4110 may be enabled to communicate a message to the global neighborhood environment 1800 (e.g., the privacy server 2900 of FIG. 29) based on a selectable distance range away from the specific geographic location. In addition, a payment of the commercial user 4100 and/or the verified registered user 4110 may be processed.

A target advertisement 4106 may display the information associated with the offers and/or events of the customizable business. The display advertisement 4108 may display ads of the products of the customizable business that may be displayed to urge the verified registered user 4110 to buy the products of the customizable business. The verified registered user 4110 may be user associated with the global neighborhood environment 1800 (e.g., the privacy server 2900 of FIG. 29) that may communicate a message to the commercial user 4100 and/or may be interested in buying the products of the customizable business.

FIG. 42 is a user interface view of a group view 4202 associated with particular geographical location, according to one embodiment. Particularly FIG. 42 illustrates, a map 4200, a groups view 4202, according to one embodiment. In the example embodiment illustrated in FIG. 42, the map view 4200 may display map view of the geographical location of the specific group of the global neighborhood environment 1800 (e.g., the privacy server 2900 of FIG. 29). The groups view 4202 may contain the information (e.g., address, occupant, etc.) associated with the particular group of the specific geographical location (e.g., the geographical location displayed in the map 4200) of the global neighborhood environment 1800 (e.g., the privacy server 2900 of FIG. 29). The members 4204 may contain the information about the members associated with the group (e.g., the group associated with geographical location displayed in the map) of the global neighborhood environment 1800 (e.g., the privacy server 2900 of FIG. 29).

FIG. 43 is a user interface view of claim view 4350, according to one embodiment. The claim view 4350 may enable the user to claim the geographical location of the registered user. Also, the claim view 4350 may facilitate the user of the global neighborhood environment 1800 (e.g., the privacy server 2900 of FIG. 29) to claim the geographical location of property under dispute.

In the example embodiment illustrated in FIG. 43, the operation 4302 may allow the registered user of the global neighborhood environment 1800 (e.g., the privacy server 2900 of FIG. 29) to claim the address of the geographic location claimed by the registered user. The operation 4304 illustrated in example embodiment of FIG. 43, may enable the user to delist the claim of the geographical location. The operation 4306 may offer information associated with the document to be submitted by the registered users of the global neighborhood environment 1800 (e.g., the privacy server 2900 of FIG. 29) to claim the geographical location.

FIG. 44 is a user interface view of a building builder 4402, according to one embodiment. Particularly the FIG. 44 illustrates, a map 4400, a building builder 4402, according to one embodiment. The map 4400 may display the geographical location in which the verified registered user (e.g., the verified registered user 4110 of FIG. 41A-B) may create and/or modify empty claimable profiles (e.g., the claimable profile 4006 of FIG. 40B-41A, the claimable profile 4102 of FIG. 41A, the claimable profile 1704 of FIG. 17), building layouts, social network pages, and floor levels structures housing residents and businesses in the neighborhood (e.g., the neighborhood 2902A-N of FIG. 29). The building builder 4402 may enable the verified registered users (e.g., the verified registered user 4110 of FIG. 41A-B) of the global neighborhood environment 1800 (e.g., the privacy server 2900 of FIG. 29) to draw floor level structures, add neighbor's profiles and/or may also enable to select the floor number, claimable type, etc. as illustrated in example embodiment of FIG. 44.

The verified registered user 4110 may be verified registered user of the global neighborhood environment 1800 (e.g., the privacy server 2900 of FIG. 29) interested in creating and/or modifying claimable profiles (e.g., the claimable profile 4006 of FIG. 40B-41A, the claimable profile 4102 of FIG. 41A, the claimable profile 1704 of FIG. 17), building layouts, social network pages, and floor level structure housing residents and businesses in the neighborhood (e.g., the neighborhood 2902A-N of FIG. 29) in the building builder 4402.

For example, a social community module (e.g., a social community module 2906 of FIG. 29) of the global neighborhood environment 1800 (e.g., the privacy server 2900 of FIG. 29) may generate a building creator (e.g., the building builder 4402 of FIG. 44) in which the registered users may create and/or modify empty claimable profiles (e.g., the claimable profile 4006 of FIG. 40B-41A, the claimable profile 4102 of FIG. 41A, the claimable profile 1704 of FIG. 17), building layouts, social network pages, and floor levels structures housing residents and/or businesses in the neighborhood (e.g., the neighborhood 2902A-N of FIG. 29).

A method, apparatus and system of property billboarding and financial revenue distribution to property owner in a geo-spatial environment 100 are disclosed. In one aspect, a method includes generating a community network 200 of user profiles, each user profile associated with a specific geographic location 206, determining a first user profile 204A, generating advertisements, determining a first advertisement 212A, generating a first display view to include a map view 402 embodied by the community network 200, the first user profile 204A represented at a location in the map view 402 corresponding with the associated specific geographic location 206, and the first advertisement 212A displayed in conjunction with the first user profile 204A, and generating a commerce transaction 114 associated with the first user profile 204A.

The first advertisement 212A may also be displayed in conjunction with a property representation selected from a group including a representation of an outside surface of a structure associated with the first user profile 204A, a representation of an inside area of a structure associated with the first user profile 204A, a representation of an outside property area associated with the first user profile 204A, a editable portion associated with the first user profile 204A, and content associated with the editable portion.

The method may further include generating a revenue transaction associated with the first user profile 204A. The method may also include generating an online payment transaction associated with the first user profile 204A. The method may include generating a link between the first advertisement 212A and a website, tabulating clicks of the link, determining revenue based on the tabulation of the clicks, and generating the online payment transaction associated with the first user profile 204A based on the revenue.

In addition, the method may include apportioning a first portion of the revenue and a second portion of the revenue associated with the online payment transaction, associating the first portion of the revenue with a claimant of the first user profile 204A, and associating the second portion of the revenue with a sponsor of the community network 200.

The method may include providing at least a portion of the advertisements available for placement in conjunction with a particular user profile. The method may further include providing at least a portion of the user profiles available to accept an advertisement. In addition, the method may include selecting a geographic region, and selecting a particular user profile of the portion of the user profiles available to accept an advertisement having a specific geographic location 206 associated with the geographic region.

The method may also include receiving a preference (e.g., may include an advertiser, a product, and/or a service) associated with a second user profile of the portion of the user profiles available to accept an advertisement, determining a second advertisement that matches the preference, and generating a second display view to include a map view 402 embodied by the community network 200, the second user profile represented at a location in the map view 402 corresponding with the associated specific geographic location 206, and the second advertisement displayed in conjunction with the second user profile.

The method may further include providing search categories associated with the advertisements, selecting at least one search category, determining a third advertisement associated with the search category, determining a third user profile associated with the third advertisement, and generating a third display view to include a map view 402 embodied by the community network 200, the third user profile represented at a location in the map view 402 corresponding with the associated specific geographic location 206, and the third advertisement displayed in conjunction with the third user profile.

The search categories may include a preference, a location of a user profile, and/or a type of advertisement (e.g., may be associated with a product, a service, an event, a celebrity, and/or content such as music clips, movie trailers, audiovisual clips and/or podcasts, etc.). In addition, the method may include generating a link between the third advertisement and a website, selecting the link, and generating an online transaction associated with the third advertisement. The online transaction may further include generating an online purchase transaction associated with the product and/or the service. The online transaction may also include generating an online order of music associated with the music clip.

Moreover, the online transaction may include generating an online order of a movie associated with the movie trailer. The online transaction may also include generating an online reservation associated with the event, and generating an online payment transaction associated with the online reservation. Furthermore, the online transaction may include generating a link associated with the celebrity.

It may be verified that each user of the community network lives at a residence associated with a claimable residential address of the community network formed through a social community module of a privacy server 2900 using a processor and a memory. Member data associated with each user may be obtained from each user of the community network, using the processor of a computing device. The member data may include an address. The address may be associated with a profile of each user. A location of each user may be determined based on the member data. The member data may be stored in a database. A personal address privacy preference may be obtained from each user, the personal address privacy preference specifying if the address should be displayed to other users.

A threshold radial distance may be optionally extended to an adjacent boundary of an adjacent neighborhood based a request of the particular user. A separate login may be generated to the online community designed to be usable by a police department, a municipal agency, a neighborhood association, and/or a neighborhood leader associated with the particular neighborhood. The police department, the municipal agency, the neighborhood association, and/or the neighborhood leader may be permitted to invite residents of the particular neighborhood themselves using the privacy server 2900 using a self-authenticating access code that permits new users that enter the self-authenticating access code in the online community to automatically join the particular neighborhood (e.g., the neighborhood 2902A) as verified users, generate a virtual neighborhood watch group and/or an emergency preparedness group restricted to users verified in the particular neighborhood using the privacy server 2900, conduct high value crime and safety related discussions from local police and fire officials that is restricted to users verified in the particular neighborhood using the privacy server 2900, broadcast information across the particular neighborhood, and/or receive and/or track neighborhood level membership and/or activity to identify leaders from

In another aspect, a system includes a geo-spatial environment 100, a community network 200 module of the geo-spatial environment 100 to include user profiles, each user profile to include a specific geographic location 206, an advertisement algorithm of the geo-spatial environment 100 to generate advertisements, a map algorithm of the geo-spatial environment 100 to include map data which serves as a basis to render a map view 402 in the geo-spatial environment 100 which identifies residences, businesses, and/or civic structures having specific geographic location 206s, a display algorithm of the geo-spatial environment 100 to generate a first display view of the map view 402 embodied by the community network 200, a first user profile 204A represented at a location in the map view 402 corresponding to the specific geographic location 206 associated with the first user profile 204A, and an advertisement displayed in conjunction with the first user profile 204A, and a commerce transaction 114 module of the geo-spatial environment 100 to generate a commerce transaction 114 associated with the first user profile 204A.

The system may further include a revenue module of the geo-spatial environment 100 to generate revenue associated with the commerce transaction 114. The system may also include an online payment transaction module of the geo-spatial environment 100 to generate an online payment transaction associated with the revenue (e.g., a first portion of the revenue may be associated with a claimant of the first user profile 204A and a second portion of the revenue may be associated with a sponsor of the community network 200).

The system may also include a tabulate module of the geo-spatial environment 100 to generate a link associated with the first advertisement 212A, to tabulate clicks of the link, and to associate the tabulated links with the commerce transaction 114. The system may yet include an availability module of the geo-spatial environment 100 to provide a portion of the user profiles available to accept advertisements and to enable selection of a particular user profile of the portion of user profiles with which a particular advertisement is associated.

Moreover, the system may include a preference module of the geo-spatial environment 100 to determine a second profile available to accept an advertisement, to receive a preference (e.g., may include an advertiser, a product, and/or a service) associated with the second user profile available to accept an advertisement, and to determine a particular advertisement that matches the preference. The system may also include a search module of the geo-spatial environment 100 to provide search categories (e.g., may include preferences, locations of user profiles, and/or types of advertisements), to enable selection of at least one search category, to determine at least one advertisement associated with a selected search category, and to identify at least one user profile associated with the advertisement.

The system may further include a claimable profile 404 module 312 of the geo-spatial environment 100 to generate a claimable profile 404 associated with at least one representation of a user profile. The system may also include an append module of the geo-spatial environment 100 to generate, with the claimable profile 404, content associated with the claimable profile 404.

A privacy server 2900 may be configured to verify that each user of the community network lives at a residence associated with a claimable residential address of the community network formed through a social community module of the privacy server 2900 using a processor and a memory, to obtain from each user of the community network, using the processor of a computing device, member data associated with each user, the member data including an address, to associate the address with a profile of each user, to determine a location of each user based on the member data, to store the member data in a database, and/or to obtain a personal address privacy preference from each user, the personal address privacy preference specifying if the address should be displayed to other users.

The privacy server may be configured to optionally extend a threshold radial distance to an adjacent boundary of an adjacent neighborhood based a request of the particular user, to generate a separate login to the online community designed to be usable by a police department, a municipal agency, a neighborhood association, and/or a neighborhood leader associated with the particular neighborhood (e.g., the neighborhood 2902A), to permit at least one of the police department, the municipal agency, the neighborhood association, and the neighborhood leader to invite residents of the particular neighborhood themselves using the privacy server using a self-authenticating access code that permits new users that enter the self-authenticating access code in the online community to automatically join the particular neighborhood as verified users, to generate a virtual neighborhood watch group and/or an emergency preparedness group restricted to users verified in the particular neighborhood using the privacy server, to conduct high value crime and/or safety related discussions from local police and/or fire officials that is restricted to users verified in the particular neighborhood using the privacy server 2900, to broadcast information across the particular neighborhood, and/or to receive and track neighborhood level membership and activity to identify leaders from the restricted group of users verified in the particular neighborhood using the privacy server 2900.

In yet another aspect, a geo-spatial environment 100 includes a first instruction set to enable a community network 200 to include a map database 208 associated with map data, a user database 202 associated with user profiles, each user profile associated with a specific geographic location 206 identifiable in the map data, and an advertisement database associated with advertisements, each advertisement associated with a user profile. The system also includes a second instruction set integrated with the first instruction set to display a map view 402 embodied by the community network 200, a user profile represented at a location in the map view 402 corresponding to the associated specific geographic location 206 and an advertisement associated with the user profile. The system further includes a third instruction set to generate a commerce transaction 114 associated with the user profile.

The geo-spatial environment 100 may include a fourth instruction set to generate an online payment transaction associated with the user profile. The geo-spatial environment 100 may also include a fifth instruction set to provide at least a portion of the user profiles available to accept an advertisement, and a sixth instruction set to provide search categories, to enable selection of at least one search category, to determine at least one advertisement associated with a selected search category, and to identify at least one user profile associated with the advertisement.

A seventh instruction set may verify that each user of the community network lives at a residence associated with a claimable residential address of the community network formed through a social community module of a privacy server 2900 using a processor and a memory, to obtain from each user of the community network, using the processor of a computing device, member data associated with each user, the member data including an address, to associate the address with a profile of each user, to determine a location of each user based on the member data, to store the member data in a database, and to obtain a personal address privacy preference from each user, the personal address privacy preference specifying if the address should be displayed to other users.

An eighth instruction set may optionally extend a threshold radial distance to an adjacent boundary of an adjacent neighborhood based a request of the particular user, to generate a separate login to the online community designed to be usable by at least one of a police department, a municipal agency, a neighborhood association, and a neighborhood leader associated with the particular neighborhood (e.g., the neighborhood 2902A), to permit the police department, the municipal agency, the neighborhood association, and/or the neighborhood leader to invite residents of the particular neighborhood themselves using the privacy server 2900 using a self-authenticating access code that permits new users that enter the self-authenticating access code in the online community to automatically join the particular neighborhood as verified users, to generate at least one of a virtual neighborhood watch group and an emergency preparedness group restricted to users verified in the particular neighborhood using the privacy server, to conduct high value crime and safety related discussions from local police and fire officials that is restricted to users verified in the particular neighborhood (e.g., the neighborhood 2902A of FIG. 29) using the privacy server, to broadcast information across the particular neighborhood, and/or to receive and track neighborhood level membership and activity to identify leaders from the restricted group of users verified in the particular neighborhood using the privacy server 2900.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

An example embodiment will now be described. In one embodiment, an advertiser may wish to advertise a good and/or service for sale. The advertiser may wish to display the advertisement in a high traffic area in order to maximize visibility of the advertisement. The advertiser may wish to avoid the hassle and expense that comes with purchasing billboards and maintaining the billboards. The advertiser may join, partner, and/or interact with the community network in order to have its advertisements displayed.

The high visibility afforded by the community network may make it an optimal environment to display advertisements. The advertiser may be able to cater to a large and targeted market at a low cost by billboarding on the community network. The advertiser may be a local business and/or want to target its advertisements to a specific neighborhood and/or community. Neighborhoods ideal for advertising may be residential and/or may not lend themselves to billboards and other methods of mass advertising. The community network may provide a viable alternative.

In one embodiment, Mama's little bakery may be a small bakery close to several residential neighborhoods. The establishment may not have the funds and/or resources to market themselves effectively and/or may not want to go door to door, take out newspaper ads (as newspaper readership has fallen drastically in recent years) and/or put up posters and/or billboards. The neighborhood surrounding the bakery may not permit flyering and/or billboards. The owner Mama's little bakery may hear about the advertising opportunity available on the community network. The owner may access (e.g., log onto) the community network and/or may begin advertising in the neighborhoods surrounding the bakery. Mama's little bakery may be able to increase awareness and/or sales in a target market (e.g., people near to the bakery) quickly and while expending minimal resources.

In yet another embodiment, a major company may wish to advertise its product to consumers. The company may not wish to invest in other methods of mass advertising such as billboards (as these may be expensive and target areas may not allow them) and/or television advertisements as these may be skipped with modern technology and may not be effective on a majority of individuals viewers. The company may learn of more targeted advertising opportunities afforded by the community network. The company may choose to display advertisements for its product(s) in certain neighborhoods on the community network. This may be more cost efficient and/or more effective at generating sales. The company may be able to increase publicity with minimal effort while helping members of the community earn money, possibly creating loyalty to the company.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structures and methods may be embodied using transistors, logic gates, and electrical circuits (e.g., Application Specific Integrated (ASIC) Circuitry and/or in Digital Signal Processor (DSP) circuitry).

For example, the community network algorithm 106, the map algorithm 108, the advertisement algorithm 110, the display algorithm 112, the commerce transaction algorithm 114, the additional algorithms 116, the revenue module 302, the online payment module 302A, the tabulate module 304, the availability module 306, the preference module 308, the search module 310, the claimable profile module 312, the append module 314 and other modules of FIGS. 1-13 may be enabled using a community network circuit, a map circuit, an advertisement circuit, a display circuit, a commerce transaction circuit, additional circuit, a revenue circuit, an online payment transaction circuit, a tabulate circuit, an availability circuit, a preference circuit, a search circuit, a claimable profile circuit, an append circuit and other circuits using one or more of the technologies described herein.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated ASIC circuitry and/or in Digital Signal; Processor DSP circuitry).

For example, the social community module 2906, the search module 2908, the claimable module 2910, the commerce module, the map algorithm 2914, the building builder module 3000, the N^{th} degree module, the tagging module 3004, the verify module 3006, the groups generator module 3008, the pushpin module 3010, the profile module 3012, the announce module 3014, the friend finder module 3022, the neighbor-neighbor help module 3024, the business search module, the communicate module 3106, the directory assistance module 3108, the embedding module 3110, the no-match module 3112, the range selector module 3114, the user-place claimable module, the user-user claimable module 3202, the user-neighbor claimable module 3204, the user-business claimable module 3206, the reviews module 3208, the defamation prevention module 3210, the claimable social network conversion module 3212, the claim module 3214, the data segment module 3216, the dispute resolution module 3218, the resident announce payment module 3300, the business display advertisement algorithm 3302, the geo-position advertisement ranking module 3304, the content syndication module 3306, the text advertisement algorithm 3308, the community market place module 3310, the click-in tracking module 3312, the satellite data module 3400, the cartoon map converter module 3404, the profile pointer module 3406, the parcel module 3408 and the occupant module 3410 of FIGS. 1-44 may be embodied through the social community circuit, the search circuit, the claimable circuit, the commerce circuit, the map circuit, the building builder circuit, the N^{th} degree circuit, the tagging circuit, the verify circuit, the groups circuit, the pushpin circuit, the profile circuit, the announce circuit, the friends finder circuit, the neighbor-neighbor help circuit, the business search circuit, the communicate circuit, the embedding circuit, the no-match circuit, the range selector circuit, the user-place claimable circuit, the user-user claimable circuit, the user-neighbor claimable circuit, the user-business circuit, the reviews circuit, the defamation prevention circuit, the claimable social network conversion circuit, the claim circuit, the data segment circuit, the dispute resolution circuit, the resident announce payment circuit, the business display advertisement circuit, the geo-position advertisement ranking circuit, the content syndication circuit, the text advertisement circuit, the community market place circuit, the click-in tracking circuit, the satellite data circuit, the cartoon map converter circuit, the profile pointer circuit, the parcel circuit, the occupant circuit using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method, comprising:
generating a community network of user profiles, each user profile of the user profiles associated with a specific geographic location;
determining a first user profile of the user profiles;
generating advertisements;
determining a first advertisement of the advertisements;
generating a first display view to include a map view embodied by the community network, the first user profile of the user profiles represented at a location in the map view corresponding with the associated specific geographic location, and the first advertisement of the advertisements displayed in conjunction with the first user profile of the user profiles; and
generating a commerce transaction associated with the first user profile of the user profiles.

2. The method of claim 1, further comprising:
generating a revenue transaction associated with the first user profile of the user profiles;
generating an online payment transaction associated with the first user profile of the user profiles;
generating a link between the first advertisement and a website;
tabulating clicks of the link;
determining revenue based on the tabulation of the clicks; and
generating the online payment transaction associated with the first user profile of the user profiles based on the revenue.

3. The method of claim 2, further comprising:
apportioning a first portion of the revenue and a second portion of the revenue associated with the online payment transaction;
associating the first portion of the revenue with a claimant of the first user profile of the user profiles; and
associating the second portion of the revenue with a sponsor of the community network.

4. The method of claim 3, further comprising:
providing at least a portion of the advertisements available for placement in conjunction with a particular user profile of the user profiles;
providing at least a portion of the user profiles available to accept an advertisement;
selecting a geographic region; and
selecting a particular user profile of the at least a portion of the user profiles available to accept an advertisement having a specific geographic location associated with the geographic region.

5. The method of claim 4, further comprising:
receiving a preference associated with a second user profile of the at least a portion of the user profiles available to accept an advertisement;
determining a second advertisement of the advertisements that matches the preference; and
generating a second display view to include a map view embodied by the community network, the second user profile of the user profiles represented at a location in the map view corresponding with the associated specific geographic location, and the second advertisement of the advertisements displayed in conjunction with the second user profile of the user profiles, wherein the preference includes an advertiser, a product, and a service.

6. The method of claim 1, further comprising:
providing search categories associated with the advertisements;
selecting at least one search category of the search categories;
determining a third advertisement of the advertisements associated with the at least one search category;
determining a third user profile of the user profiles associated with the third advertisement; and
generating a third display view to include a map view embodied by the community network, the third user profile of the user profiles represented at a location in the map view corresponding with the associated specific geographic location, and the third advertisement of the advertisements displayed in conjunction with the third user profile of the user profiles.

7. The method of claim 6, wherein the search categories include a preference, a location of a user profile, and a type of advertisement, and wherein the type of advertisement is associated with at least one of a product, a service, a music clip, a movie trailer, an event, an audiovisual clip, a podcast, and a celebrity.

8. The method of claim 6, further comprising:
generating a link between the third advertisement and a website;
selecting the link; and
generating an online transaction associated with the third advertisement.

9. The method of claim 8:
wherein the online transaction further comprises generating an online purchase transaction associated with the product and the service,
wherein the online transaction further comprises generating an online order of music associated with the music clip,
wherein the online transaction further comprises generating an online order of a movie associated with the movie trailer,
wherein the online transaction further comprises:
generating an online reservation associated with the event, and
generating an online payment transaction associated with the online reservation,
wherein the online transaction further comprises generating a link associated with the celebrity, and
wherein the first advertisement is displayed in conjunction with a property representation selected from a group comprising a representation of an outside surface of a structure associated with the first user profile, a representation of an inside area of a structure associated with the first user profile, a representation of an outside property area associated with the first user profile, a claimable associated with the first user profile, and content associated with the claimable.

10. The method of claim 1 further comprising:
verifying that each user of the community network lives at a residence associated with a claimable residential address of the community network formed through a social community module of a privacy server using a processor and a memory;
obtaining from each user of the community network, using the processor of a computing device, member data associated with each user, the member data including an address;
associating the address with a profile of each user;
determining a location of each user based on the member data;
storing the member data in a database; and
obtaining a personal address privacy preference from each user, the personal address privacy preference specifying if the address should be displayed to other users.

11. The method of claim 1 further comprising:
optionally extending a threshold radial distance to an adjacent boundary of an adjacent neighborhood based a request of the particular user;
generating a separate login to the online community designed to be usable by at least one of a police department, a municipal agency, a neighborhood association, and a neighborhood leader associated with the particular neighborhood;
permitting at least one of the police department, the municipal agency, the neighborhood association, and the neighborhood leader to at least one:
invite residents of the particular neighborhood themselves using a privacy server using a self-authenticating access code that permits new users that enter the self-authenticating access code in the online community to automatically join the particular neighborhood as verified users,
generate at least one of a virtual neighborhood watch group and an emergency preparedness group restricted to users verified in the particular neighborhood using the privacy server,
conduct high value crime and safety related discussions from local police and fire officials that is restricted to users verified in the particular neighborhood using the privacy server,
broadcast information across the particular neighborhood, and
receive and track neighborhood level membership and activity to identify leaders from the restricted group of users verified in the particular neighborhood using the privacy server.

12. The method of claim 1 in a form of a machine-readable medium embodying a set of instructions that, when executed by a machine, causes the machine to perform the method of claim 1.

13. A system, using a processor and a memory, comprising:
a geo-spatial environment;
a community network algorithm of the geo-spatial environment, to include user profiles, each user profile of the user profiles to include a specific geographic location;
an advertisement algorithm of the geo-spatial environment to generate advertisements;
a map algorithm of the geo-spatial environment to include map data which serve as a basis to render a map view in the geo-spatial environment which identifies at least some of residences, businesses, and civic structures having specific geographic locations;
a display algorithm of the geo-spatial environment to generate a first display view of the map view embodied by a community network, a first user profile of the user profiles represented at a location in the map view corresponding to the specific geographic location associated with the first user profile, and an advertisement of the advertisements displayed in conjunction with the first user profile of the user profiles; and
a commerce transaction algorithm of the geo-spatial environment to generate a commerce transaction associated with the first user profile.

14. The system of claim 13, further comprising:
a revenue module of the geo-spatial environment to generate revenue associated with the commerce transaction;
a tabulate module of the geo-spatial environment to generate a link associated with the first advertisement, to tabulate clicks of the link, and to associate the tabulated links with the commerce transaction;
a claimable profile module of the geo-spatial environment to generate a claimable profile associated with at least one representation of a user profile; and
an append module of the geo-spatial environment to generate with the claimable profile, content associated with the claimable profile.

15. The system of claim 13, further comprising:
an availability module of the geo-spatial environment to provide at least a portion of the user profiles available to accept the advertisements and to enable selection of a particular user profile of the at least a portion of user profiles with which a particular advertisement of the advertisements is associated;
a preference module of the geo-spatial environment to determine a second user profile available to accept an advertisement, to receive a preference associated with the second user profile available to accept an advertisement, and to determine a particular advertisement of the advertisements that matches the preference; and
an online payment transaction module of the geo-spatial environment to generate an online payment transaction associated with the revenue, wherein a first portion of the revenue is associated with a claimant of the first user profile and a second portion of the revenue is associated with a sponsor of the community network, and wherein the preference includes an advertiser, a product, and a service.

16. The system of claim 13, further comprising a search module of the geo-spatial environment to provide search categories, to enable selection of at least one search category of the search categories, to determine at least one advertisement associated with a selected at least one search category, and to identify at least one user profile of the user profiles associated with the at least one advertisement, wherein the search categories include a preference, a location of a user profile, and a type of advertisement.

17. The system of claim 13 further comprising:
a privacy server configured:
to verify that each user of the community network lives at a residence associated with a claimable residential address of the community network formed through a social community module of the privacy server using a processor and a memory;
to obtain from each user of the community network, using the processor of a computing device, member data associated with each user, the member data including an address;
to associate the address with a profile of each user;
to determine a location of each user based on the member data;
to store the member data in a database; and
to obtain a personal address privacy preference from each user, the personal address privacy preference specifying if the address should be displayed to other users.

18. The system of claim 13 further comprising:
a privacy server configured:
to optionally extend a threshold radial distance to an adjacent boundary of an adjacent neighborhood based a request of the particular user;
to generate a separate login to the online community designed to be usable by at least one of a police department, a municipal agency, a neighborhood association, and a neighborhood leader associated with the particular neighborhood;
to permit at least one of the police department, the municipal agency, the neighborhood association, and the neighborhood leader to at least one:
invite residents of the particular neighborhood themselves using the privacy server using a self-authenticating access code that permits new users that enter the self-authenticating access code in the online community to automatically join the particular neighborhood as verified users,
to generate at least one of a virtual neighborhood watch group and an emergency preparedness group restricted to users verified in the particular neighborhood using the privacy server,
to conduct high value crime and safety related discussions from local police and fire officials that is restricted to users verified in the particular neighborhood using the privacy server,
to broadcast information across the particular neighborhood, and
to receive and track neighborhood level membership and activity to identify leaders from the restricted group of users verified in the particular neighborhood using the privacy server.

19. A geo-spatial environment, using a processor and a memory, comprising:
a first instruction set to enable a community network, to include a map database associated with map data, a user database associated with user profiles, each user profile of the user profiles associated with a specific geographic location identifiable in the map data, and an advertisement database associated with advertisements, each advertisement of the advertisements associated with a user profile of the user profiles;
a second instruction set integrated with the first instruction set to display a map view embodied by the community network, a user profile of the user profiles represented at a location in the map view corresponding to the associated specific geographic location, and an advertisement associated with the user profile of the user profiles; and
a third instruction set to generate a commerce transaction associated with the user profile
a fourth instruction set to generate an online payment transaction associated with the user profile of the user profiles;
a fifth instruction set to provide at least a portion of the user profiles available to accept an advertisement;
a sixth instruction set to provide search categories, to enable selection of at least one search category of the search categories, to determine at least one advertisement associated with a selected at least one search category, and to identify at least one user profile of the user profiles associated with the at least one advertisement;
a seventh instruction set to verify that each user of the community network lives at a residence associated with a claimable residential address of the community network formed through a social community module of a privacy server using a processor and a memory, to obtain from each user of the community network, using the processor of a computing device, member data associated with each user, the member data including an address, to associate the address with a profile of each user, to determine a location of each user based on the member data, to store the member data in a database, and to obtain a personal address privacy preference from each user, the personal address privacy preference specifying if the address should be displayed to other users; and
an eighth instruction set to optionally extend a threshold radial distance to an adjacent boundary of an adjacent neighborhood based a request of the particular user, to generate a separate login to the online community designed to be usable by at least one of a police department, a municipal agency, a neighborhood association, and a neighborhood leader associated with the particular neighborhood, to permit at least one of the police department, the municipal agency, the neighborhood association, and the neighborhood leader to at least one of invite residents of the particular neighborhood themselves using the privacy server using a self-authenticating access code that permits new users that enter the self-authenticating access code in the online community to automatically join the particular neighborhood as verified users, to generate at least one of a virtual neighborhood watch group and an emergency preparedness group restricted to users verified in the particular neighborhood using the privacy server, to conduct high value crime and safety related discussions from local police and fire officials that is restricted to users verified in the particular neighborhood using the privacy server, to broadcast information across the particular neighborhood, and to receive and track neighborhood level membership and activity to identify leaders from the restricted group of users verified in the particular neighborhood using the privacy server.
